(19) United States
(12) Patent Application Publication
(10) Pub. No.: US 2026/0225109 A1
(43) Pub. Date: Aug. 6, 2026

(54) HETEROGENEOUS MATERIAL PROCESSING SYSTEM AND METHOD

(71) Applicant: Disa Technologies, Inc., Mills, WY (US)

(72) Inventors: Andrew George Pfleider Halverson, Casper, WY (US); Garrett Luke Pierpoint, Casper, WY (US); Louard Crumbaugh, IV, Casper, WY (US); Dustin Steven Weaver, Denver, CO (US); Justin Patrick Flock, Broomfield, CO (US)

(21) Appl. No.: 19/531,477

(22) Filed: Feb. 5, 2026

Related U.S. Application Data
(60) Provisional application No. 63/755,094, filed on Feb. 6, 2025.
(60) Provisional application No. 63/788,557, filed on Apr. 14, 2025.
(60) Provisional application No. 63/788,579, filed on Apr. 14, 2025.
(60) Provisional application No. 63/865,966, filed on Aug. 18, 2025.

(51) Int. Cl. B02C 19/00; B02C 23/36; B02C 23/38

(52) U.S. Cl. CPC B02C 19/0043; B02C 23/36; B02C 23/38

(57) ABSTRACT

A method for liberating and processing a heterogenous material, the method comprising: passing the heterogeneous material into a high-pressure slurry ablation system comprising a collision chamber and a nozzle to form an ablated heterogeneous material; and passing the ablated heterogeneous material into a mineral processing circuit. A system and method for ablating a heterogeneous material, the system comprising: a first collision chamber comprising a pressure transducer; a knife gate; a valve; a splitter in communication with the valve; and a distributor. A system and method for ablating a heterogeneous material, the system comprising: a multiple nozzle chamber, the multiple nozzle chamber comprising: a chamber body; a plurality of nozzles; and an adapter-spacer.

### CROSS REFERENCE TO RELATED APPLICATIONS

This application claims priority to and the benefit of the filing of U.S. Provisional Patent Application No. 63/755,094, entitled “Heterogeneous Material Processing System and Method”, filed on Feb. 6, 2025; U.S. Provisional Patent Application No. 63/788,557, entitled “Heterogeneous Material Processing System and Method”, filed on Apr. 14, 2025; U.S. Provisional Patent Application No. 63/788,579, entitled “Heterogeneous Material Processing System and Method for Hydrocarbons”, filed on Apr. 14, 2025; and U.S. Provisional Patent Application No. 63/865,966, entitled “Heterogeneous Material Processing System and Method”, filed on Aug. 18, 2025, and their specifications thereof are incorporated herein by reference.

### BACKGROUND OF THE INVENTION

### Field of the Invention (Technical Field)

The present invention relates to a system and method for processing heterogeneous material, in particular, a system for dissociation of the subfractions of heterogenous materials.

### Related Art

Heterogeneous materials, such as heterogeneous solid materials, occur naturally and may also be formed by man-made processes. For example, naturally occurring ores may include volumes containing a material of interest (i.e., a “bearing fraction”), such as a metal or a mineral, mixed with volumes not containing the material of interest (i.e., a so-called “non-bearing fraction”). Recovery of the material of interest generally requires physical or chemical separation of the bearing fraction from the non-bearing fraction. Chemical separation may require reagents (e.g., cyanide, acids, carbonates), which may be expensive or raise environmental challenges.

Other materials of interest can include previously processed materials which may be recycled or repurposed, including but not limited to industrial waste, electronic waste (e-waste), construction and building materials, alloys, aggregate, concrete, plant materials, chemical compounds, and other materials where one component needs to be separated from another component.

As one example of a material of interest, uranium is typically found in nature as uranium ore, e.g., the heterogeneous material. Low-grade uranium ore may contain any form of uranium-containing compounds in concentrations up to about five pounds of U₃O₈ equivalent per ton of ore, whereas higher grade ore may contain uranium-containing compounds in concentrations of about eight pounds of U₃O₈ equivalent per ton of ore or more.

Heterogeneous material deposits may be formed in sandstone by erosion and redeposition. For example, an uplift may raise a mineral-bearing source rock and expose the source rock to the atmosphere. The source rock may then erode, forming solutions of primary and secondary materials of interest. The solutions may migrate along the surface of the earth or through permeable subsurface channels into a sandstone formation, stopping at a structural or chemical boundary. The material of interest may then be deposited as a patina or coating around or between grains of the formation. The material of interest may also be present in carbonaceous materials within sandstone. Minerals may be all or a portion of the cementing material between grains of the formation.

A material of interest may conventionally be recovered through in-situ recovery (“ISR”), also known in the art as in-situ leaching (“ISL”) or solution mining. In ISR, a leachate or lixiviant solution is pumped into an ore formation through a well. The solution permeates the formation and dissolves a portion of the ore. The solution is extracted through another well and processed to recover the mineral. Reagents used to dissolve the material of interest disposed in the ore may include an acid or carbonate. ISR may have various environmental and operational concerns, such as mobilization of mineral or heavy metals into aquifers, footprint of surface operations, interconnection of wells, etc. ISR typically requires particular reagents, which must be supplied, recovered, and treated. Because ISR relies on the subsurface transport of a solution, ISR cannot generally be used in formations that are impermeable or shallow.

A material of interest may also conventionally be mined in underground mines or surface mines (e.g., strip mines, open-pit mines, etc.). During such mining activities, it may be necessary to process large quantities of heterogeneous material comprising a material of interest at a concentration too low for economic recovery by conventional processes. Such material (e.g., overburden) may be treated as waste or as a material for use in mine reclamation. Conventional mining may produce significant amounts of such low-concentration material, which may require treatment during or subsequent to mining operations. Other materials of interest from mining operations include ore, concentrates, and tailings.

Alberta's oil sands are among the largest deposits of crude oil in the world with more than 165 billion barrels of accessible bitumen in the ground. However, this valuable resource is often viewed negatively because of the environmental impact of the extraction processes. In particular, open-pit mining, the most common method for accessing the heavy bitumen deposited at shallow depths (less than 75 meters (“m”)), uses significant amount of energy and water for ore transport and treatment. The ore properties and energy intensity of the bitumen liberation and extraction processes directly control bitumen extraction recovery, but also the degree of clay dispersion, a major factor in determining tailings properties. In conventional operations, a great part of this energy is spent on slurry transport, or hydro-transport, from the mine to the bitumen upgrading plant, an operation that is particularly hard to control and predict.

As a part of ongoing efforts of the oil sands industry to reduce the costs and environmental impacts of the bitumen production process, many companies have recognized the need to extract the bitumen as early as possible in the process circuit, which ideally happens at the mine face to eliminate the need for long truck haulage and provide reduction of the length of the hydro-transport pipelines. In order to achieve complete oil sand lump ablation using less energy and shorter pipelines, current operating strategies, often involving a long network of hydro-transport pipelines serving dual purpose of oil sand slurry transport to the extraction plant and slurry conditioning, need to be modified. The incomplete ablation that occurs during at-face lump ablation using short hydro-transport pipes, can be overcome through accelerated, high-shear, lump conditioning over short periods of time.

Estimates suggest that a seemingly insignificant one percent increase in oil sands conditioning circuit efficiency would result in annual cost savings of $300 million in Canada alone and 15% reduction in greenhouse gas (“GHG”) emission of the oil sand surface mining operation. Therefore, even small improvements in the efficiency of the oil sand conditioning and bitumen extraction circuit can greatly enhance the industry's profitability and reduce its energy footprint.

Canada has one of the world's largest oil reserves, mostly located in the form of oil sands. Oil sands are a loose sand deposit, which comprises a viscous bitumen in its unconsolidated matrix, comprising primarily of sand, clay, and water saturated with bitumen. A typical oil sands deposit contains about 10% bitumen, 5% water and 85% solids, but bitumen content can be as high as 20% in some sections. About 15% to 20% of the Canadian oil sands reserve, comprising 140 billion barrels of bitumen, can be found at depths less than 75 meters where surface mining is economically feasible. In conventional oil sand surface mining operations, the ore is typically extracted using large capacity shovels and haul trucks that transfer the mined ore to the slurry preparation plant (“SPP”), where water and additives are added to the crushed ore. The oil sands slurry produced within the SPP is often non-homogenous, lumpy and poorly mixed. Lumps of bitumen, clay, ice and sand can be bound together in large chunks, which can be as large as five inches in diameter.

Roughly 60,000 tons of oil sand, flowing in the form of slurry with about 60% solids (wt.), is ablated per hour to produce 0.5 million barrels of bitumen per day. Oil sands slurry is one of the most high-wear process fluids in the industry, as abrasive silica sand and entrained oxygen cause both erosion and corrosion of hydro-transport lines. Slurry lines require constant inspection and maintenance and many oil sands mining facilities have full time maintenance crews dedicated solely to the repair and replacement of slurry pumps and pipelines. Maintenance is responsible for 50% of the operating cost due to high wear rates in the long hydro-transport pipelines and this cost is one of the main factors that influences mining costs per barrel of bitumen produced. Cost of maintenance and energy requirements are considered as two of the greatest challenges in the oil sand extraction and hydro-transport processes. Carbon dioxide accounts for about 85% to 95% of the total GHG emissions in the oil sand surface mining operations, and some estimates suggest that about 40 kilograms (“kg”) of CO₂ is emitted during mining, conditioning, and extraction to produce one barrel of synthetic crude oil. There is an economic and environmental need to reduce GHG emissions, use of the haul trucks, and length requirements of the slurry hydro-transport pipelines. Use of shorter pipelines would bring substantial decreases in the maintenance costs.

There is a present need for a solution that does not transport oil sands (which comprise more than 80% of abrasive quartz) to the extraction plant, which would significantly reduce slurry transportation requirements to the extraction and/or bitumen upgrading plant, bringing significant economic and environmental benefits to the oil sands industry. A solution is needed that provides a compact unit while providing a high throughput, so it can be a part of a modular, skid-mounted bitumen extraction plant that can be run at a mine face enabling both primary bitumen extraction and sand cleaning functions using warm water and slurry conditioning reagents. This modular approach would enable primary bitumen recovery and create clean sands that can be safely disposed of on site.

What is needed is a system and method able to recover a material of interest by reducing the amount of overburden produced by the recovery process. What is also needed is a high-pressure slurry ablation technology that provides high-shear conditions and more efficient bitumen liberation, better slurry conditioning and aeration, shorter processing times, and improved bitumen recovery of the downstream units. What is also needed is a process that increases the mechanical energy to which lumps are exposed as well as increases lump collision frequencies, both enhancing lump ablation rate.

### BRIEF SUMMARY OF EMBODIMENTS OF THE PRESENT INVENTION

Embodiments of the present invention relate to a method for liberating and processing a heterogenous material, the method comprising: passing the heterogeneous material into a high-pressure slurry ablation system comprising a collision chamber and a nozzle to form an ablated heterogeneous material; and passing the ablated heterogeneous material into a mineral processing circuit. In another embodiment, the mineral processing circuit comprises a flotation circuit. In another embodiment, the mineral processing circuit comprises a grinding circuit. In another embodiment, the mineral processing circuit comprises a cyclone circuit. In another embodiment, the mineral processing circuit comprises an attrition cell circuit. In another embodiment, the high-pressure slurry ablation system replaces a component of the mineral processing circuit.

Embodiments of the present invention also relate to a system for ablating a heterogeneous material, the system comprising: a first collision chamber comprising a pressure transducer; a knife gate; a valve; a splitter in communication with the valve; and a distributor. In another embodiment, the system further comprises a second collision chamber. In another embodiment, the distributor is a side entry linear distributor. In another embodiment, the distributor is a top entry linear distributor. In another embodiment, the distributor is a top entry split distributor.

Embodiments of the present invention also relate to a method for ablating a heterogeneous material, the method comprising: passing the heterogeneous material through a knife gate; passing the heterogeneous material through a valve; passing the heterogeneous material through a splitter in communication with the valve; passing the heterogeneous material through a distributor; passing the heterogeneous material into a first collision chamber comprising a pressure transducer; and forming an ablated heterogeneous material. In another embodiment, the method further comprises passing the heterogeneous material into a second collision chamber. In another embodiment, the distributor is a side entry linear distributor. In another embodiment, the distributor is a top entry linear distributor. In another embodiment, the distributor is a top entry split distributor. In another embodiment, the method further comprises measuring the force that the heterogeneous material exerts on a surface. In another embodiment, the splitter radially splits the heterogeneous material into a plurality of collision chambers.

Embodiments of the present invention also relate to a system for ablating a heterogeneous material, the system comprising: a multiple nozzle chamber, the multiple nozzle chamber comprising: a chamber body; a plurality of nozzles; and an adapter-spacer. In another embodiment, the system further comprises a removable blind mounting plate for covering at least one nozzle. In another embodiment, the system further comprises a removable insert nozzle. In another embodiment, the chamber body is polyhedron-shaped.

Embodiments of the present invention also relate to a method for ablating a heterogenous material, the method comprising: passing heterogeneous material into a multiple nozzle chamber comprising a chamber body and an adapter-spacer; and forming an ablated heterogenous material. In another embodiment, at least one of the plurality of nozzles is covered by a removable blind mounting plate. In another embodiment, at least one of the plurality of nozzles is a removable insert nozzle.

Embodiments of the present invention also relate to a system for ablating a heterogeneous material, the system comprising: a combined collision chamber, the combined collision chamber comprising a plurality of modular nozzles; and each of the plurality of modular nozzles comprising an angled adapter. In another embodiment, at least one modular nozzle of the plurality of modular nozzles comprises a position sensor. In another embodiment, at least one modular nozzle of the plurality of modular nozzles comprises a motorized adaptor. In another embodiment, the system further comprises an inter-collision separation device.

Embodiments of the present invention also relate to a method for ablating a heterogeneous material, the method comprising: passing heterogeneous material into combined collision chamber comprising a plurality of modular nozzles, wherein each of the plurality of modular nozzles comprises an angled adapter. In another embodiment, at least one modular nozzle of the plurality of modular nozzles comprises a position sensor. In another embodiment, at least one modular nozzle of the plurality of modular nozzles comprises a motorized adaptor. In another embodiment, the method further comprises an inter-collision separation device.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a process flow diagram showing components and steps of a high-pressure slurry ablation system comprising parallel collision chambers, according to an embodiment of the present invention;

FIG. 2A is a diagram showing an expanded view of collision chamber of a system, according to an embodiment of the present invention and FIG. 2B is a diagram showing a distributor radially connected to collision chambers of a system, according to an embodiment of the present invention;

FIG. 3 is a process flow diagram showing components and steps of a high-pressure slurry ablation system comprising a cyclone, according to an embodiment of the present invention;

FIG. 4 is a process flow diagram showing another configuration of a high-pressure slurry ablation system, according to an embodiment of the present invention;

FIG. 5 is a series of images and diagrams showing uranium mineral pre-high-pressure slurry ablation, uranium post-high-pressure slurry ablation, and a graphic illustration of selective liberation of material of interest from heterogenous material by high-pressure slurry ablation, according to an embodiment of the present invention;

FIG. 6 is a process flow diagram showing components and steps of a uranium high-pressure slurry ablation system for uranium mineral ablation, according to an embodiment of the present invention;

FIG. 7 is a photo diagram showing high-pressure slurry ablation technology as applied to filter sand treatment and reuse, according to an embodiment of the present invention;

FIG. 8 is a process flow diagram showing a system for processing heterogeneous material comprising filter sand, according to an embodiment of the present invention;

FIG. 9 is a process flow diagram showing one configuration of components and processing steps of a high-pressure slurry ablation system, according to an embodiment of the present invention;

FIG. 10 is a process flow diagram showing another configuration of components and processing steps of a high-pressure slurry ablation system, according to an embodiment of the present invention;

FIG. 11 is a diagram showing a side view of a feed tank system, according to an embodiment of the present invention;

FIG. 12 is a diagram showing the main tank of a feed tank system, according to an embodiment of the present invention;

FIG. 13 is a diagram showing a collision chamber of a system, according to an embodiment of the present invention;

FIG. 14 is an illustration showing a collision chamber comprising a nozzle and shim, according to an embodiment of the present invention;

FIG. 15 is an illustration showing a perspective view of an aligned collision chamber with nozzles, according to an embodiment of the present invention;

FIG. 16 is diagram showing a cross-sectional view of a slim chamber nozzle, according to an embodiment of the present invention;

FIGS. 17A and 17B are perspective and bottom view illustrations showing a multiple nozzle chamber, respectively, according to an embodiment of the present invention;

FIG. 18 is a perspective view illustration showing a multiple nozzle chamber with blind mounting plates, according to an embodiment of the present invention;

FIGS. 19A, 19B, and 19C are diagrams showing different sized adapter spacers, according to an embodiment of the present invention;

FIGS. 20A, 20B, and 20C are illustrations showing a side, top, and perspective view of a distributor used with a multiple nozzle chamber, respectively, according to an embodiment of the present invention;

FIG. 21 is a cross-sectional view showing a removable insert nozzle, according to an embodiment of the present invention;

FIG. 22 is a schematic showing a nozzle alignment calculation, according to an embodiment of the present invention;

FIG. 23 is a table showing the recovery and weight percentages per sample time for high-pressure slurry ablation treatment, according to an embodiment of the present invention;

FIG. 24 is a graph showing experimental data of turnover rate against percent solids of different parts in the system, according to an embodiment of the present invention;

FIG. 25 is a table showing X-ray diffraction (“XRD”) lab results from feed and product material from a filter sand processing continuous pilot, according to an embodiment of the present invention;

FIG. 26A and FIG. 26B are illustrations showing isometric view of a collision chamber with a radially continuous nozzle, and a cross-sectional view of a collision chamber with a radially continuous nozzle, respectively, according to an embodiment of the present invention;

FIG. 27 is an illustration showing a collision chamber with load cells installed for imbalance detection, according to an embodiment of the present invention;

FIG. 28 is an illustration showing a cross-sectional view of a collision chamber with a continuous rod feed adapter, according to an embodiment of the present invention;

FIG. 29 is an illustration showing a combined classification high-pressure slurry ablation collision system, according to an embodiment of the present invention;

FIG. 30 is an illustration showing a combined classification, high-pressure slurry ablation collision, and froth flotation system, according to an embodiment of the present invention;

FIG. 31A is an illustration showing a computational fluid dynamics simulation of particles in a piping classification system, and FIG. 31B is a graph of particle size distribution results of a computational fluid dynamics (“CFD”) simulation, according to an embodiment of the present invention;

FIG. 32 is a diagram showing a system for determination of particle fracture when propelled by an air jet into a collision box, according to an embodiment of the present invention;

FIG. 33 is a diagram showing an adjustable high-pressure slurry ablation collision chamber for upstream process hoses, according to an embodiment of the present invention;

FIG. 34 is a diagram showing various types of multi-hole and shaped-hole nozzles, according to an embodiment of the present invention;

FIG. 35A and FIG. 35B are diagrams showing a double orifice nozzle with a section line A-A, and a section view of the double orifice nozzle of FIG. 35A along section line A-A, respectively, according to an embodiment of the present invention;

FIG. 36A and FIG. 36B are diagrams showing a double orifice nozzle with a section line B-B, and a section view of the double orifice nozzle of FIG. 36A along section line B-B, respectively, according to an embodiment of the present invention;

FIG. 37 is a diagram that illustrates the particle dispersion upstream of a nozzle that forces particle segregation, according to an embodiment of the present invention;

FIG. 38 is an illustration showing a mineral processing system, according to an embodiment of the present invention;

FIG. 39 is an illustration showing integration of a high-pressure slurry ablation system into a grinding feed system, according to an embodiment of the present invention;

FIG. 40 is a diagram that illustrates a collision regime for breaking down hydrocarbon material or any other heterogenous material, according to an embodiment of the present invention;

FIG. 41 is a diagram that illustrates an isometric view of a removable nozzle insert, according to an embodiment of the present invention;

FIG. 42 is a diagram that illustrates a section view of a removable nozzle insert, according to an embodiment of the present invention;

FIG. 43A, FIG. 43B, and FIG. 43C are diagrams that illustrate an isometric view, a side section view, and a front section view, respectively, of a wear plate collision chamber, according to an embodiment of the present invention;

FIG. 44A, FIG. 44B, and FIG. 44C are diagrams that illustrate an isometric view, a side section view, and a front section view, respectively, of a high-pressure slurry ablation array collision chamber, according to an embodiment of the present invention;

FIG. 45 is a process flow diagram that illustrates the components and steps of a high-pressure slurry ablation system as applied to hydrocarbon processing, according to an embodiment of the present invention;

FIG. 46 is a process flow diagram that illustrates the components and steps of a high-pressure slurry ablation system for processing hydrocarbon material with multiple methods for recovery, according to an embodiment of the present invention;

FIG. 47 is a process flow diagram that illustrates the components and steps of a high-pressure slurry ablation system for processing hydrocarbon material integrated into hydro transport systems, according to an embodiment of the present invention; and

FIG. 48 is a diagram that illustrates a flow conditioner for breaking down hydrocarbon material, according to an embodiment of the present invention.

### DETAILED DESCRIPTION OF THE INVENTION

Embodiments of the present invention relate to a method for liberating and processing a heterogenous material, the method comprising: passing the heterogeneous material into a high-pressure slurry ablation system comprising a collision chamber and a nozzle to form an ablated heterogeneous material; and passing the ablated heterogeneous material into a mineral processing circuit.

Embodiments of the present invention also relate to a system for ablating a heterogeneous material, the system comprising: a first collision chamber comprising a pressure transducer; a knife gate; a valve; a splitter in communication with the valve; and a distributor.

Embodiments of the present invention also relate to a method for ablating a heterogeneous material, the method comprising: passing the heterogeneous material through a knife gate; passing the heterogeneous material through a valve; passing the heterogeneous material through a splitter in communication with the valve; passing the heterogeneous material through a distributor; passing the heterogeneous material into a first collision chamber comprising a pressure transducer; and forming an ablated heterogeneous material.

Embodiments of the present invention also relate to a system for ablating a heterogeneous material, the system comprising: a multiple nozzle chamber, the multiple nozzle chamber comprising: a chamber body; a plurality of nozzles; and an adapter-spacer.

Embodiments of the present invention also relate to a method for ablating a heterogenous material, the method comprising: passing heterogeneous material into a multiple nozzle chamber comprising a chamber body and an adapter-spacer; and forming an ablated heterogenous material.

Embodiments of the present invention relate to a method of ablating heterogenous material, the method comprising: passing heterogenous material through a hydrocyclone; separating the heterogenous material into an overflow heterogenous material and an underflow heterogenous material; passing the underflow heterogenous material through a splitter; passing the underflow heterogenous material through a collision chamber, wherein the plurality of collision chambers comprises a nozzle, a pressure transducer, and a knife gate; and passing the overflow heterogenous material to a froth flotation bank or circuit.

The system and method of the present invention may be used to ablate a heterogeneous material and/or mineral, including but not limited to, sandstone, silicates, claystone, siltstone, mudrock, limestone, other sedimentary rock, metal sulfide, metal oxide, or a combination thereof; or for the recovery of a selected material of interest including, but not limited to, a metal-containing compound or phosphates. Other heterogenous materials or materials of interest can include previously processed materials which may be recycled or repurposed, including but not limited to industrial waste, electronic waste (e-waste), construction and building materials, alloys, aggregate, concrete, and other materials where one component needs to be separated from another component., etc.

High-pressure slurry ablation, may be effective for the disassociation of hydrocarbons from hydrocarbon-bearing sands (for example, oil spill site material and/oil sands), and other natural heterogenous materials with low to medium hardness. Hydrocarbon-bearing sands and/oil sands may comprise lumps that required break up. High-pressure slurry ablation may achieve lump breakage in oil sands by intensive lump-to-lump and lump-to-plate collisions provided by the high-pressure pump moving slurry through a set of nozzles.

The material of interest may be a post-depositional material, carried into an already established sandstone formation by mineral-bearing solutions. Without being bound to any particular theory, when a mineral-bearing solution reaches a reduction zone, carbon may cause the uranium to reduce and precipitate out of solution to form stable uranium-containing compounds. Metal-containing compounds may form as a mineral patina surrounding grains and/or in carbonaceous material.

The system and method of the present invention may ablate a heterogeneous material at a greater rate, at greater efficiency, or at a lower cost than conventional ablation systems and methods. The system and method of the present invention may also ablate more types of heterogeneous material than conventional ablation systems and methods.

High-pressure slurry ablation may be used to treat low grade abandoned uranium mine (“AUM”) waste material. Through particle-to-particle collisions, the surface coating of carnotite (uranium bearing mineral) on the host quartz grains may be selectively liberated from the quartz grains and ground into a finer material fraction while the quartz grains remain intact. Size separation, either through screening or use of a hydrocyclone, to remove the finer particle contaminants from the post-high-pressure slurry ablation treated heterogeneous material may be used. Since larger particles possess higher kinetic energies in the heterogeneous material jets when exiting the nozzles of the high-pressure slurry ablation chamber at the same velocities as smaller particles, efficiencies of treatment by high-pressure slurry ablation may be improved by removing finer material fractions from the process stream prior to entering the high-pressure slurry ablation system.

High-pressure slurry ablation may process heterogeneous material comprising phosphate. High-pressure slurry ablation may be configured to fracture a gangue material such as calcite, dolomite, quartz, orthoclase, or a combination thereof from the base apatite matrix of a heterogeneous material. Gangue material that is bound within the apatite matrix agglomeration may fracture along grain boundaries through particle-to-particle collisions produced by high-pressure slurry ablation. Fractures of the agglomerated apatite matrix may be achieved through particle-to-particle collisions without fracturing larger, purer apatite particles as the gangue is disseminated within these agglomerates. This allows for separation of fine material comprising the fractured gangue from the apatite particles.

High-pressure slurry ablation may process heterogeneous material comprising zinc, lead, and/or a zinc-lead mineral. High-pressure slurry ablation may be used as a size reduction step prior to flotation of the heterogeneous material. High-pressure slurry ablation may process sphalerite, which comprises zinc associated with other soft minerals such as calcite and dolomite. Sphalerite may be reduced, e.g., ablated, to a particle size of at least about 1 micrometer, about 1 micrometer to about 300 micrometers, about 5 micrometers to about 275 micrometers, about 10 micrometers to about 250 micrometers, about 25 micrometers to about 225 micrometers, about 50 micrometers tor about 200 micrometers, about 75 micrometers to about 175 micrometers, about 100 micrometers to about 150 micrometers, or about 300 micrometers. Heterogeneous material comprising zinc may be processed in a closed circuit with a cyclone, separating the heterogeneous material comprising zinc at a given, micrometer particle size, e.g., with about 175 micrometers to about 225 micrometers. Heterogeneous material comprising zinc greater than a given size may be recirculated back to the high-pressure slurry ablation process to be reduced in size along with an incoming heterogenous material feed. Heterogeneous material comprising zinc may be processed due to the soft nature of this mineral type. Heterogeneous material less than a given size may then be sent to a flotation recovery bank where the fractured gangue is separated from the sphalerite for recovery of the sphalerite.

High-pressure slurry ablation may process heterogeneous material comprising copper, nickel, a copper-nickel mineral, hematite, magnetite, goethite, limonite, gibbsite, boehmite, diaspore (bauxite), cuprite, tenorite, malachite, azurite, chrysocolla, cassiterite, rutile, ilmenite, anatase, chromite, pyrolusite, psilomelane, manganite, hausmannite, uraninite, carnotite, coffinite, wolframite, scheelite, columbite, tantalite, microlite, zircon, baddeleyite, monazite, bastnäsite, garnierite, clay, Ni-oxide mineral, spodumene, lepidolite, garnet (almandine, pyrope, etc.), chalcopyrite, bornite, chalcocite, covellite, enargite, tetrahedrite, galena, jamesonite, boulangerite, sphalerite, wurtzite, pentlandite, millerite, heazlewoodite, pyrite, pyrrhotite, marcasite, molybdenite, acanthite/argentite, stephanite, pyrargyrite, polybasite, cinnabar, stibnite, arsenopyrite, realgar, orpiment, cobaltite, linnaeite, carrolite, bismuthinite, greenockite, cooperate, braggite, sperrylite, or a combination thereof.

High-pressure slurry ablation may be used in reprocessing applications as a liberation step after initial ball mill fracturing is performed prior to flotation recovery of both copper and nickel from the host heterogeneous material. Pentlandite comprising nickel and chalcopyrite comprising copper may be present among gangue minerals including, but not limited to, pyrrhotite, plagioclase, serpentine, orthopyroxene, other iron oxide minerals, or a combination thereof. Through particle-to-particle collisions on material, remaining pentlandite or chalcopyrite, which may be previously present as interstitials at the larger particle size prior to the ball mill fracture, may be selectively liberated from the gangue materials. Particle-to-particle collisions may be performed on heterogenous material at least about 125 micrometers, about 125 micrometers to about 175 micrometers, about 135 micrometers to about 165 micrometers, about 145 micrometers to about 155 micrometers, or about 175 micrometers in size. Processing at this stage may result in a particle size reduction of at least about 10 micrometers, about 10 micrometers to about 30 micrometers, about 15 micrometers to about 25 micrometers, or about 30 micrometers, and prepare the minerals for flotation recovery downstream. Due to high-pressure slurry ablation operation, recoveries may be increased by at least about 0.5% for both copper and nickel. The copper and/or nickel grades may be maintained within at least about 0.1%, about 0.1% to about 0.3%, about 0.15% to about 0.25%, or about 0.3% of the heterogeneous material not reprocessed through high-pressure slurry ablation.

High-pressure slurry ablation may reprocess copper tailings to improve copper recovery. High-pressure slurry ablation may process heterogenous material comprising particles with a diameter greater than about 1.2 centimeter in diameter to particles comprising a diameter of about 50, about 50 to about 100, about 60 to about 90, about 70 to about 80, or about 100 micrometers in diameter. In traditional copper recovery technologies, chalcocite that may be ground too fine to be recovered, and scavenger flotation circuits may agglomerate with fine particles of the ground hematite material. An advantage of high-pressure slurry ablation over traditional copper recovery methods is that the hematite and chalcocite minerals may be deagglomerated from each other, allowing for exposed surface area on the cleaned chalcocite particles to react with post-high-pressure slurry ablation flotation separation through particle-to-particle collisions via high-pressure slurry ablation.

Embodiments of the present invention relate to a method of ablating hydrocarbon material, the method comprising: passing hydrocarbon material through an auger and/or an extruder; mixing the hydrocarbon material with water to produce a slurry; passing the slurry through a heat exchanger; passing the slurry through a splitter; and passing the slurry through a collision chamber.

Embodiments of the present invention also relate to a method of ablating hydrocarbon material, the method comprising: passing hydrocarbon material through into a process tank; mixing the hydrocarbon material with water to produce a slurry; passing the slurry through a splitter; passing the slurry through a collision chamber; collecting overflow oil with an overflow launder; passing the slurry through a tricanter centrifuge to produce tricanter separated water, oil, and sand; imaging the tricanter separated water; and either passing the tricanter separated water through an emulsion separation cyclone or an electrolytic separation process.

Embodiments of the present invention also relate to a method of ablating hydrocarbon material, the method comprising: passing hydrocarbon material through a hydro transport length; mixing the hydrocarbon material with water to produce a slurry; passing the slurry through a primary flow conditioner; passing the slurry through a splitter; passing the slurry through a secondary flow conditioner; passing the slurry through a collision chamber; and passing the slurry through a tertiary flow conditioner.

Embodiments of the present invention also relate to a flow conditioner, wherein the flow conditioner comprises a chamber, a flange, bulbs, and ribs.

Embodiments of the present invention also relate to a collision regime, wherein the collision regime comprises a first plane, a second plane, first plane nozzles, second plane nozzles, first plane streams, second plane streams, a collision point, a jet-collided stream, a collision plate, and a plate-collided stream.

The term “heterogeneous material” as used herein includes, but is not limited to, an ore, rock, mineral, mining or industrial waste, agglomerate, slurry, fines, particles, comminuted matter, crushed matter, mineral tailings, sand, oil sand, or a combination thereof. The heterogeneous material may comprise a material of interest and may further comprise a bulk material. Other heterogenous materials may include previously processed materials which may be recycled or repurposed, including but not limited to industrial waste, electronic waste (e-waste), construction and building materials, alloys, aggregate, concrete, plant materials, chemical compounds, other materials where one component needs to be separated from another component.

The term “material of interest” as used herein includes, but is not limited to, a metal, including but not limited to a metal ion, metal compound, metal atom, or a combination thereof; a mineral; oil; clay; bitumen; sand; an agricultural product including, but not limited to, rice, seeds, nuts, or a combination thereof; a chemical powder; or a combination thereof; previously processed materials which may be recycled or repurposed, including but not limited to industrial waste, electronic waste (e-waste), construction and building materials, alloys, aggregate, concrete, plant materials, chemical compounds, and other materials where one component needs to be separated from another component.

The term “metal” as used herein includes, but is not limited to, a metal ion, metal compound, or a combination thereof. The metal may include, but is not limited to, neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“Al”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The terms “ablate”, “ablation”, or “ablated” as used herein means and includes wearing away by flexure, rebound, and distortion. Ablation may also include, but is not limited to, wear by friction, chipping, spalling, another erosive process, or a combination thereof. Ablation may be used to separate one or more materials of interest in a heterogeneous material. The separation may be achieved based on the physical characteristics of the material of interest. When particles are ablated, the boundary between different materials of interest in a heterogeneous material may become more highly stressed than the bulk materials themselves. Ablation may physically remove coatings from an underlying bulk material or a material of interest. Ablation imparts energy to the heterogeneous material being ablated to physically dissociate the material into various fractions (e.g., a solid fraction and an oil or two solid fractions). The ablated particles may then be classified to divide the heterogenous material into various fractions. Ablation and separation may significantly reduce the amount of material to be further processed to recover the one or more desired components of the heterogeneous material. Heterogeneous material may be repeatedly ablated. Ablated material that is subject to additional ablation is further ablated heterogeneous material.

The term “formation” as used herein means a naturally occurring region of heterogeneous material disposed at or below ground level.

The terms “tank” and “vessel” are used interchangeably throughout and mean any object capable of holding and/or containing matter.

The term “hydrocarbon material” and “oil sands” as used includes, but is not limited to, loose sand deposit, which comprises a viscous bitumen in its unconsolidated matrix, comprising of sand, clay, and water saturated with bitumen. A typical oil sands deposit may comprise about 10% bitumen, 5% water and 85% solids, but bitumen content can be as high as 20% in some sections. Oil sands reserves, comprising bitumen, can often be found at depths less than 75 meters where surface mining is economically feasible. The oil sands are typically extracted using large capacity shovels and haul trucks that transfer the oil sands to the slurry preparation plant (“SPP”), where water and additives may be added to the crushed ore. The oil sands slurry produced within the SPP is often non-homogenous, lumpy and poorly mixed. Lumps of bitumen, clay, ice, and sand can be bound together in large chunks, which can be as large as about 5 inches in diameter.

The term “conditioning” as used herein refers the process of oil sand lump reduction and ablation, bitumen liberation, and air bubble-bitumen droplet attachment.

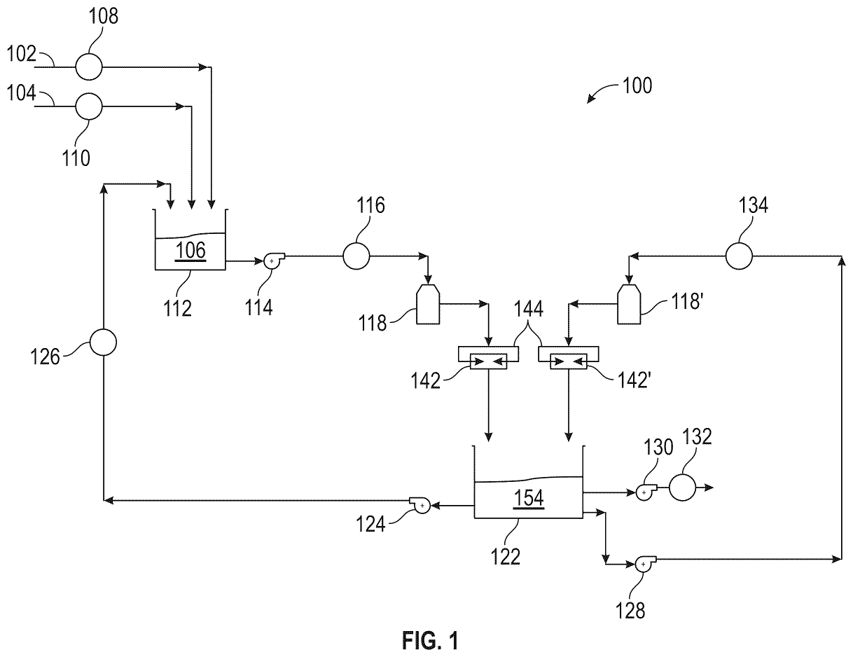

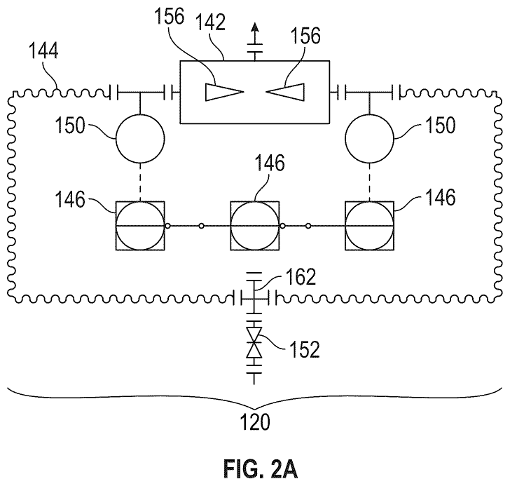

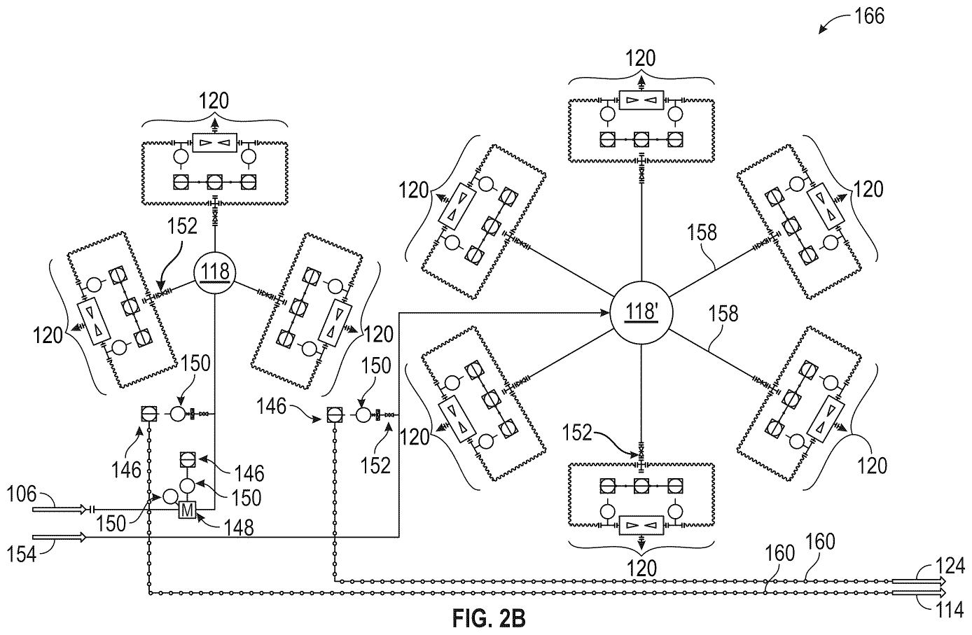

Turning now to the figures, FIG. 1 shows system 100. Heterogeneous material 102 and dilution water 104 flow into feed tank 112, through conduits 108 and 110, respectively, creating heterogeneous material 106. Heterogeneous material 106 is then conveyed through conduit 116 by at least one feed pump 114 into distributor 118. Distributor 118 splits the flow of heterogeneous material 106 into one or more streams. Heterogeneous material 106 then flows from distributor 118 into collision chamber array 142 through conduits 144, which is described in more detail in FIGS. 2A and 2B. Collision chamber array 142 ablates heterogeneous material 106 into ablated heterogeneous material 154. After exiting collision chamber array 142, ablated heterogeneous material 154 then flows into main tank 122. Recycle pump 124 conveys ablated heterogeneous material 154 from main tank 122 through conduit 126 and back into feed tank 112. Recycle pump 124 controls the slurry amount in feed tank 112, leading to fewer process fluctuations as well as providing greater collision probability for particles feeding into distributor 118 and collision chamber arrays 142 in fluid communication with distributor 118. Recirculation pump or pumps 128 also conveys ablated heterogeneous material 154 out of main tank 122 through conduit 134 into distributor 118′. Distributor 118′ splits the flow of ablated heterogeneous material 154 into one or more streams. Ablated heterogeneous material 154 then flows from distributor 118′ into collision chamber array 142′ through conduits 144 and 158, which is described in more detail in FIGS. 2A and 2B. Collision chamber array 142′ further ablates ablated heterogeneous material 154. Ablated heterogeneous material 154 from collision chamber array 142′ then re-enters main tank 122. Product pump 130 then withdraws ablated heterogeneous material 154 from main tank 122 through conduit 132 for downstream processes.

In one embodiment, heterogeneous material 102 is fed into system 100. Dilution water 104 dilutes heterogeneous material 106. The diluted heterogeneous material 106 within feed tank 112 is then conveyed by one or more feed pumps 114 in conduit 116 through distributor 118. Conduit 116 connects to distributor 118 through its bottom to reduce space consumed and increase access to the chambers around distributor 118.

Other types of distributors may be used, namely, side entry linear distributors, top entry linear distributors, and top entry split linear distributors. A side entry linear distributor is used with the discharge of the first recirculation pump. A side entry linear distributor, top entry linear distributor, and top entry split linear distributor comprise collision chamber arrays 142 and valves 152 to toggle flow between the two collision chambers 120. Side entry linear distributor, top entry linear distributor, and top entry split linear distributor may comprise a plurality of collision chambers 120, with at least one operating chamber and bypass chamber. The flow may be switched between the chambers to allow them to be serviced when necessary. Side entry linear distributor has material entering the distributor from the side via conduit 116. Top entry linear distributor and top entry split linear distributor have material entering from the top via conduit 116. Top entry linear distributor has material directly entering the top of the distributor. With top entry split linear distributor, the material diverges into two flows then reconverges before being directed towards collision chambers 120 in operation. The top entry option distributors (top entry linear distributor and top entry split linear distributor) result in an even distribution of solids and liquids across the flow profile. A more symmetrical flow profile causes the liquid and solid flow rates between the two nozzles 156 on the operating collision chamber 120 to be closer to the same after the split in conduits 144, which may result in better performance of collision chamber 120.

Conduits 144 used with side entry linear distributor, top entry linear distributor, and top entry split linear distributor have piping crosses instead of tees when the material is split from one flow to two flows. Piping crosses are capped on the end opposite to where the material enters the pipe fitting. This allows solid material to accumulate in the pipe cap. Piping crosses provide padding for high velocity particles flowing through conduits 144. Instead of impacting the pipe fitting, the particles impact the accumulated solid material. This reduces wear in the pipe fitting and conduit 144.

There may be another distributor on either side entry linear distributor, top entry linear distributor, or top entry split linear distributor, which is used on the discharge of second recirculation pump 128. This distributor is similar to the previously described radial distributors. This configuration has material feeding in through the top of the distributor body and split into the collision chambers 120 with chambers in operation and chambers available for bypass.

FIG. 2A shows an expanded view of collision chamber 120, comprising collision chamber array 142, conduit 144, pressure sensors 146, pressure transducers 150, valve 152, nozzles 156, and splitter 162. Heterogeneous material 106 enters collision chamber 120 through valve 152. Valve 152 splits heterogeneous material 106 into two streams, via splitter 162, which travel through conduits 144. Conduits 144 transport heterogeneous material 106 onto opposite ends of collision chamber array 142, where the two streams of heterogeneous material 106 collide as they exit nozzles 156. Pressure sensors 146 measure the pressure flow of heterogeneous material 106 as it goes through nozzle 156. Pressure transducers 150 measure the force that heterogeneous material 106 exerts on surfaces in contact with it.

Distributor 118 splits the flow of heterogeneous material 106 radially between three collision chambers 120, each comprising two opposing nozzles 156 within collision chamber arrays 142, as shown in FIG. 2B. Heterogeneous material 106 enters system 166 via suction from motor 148. Pressure transducers 150 measure the force that heterogeneous material 106 exerts and pressure sensors 146 measure the pressure flow of heterogeneous material 106. Heterogeneous material 106 flows into distributor manifold 118, where the flow is split radially between three collision chambers 120. Ablated heterogeneous material 154 enters system 166 and flows into distributor 118′, where the flow is split radially between six collision chambers 120. The entering stream of heterogeneous material 106 is controlled with one or more recycle pumps 124, pressure sensor 146, pressure transducer 150, conduit 160, and valve 152. The entering stream of ablated heterogeneous material 154 is managed with feed pump 114 alongside a pressure sensor 146, pressure transducer 150, conduit 160, and a valve 152. Valve 152 may optionally comprise a collision chamber array valve toggle between the use of or bypass chambers. At least one of valve 152 is closed at all times (as indicated by the darker valve color in FIG. 2B) to ensure that there is a backup chamber for maintenance while the system remains in operation.

There may be more than two distributors 118 and 118′ and each distributor 118 or 118′ splits the flow of heterogeneous material 106 or ablated heterogeneous material 154 to one or more collision chambers 120. The system may comprise nozzles 156 installed in collision chambers 120 around distributor 118, where distributor 118 operates with two valves 152 closed and one valve 152 open.

Ablated heterogeneous material 154 exits collision chambers 120 and proceeds through chutes in communication with the bottom of collision chambers 120 into main tank 122. Ablated heterogeneous material 154 within main tank 122 is conveyed by one or more recirculation pumps 128 through conduit 134 to distributor 118′ which radially distributes ablated heterogeneous material 154 through six sets of conduits 144 to six collision chambers 120, each comprise a collision chamber array 142′, exiting distributor 118′. Conduits 144 exiting distributor 118′ are staggered at different heights to allow for chamber mounting heights to be staggered. Staggered chamber mounting heights provide more space for access and service of collision chambers 120. Both distributor 118 and distributor 118′ each comprise collision chamber arrays 142 and collision chamber arrays 142′, respectively, and valves 152 to allow for bypass of collision chambers 120 during operations. During normal operations, five of valves 152 are open while one is closed and in reserve.

For both distributor 118 and distributor 118′, pressure is measured using pressure transducers 150. Pressure transducers 150 are in communication with variable frequency drives (“VFDs) (not shown) of feed pump 114 and recirculation pump 128 to control the system using a programmable logic controller (“PLC”) (not shown) allowing the colliding jets to reach the pressure and velocity sufficient to achieve the desired level of ablation.

Ablated heterogeneous material 154 exiting collision chambers 120 surrounding distributor 118 flows through chutes attached to the bottom of collision chambers 120 back into main tank 122. Ablated heterogeneous material 154 disposed in main tank 122 is also conveyed by product pump 130 through conduit 132 for downstream processing by further unit operations. Further, ablated heterogeneous material 154 is conveyed from main tank 122 using recycle pump 124 through conduit 126 back to feed tank 112. Recycle pump 124 controls heterogeneous material 106 level in feed tank 112, this may result in fewer process fluctuations as well as provide a means to achieve greater collision probability for particles feeding into distributor 118 and collision chambers 120 in fluid communication with it.

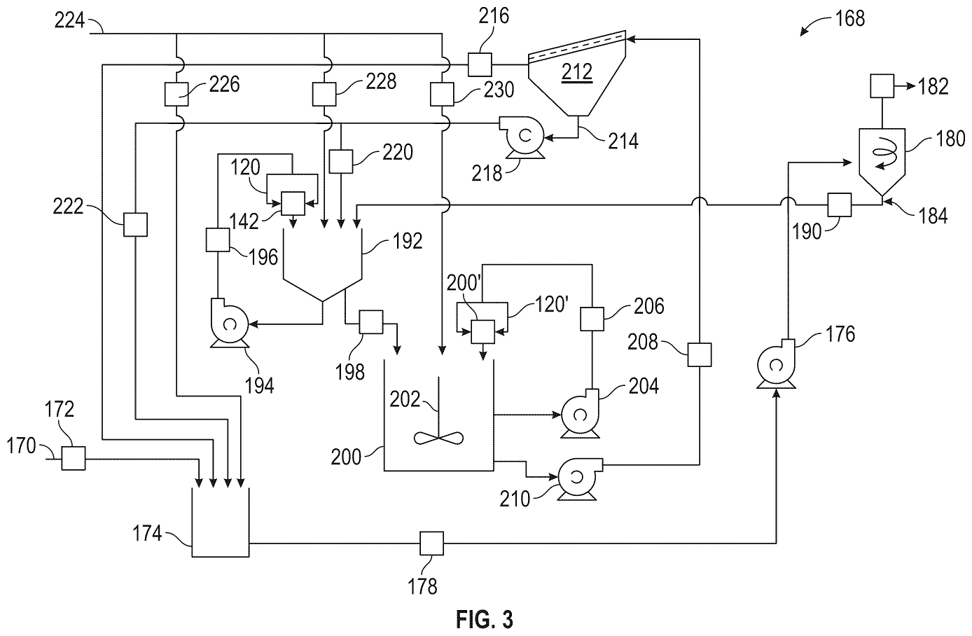

FIG. 3 shows system 168. System 168 is configured to process heterogeneous material in closed-circuit operation with a hydrocyclone. System 168 may be operated with any material including, but not limited to, graphite ore to achieve a certain P80 (80% of particles are smaller than a certain size). Since system 168 is operated in closed circuit, particles may circulate around system 168 multiple times until the particle size is reduced to a desired size. When system 168 does not include hydrocyclone or any other sizing process operation 180, system 168 does not need to achieve a specific particle size, and only liberation occurs. When system 168 does not include hydrocyclone or any other sizing process operation 180, system 168 is referred to as an “open circuit”.

The throughput of system 168 may be approximately 10 metric tons per hour, which would be represented by a circulating load ratio of 285%. System 168 may have a circulating load of at least about 0%, about 0% to about 2000%, about 10% to about 1750%, about 25% to about 1500%, about 50% to about 1250%, about 100% to about 1000%, about 250% to about 750%, about 300% to about 600%, or about 2000%.

Material 170 is fed into system 168 through conduit 172 into first tank 174. First pump 176 transfers the contents of first tank 174 into hydrocyclone 180 via conduit 178. Overflow (“O/F”) 182 of hydrocyclone 180 is transferred to the next downstream process if the particle is small enough. Underflow (“U/F”) 184 of hydrocyclone 180 comprises the coarse particles which need further processing. Underflow 184 is transferred via conduit 190 to first recirculation tank 192, which is a high-pressure slurry ablation recirculation tank. First recirculation pump 194 and conduit 196 process the material through one or more high-pressure slurry ablation collision chambers 120, each comprising collision chamber array 142. Conduit 198 may be a gravity fed line between first recirculation tank 192 and second recirculation tank 200. The flow in conduit 198 may be at a lower flow rate than that of conduit 196 to increase the probability of multiple passes through collision chamber 120 to process material 170 before particles are transferred to second recirculation tank 200. Second recirculation tank 200 is another high-pressure slurry ablation recirculation tank with second recirculation pump 204 and conduit 206 providing one or multiple high-pressure slurry ablation collision chambers 120′, each comprising collision chamber array 142′, with material 170. Second recirculation tank 200 also comprises mechanical agitator 202. Mechanical agitator 202 may achieve particle suspension.

Streamflow through conduit 208 comprises heterogeneous material that is transported out of second recirculation tank 200 through screen pump 210 into dewatering screen 212. Dewatering screen 212 allows water and some small particles to pass through into screen undersize (“U/S”) 214. As a result, screen oversize (“O/S”) 216 has a higher heterogeneous material density than screen undersize 214. Screen oversize 216 is transferred into first tank 174. Screen undersize 214 is transferred with undersize pump 218 to both first recirculation tank 192 and first tank 174 through conduit 220 and conduit 222, respectively. Conduit 222 controls the heterogeneous material density in conduit 178 at a preferred value. Conduit 220 ensures that the heterogeneous material density of material 170 in first recirculation tank 192 remains at a preferred value. Dilution water 224 is disposed into first tank 174 via conduit 226, into first recirculation tank 192 via conduit 228, and into second recirculation tank 200 via conduit 230. Dilution water 224 is used to control material 170 density in each respective tank.

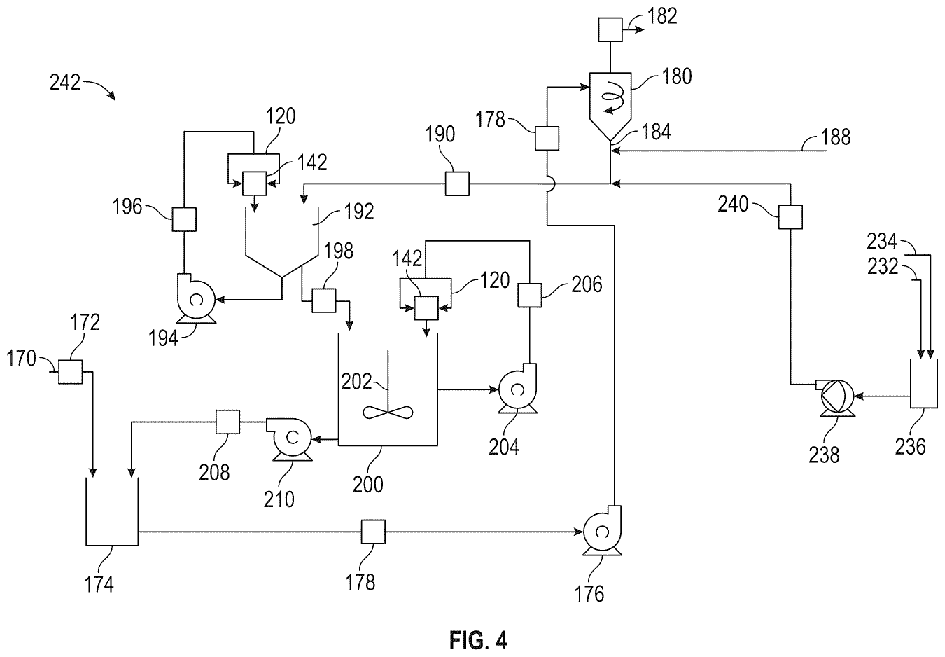

FIG. 4 shows system 242. Material 170 is fed into system 242 through conduit 172 into first tank 174. The flow in conduit 178 comprises of the heterogeneous material transported by first pump 176 into hydrocyclone 180. Overflow (“O/F”) 182 of hydrocyclone 180 comprises fine particle size cyclone overflow (O/F) material 170, which proceeds to the next process for recovering and upgrading the high-pressure slurry ablation liberated material, including but not limited to froth flotation. Underflow 184 of hydrocyclone 180 comprises coarse material 170 and requires more ablation. Underflow 184 is combined with low density heterogeneous material 240 and process water 188. System recycle water 232 and dilution water 234 are combined in recycle water tank 236 to reduce heterogeneous material density. System recycle water 232 is of very low heterogeneous material density. Low density heterogeneous material 240 is transferred by low density heterogeneous material pump 238 from recycle water tank 236 to be combined with underflow 184. System recycle water 232 is the combined tailings of many downstream processing operations. Optionally, the heterogeneous material density of system recycle water 232 may range from less than 1% solids to 50% solids. Underflow 184 is combined with low density heterogeneous material 240 and is transferred via conduit 190 to first recirculation tank 192, which is a high-pressure slurry ablation recirculation tank. First recirculation pump 194 and conduit 196 process the material through one or more collision chamber array 142. Conduit 198 is a gravity fed line between first recirculation tank 192 and second recirculation tank 200. The flow in conduit 198 is at a lower flow rate than that of conduit 196 to increase the probability of multiple passes through collision chamber array 142 to process material 170 before particles are transferred to second recirculation tank 200. Second recirculation tank 200 is another high-pressure slurry ablation recirculation tank with second recirculation pump 204 and conduit 206 feeding one or multiple collision chamber array 142. Second recirculation tank 200 also comprises mechanical agitator 202 for particle suspension. Conduit 208 and screen pump 210 transfer material 170 back into first tank 174.

In system 168 shown in FIG. 3, heterogeneous material density of the high-pressure slurry ablation system and hydrocyclone feed stream from conduit 178 are controlled using a dewatering screen 212. Not shown in FIG. 3, system recycle water 232 enters first tank 174 directly. In system 242 shown in FIG. 4, heterogeneous material density of the high-pressure slurry ablation system and hydrocyclone feed stream from conduit 178 are controlled using system recycle water 232.

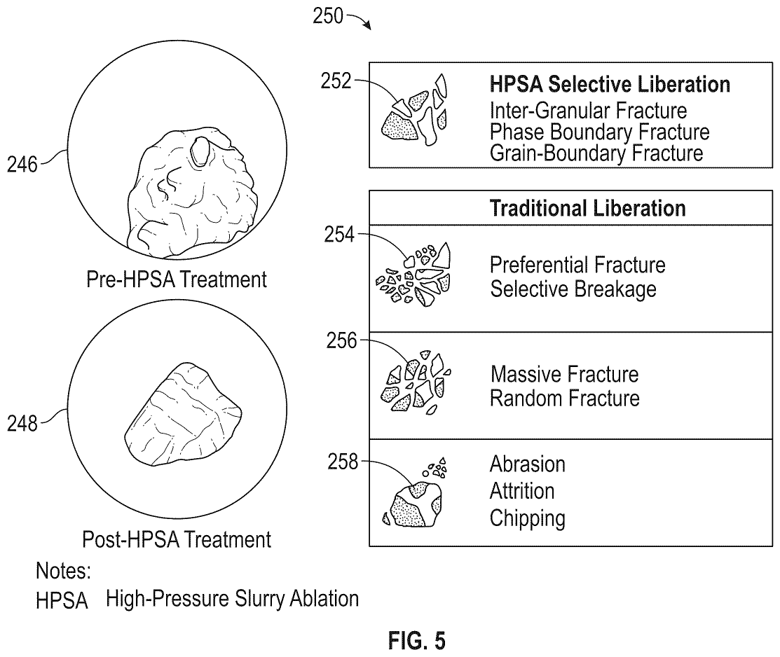

FIG. 5 shows photographs of quartz grain 244 disposed with uranium pre-high-pressure slurry ablation 246 and post-high-pressure slurry ablation 248. Also shown is a graphic illustration of selective liberation performed by high-pressure slurry ablation 250. Illustration of high-pressure slurry ablation selective liberation 252 shows crack propagation along the grain boundary of the material resulting in selective separation of material of interest from heterogenous material. Illustrations of traditional liberation including preferential separation 254, random fracture 256, and chipping 258 show reduction in size of particles of heterogenous material without selective separation of material of interest from the heterogenous material.

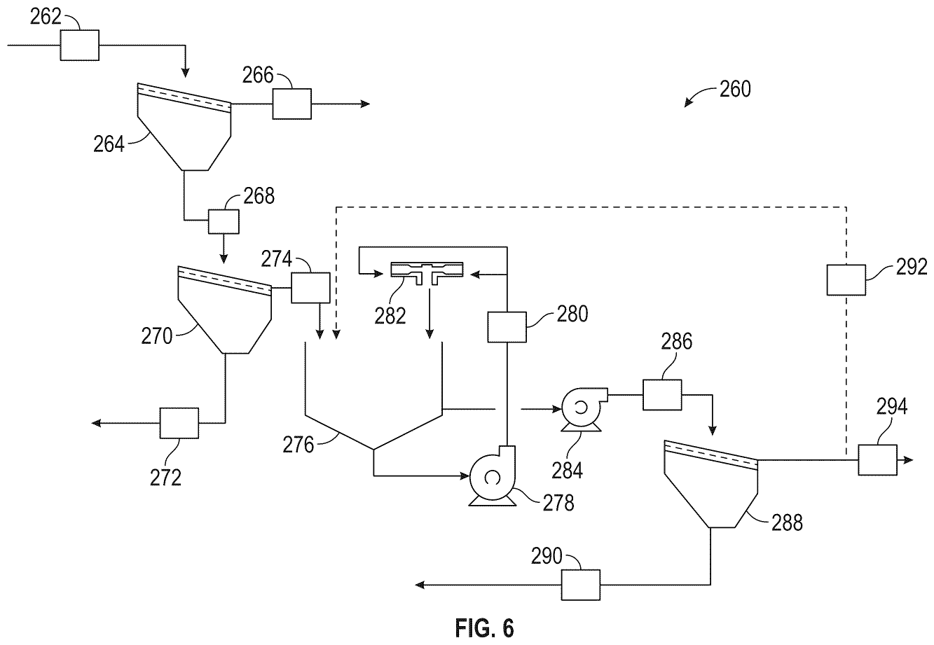

FIG. 6 details an example of high-pressure slurry ablation abandoned uranium mine (“AUM”) remediation 260. Feed material within conduit 262 enters oversize screen 264 where larger material is separated into conduit 266 that leaves the circuit and finer material is separated into conduit 268 that enters pre-cut screen 270. Pre-cut screen 270 separates fine material that is less efficiently processed by high-pressure slurry ablation into conduit 272 while sending coarser material that is more efficiently processed by high-pressure slurry ablation through conduit 274 and into main tank 276. Material is conveyed from main tank 276 through conduit 280 into high-pressure slurry ablation collision chamber 282 via pump 278, which then returns to main tank 276. Relying on probability of collisions based on the recirculating flow rate of conduit 280 to the discharge flow rate of conduit 286. Subsequent high-pressure slurry ablation systems may be used within the process before conduit 286 is conveyed via pump 284 from main tank 276 to product screen 288 where this again separates post-high-pressure slurry ablation treated material into a fine material heterogeneous material within conduit 290 and a coarse product stream within conduit 294. Depending on the concentration requirements of the uranium, radium-226, or other contaminants of concern, a fraction of streamflow in conduit 294 may be split from the coarse product and recycled back to main tank 276 via conduit 292. This provides more selective liberation of the contaminants and may reduce the final contaminant concentrations in conduit 294.

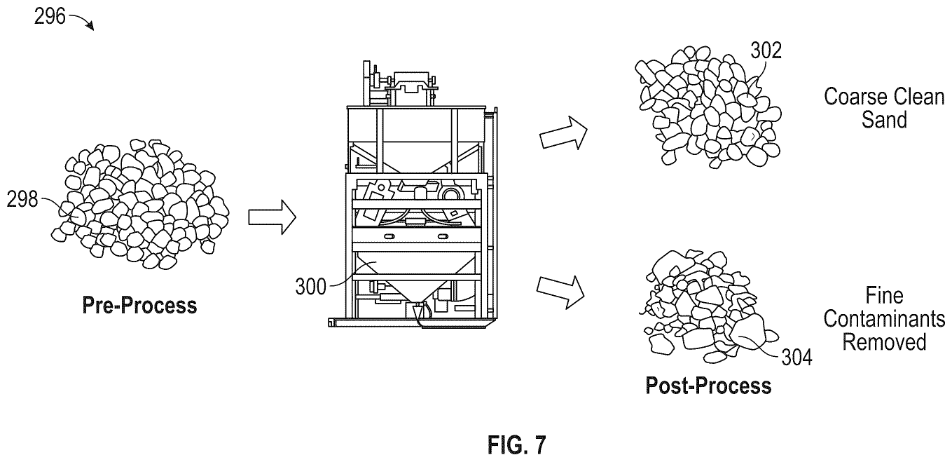

The high-pressure slurry ablation systems described above may be applied to filter sand treatment and reuse. Sand media used for filtration eventually fouls and requires replacement. High-pressure slurry ablation may be used to clean the surfaces of this sand through its particle collisions to regenerate and reuse. FIG. 7 shows a picture of the cleaning results of filter sand high-pressure slurry ablation 296. Feed sand 298 is foul and needs to have contaminants removed to be reused. Feed sand 298 goes through high-pressure slurry ablation process 300, which results in coarse clean sand 302 and separated fine contaminants 304.

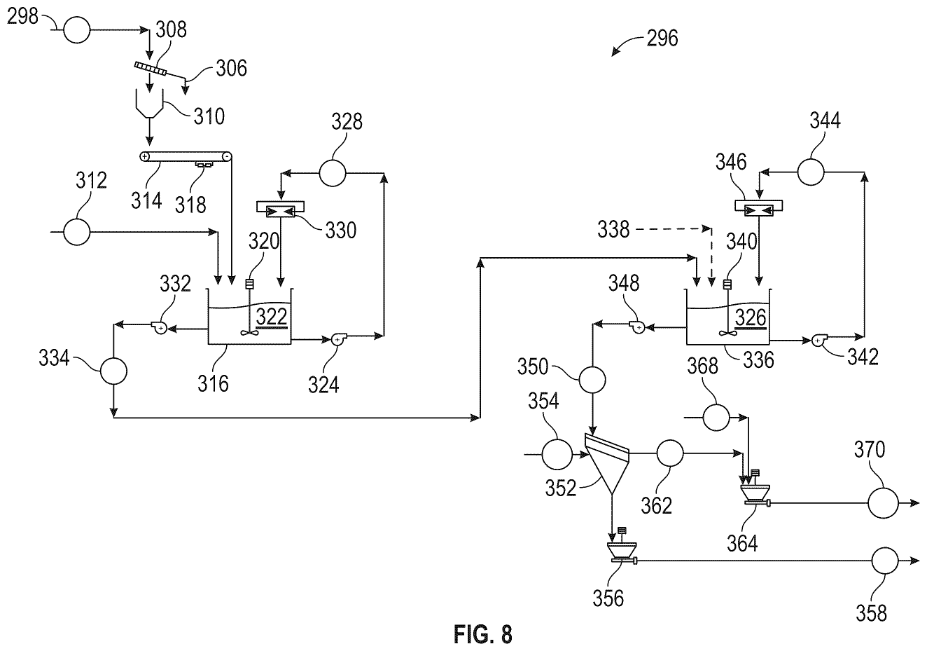

FIG. 8 shows an overview of the process flow diagram for filter sand high-pressure slurry ablation 296. Vibrating feed screen 308 filters out oversize material 306 and sends it to the ground without crushing or processing. Vibrating feed screen 308 has apertures which may vary in size. Feed sand 298 enters hopper 310, which deposits feed sand 298 onto conveyor 314. Conveyor 314 further comprises conveyor belt scale 318 for throughput measurement and dilution water 312 control. Dilution water 312 enters first stage high-pressure slurry ablation tank 316 along with feed sand 298 exiting feed conveyor belt 314, to create heterogeneous material 322. First stage high-pressure slurry ablation tank 316 has first agitator 320 to agitate heterogeneous material 322 and allow material to be suspended. First high-pressure slurry ablation pump 324 recirculates heterogeneous material 322 in first stage high-pressure slurry ablation tank 316 through conduit 328 to operating chambers with bypass chamber 330. Heterogeneous material 322 processed through first collision chamber 330 is then deposited back into first stage high-pressure slurry ablation tank 316.

Heterogeneous material 322 is conveyed by pump 332 through conduit 334 into second stage high-pressure slurry ablation tank 336. Second high-pressure slurry ablation pump 342 recirculates second stage ablated material 326 in second stage high-pressure slurry ablation tank 336 via conduit 344 through operating chambers with bypass chamber 346. Second agitator 340 allows material to be suspended in second stage high-pressure slurry ablation tank 336. Second stage ablated material 326 processed through second collision chamber 346 is deposited back into second stage high-pressure slurry ablation tank 336. Flush water 338 is also added into second stage high-pressure slurry ablation tank 336 to control second stage ablated material 326 levels. Second stage ablated material 326 is conveyed by pump 348 via conduit 350 into product size separation screen 352. Oversize material 362 is sorted out by vibrating product size separation screen 352 and is disposed into cleaned product pump 364. Dilution water 368 is added into cleaned product pump 364 to dilute oversize material 362. Screen spray water 354 is used to clean any remaining oversize material 362 and other debris off product size separation screen 352. Undersize material 358 from the vibrating of product size separation screen 352 is disposed into reject fines pump 356. Cleaned product pump 364 and dilution water 368 clean sand product 370 as it exits filter sand high-pressure slurry ablation 296. After reject fines pump 356, undersize material 358 exits filter sand high-pressure slurry ablation 296.

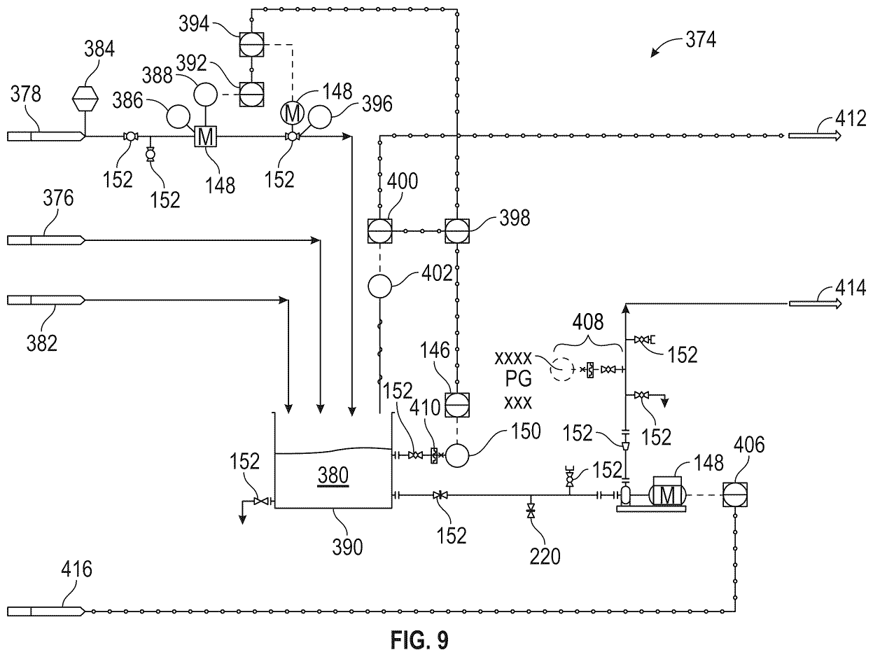

FIG. 9 shows system 374 where feed solid 376, dilution water 378, and feed recycle heterogeneous material 382 are disposed of into feed tank 390, creating heterogeneous material 380. Dilution water 378 and heterogeneous material 380 flow through a series of multiplier 384, motors 148, flow elements 386, flow transmitters 388, flow indicator controllers 392, hand switches 394, flow valves 396, density indicator controllers 398, level indicator controllers 400, level indicator transmitters 402, pressure gauges 408, filter 410, pressure sensors 146, pressure transducers 150, and valves 152 before arriving at feed tank 390. Feed distributor pressure 416 is also measured in feed tank 390 by sensor 406. A series of valves 152 transport heterogeneous material 380 to various places, including out of system 374 as feed heterogeneous material 414, which is measured with feed tank level 412.

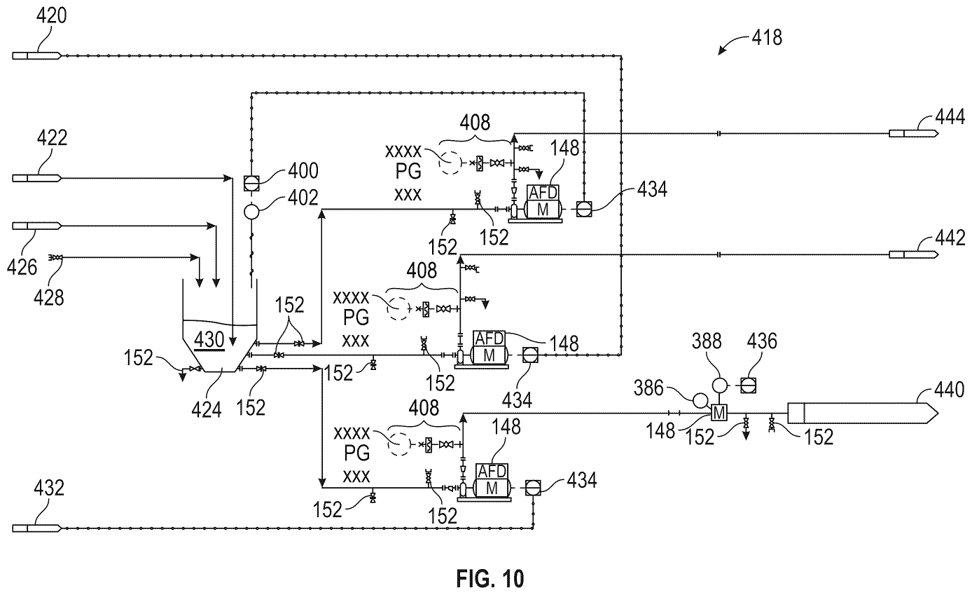

FIG. 10 shows system 418 where feed chamber drains 422, main recirculation chamber drains 426, and startup water 428 are mixed into heterogeneous material 430 in main tank 424. Heterogeneous material 430 exits main tank 424 as product 444, feed recycle heterogeneous material slurry 442, and main recirculation heterogeneous material 440. Product 444 is the result of heterogeneous material 430 exiting main tank 424 and being processed through a series of valves 152, motors 148, and pumps 434, and measured via level indicator controllers 400, level indicator transmitters 402, and pressure gauges 408. Feed recycle heterogeneous material slurry 442 is the result of heterogeneous material 430 exiting main tank 424 and being processed through a series of valves 152, motors 148, and pumps 434, and measured via pressure gauges 408 and feed tank level 420. Main recirculation heterogeneous material 440 is the result of heterogeneous material 430 exiting main tank 424 and being processed through a series of valves 152, motors 148, flow elements 386, and pumps 434, and measured via flow transmitters 388, flow indicators 436, pressure gauges 408, and main distributor pressure 432.

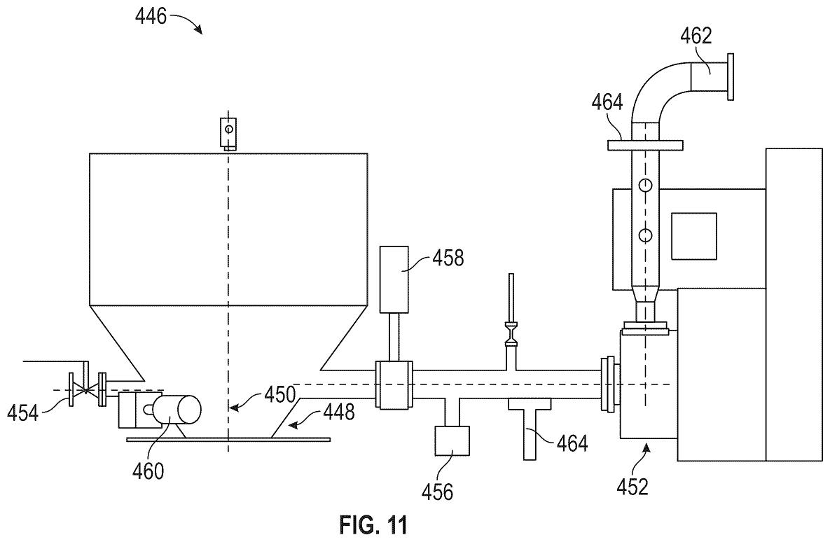

FIG. 11 shows an elevation view of feed tank system 446. Feed tank system 446 comprises feed tank 448, level transmitter 450, feed pump 452, valve 454, endcap 456, flow control 458, pump 460, and feed outlet 462. Feed tank system 446 is supported structurally with structure members 464. Structure members 464 may comprise steel material.

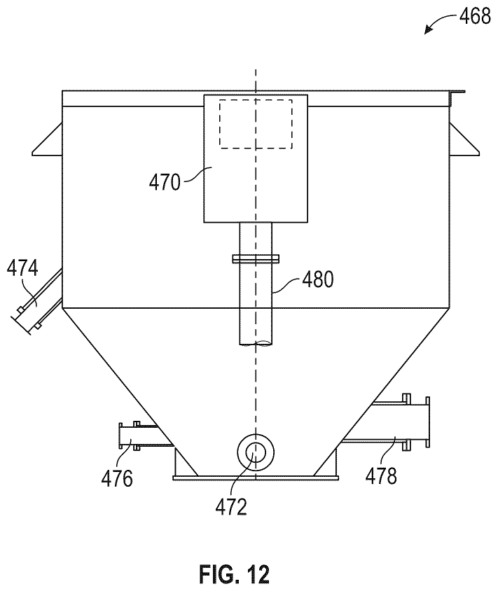

FIG. 12 shows a schematic of the embodiments of main tank 468. Main tank 468 comprises overflow 470, drain 472, outlet product pump 474, outlet recirculation pump 476, outlet main pump 478, and overflow pipe 480.

FIG. 13 shows a close-up view of collision chamber 120. Chamber flange 482 and chamber discharge transition 484 may be seen connecting collision chamber body 486 to collision chamber outlet 488. As shown, collision chamber 120 has two nozzle inlets 490 and a viewing window 492. The system may comprise a primary logic controller (“PLC”) for operational stabilization. FIGS. 9 and 10 show instrument control loops relating to level, pressure, flow, and density. These instruments in combination with advanced mathematical and statistical models are used to control system operation. The PLC and/or control loops may be in communication with any component of the system. The PLC and/or control loops may control, regulate, modify, adjust, and/or monitor any component of the system. The PLC and/or control loops may comprise a software program. The software program may employ machine learning, artificial intelligence, a neural network, an algorithm, or a combination thereof.

With high-pressure slurry ablation, nozzle alignment allows material streams to impact completely. Nozzle alignment is critical to the efficiency of high-pressure slurry ablation operation. Imbalanced nozzles increase energy consumption and can potentially lead to premature wear of components.

FIG. 14 shows shim 500 and adjusting nozzle 502 on collision chamber 496. Shim 500 compensates for collision chambers 496 that have mounting structures that may not be completely aligned. Shims 500 may vary in thickness. By changing the angle, the location and angle of the tip of adjusting nozzle 502 changes. Adjusting nozzles 502 allows the flow trajectory from each adjusting nozzle 502 to impact each other completely, and the collision point to be centered in collision chamber 496. Shims 500 may be placed at any location around chamber mounting plate 508, and may be placed around bolts 510, which are the top/bottom bolts or left/right bolts that secure adjusting nozzle 502 onto collision chamber body 512.

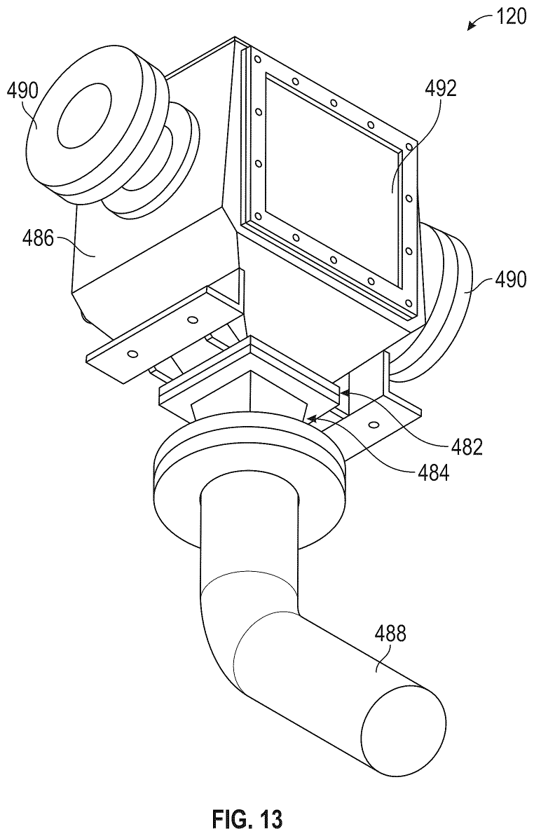

Aligned collision chamber 498 as shown in FIG. 15 reduces the need to use alignment methods such as shim 500 in collision chamber 496. Aligned collision chamber 498 is manufactured to much tighter design tolerances than previously patented chamber designs. As shown in FIG. 15, aligned collision chamber 498 comprises main body 514, viewing window 516, slim chamber nozzles 504, mounting bracket 518, nozzle mounting adapter 522, and fitted housing panels 522 and 526. Slim chamber nozzles 504 further comprise piping connection flange 506 and channel 520. Main body 514 is connected to slim chamber nozzles 504 via nozzle mounting adapter 522. Viewing window 516 allows a user to see what is happening inside of aligned collision chamber 498. Mounting brackets 518 allow aligned collision chamber 498 to be secured to a support structure. Piping connection flange 506 connects aligned collision chamber 498 and slim chamber nozzles 504 to a pipe to receive a material. Channel 520 is the pathway within slim chamber nozzle 504 that allows material to flow through.

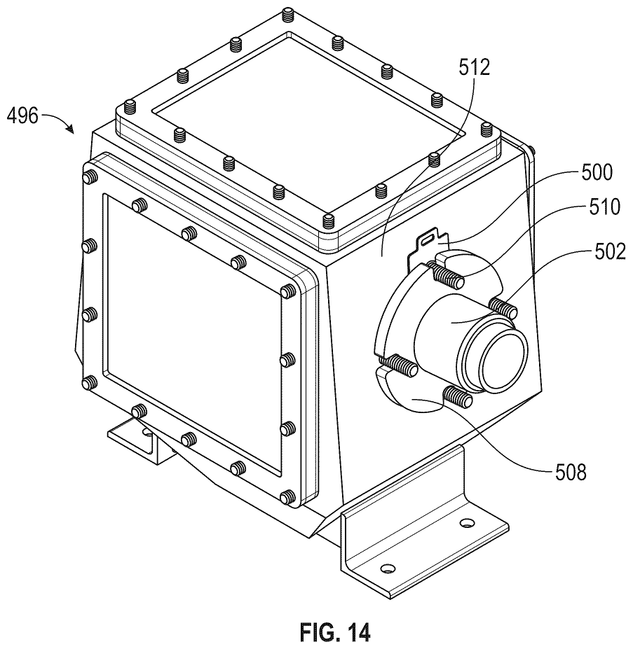

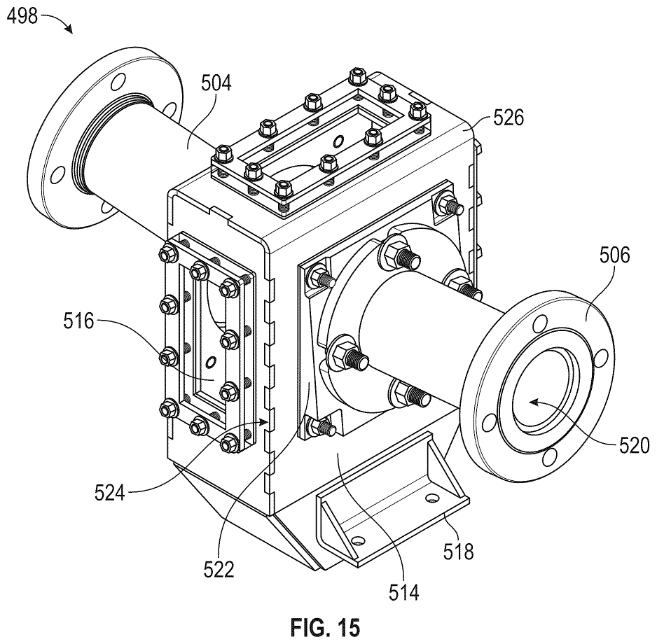

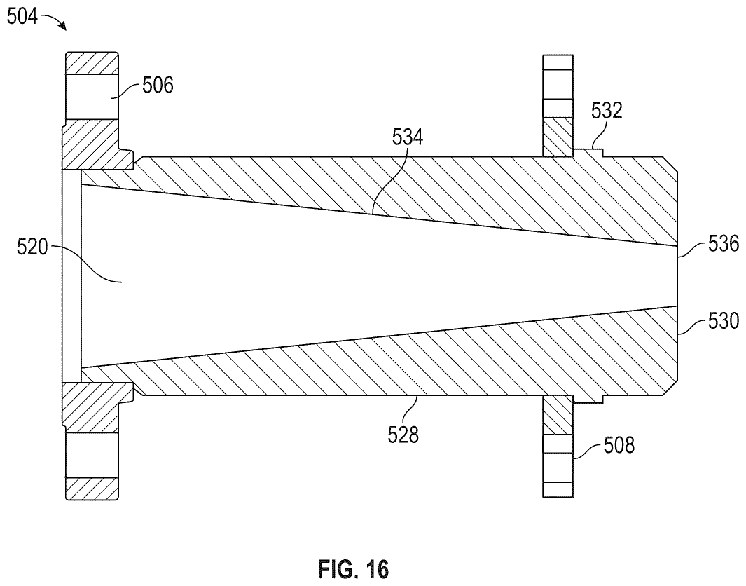

FIG. 16 shows a detailed version of slim chamber nozzle 504. Slim chamber nozzle 504 comprises base section 528, chamber mounting plate 508, piping connection flange 506, locating collar 532, channel 520, nozzle outlet 536, and nozzle tip 530. Chamber mounting plate 508 and piping connection flange 506 are located on opposite ends of base section 528. Chamber mounting plate 508 allows communication between slim chamber nozzle 504 and aligned collision chamber 498. Locating collar 532 allows easier insertion of slim chamber nozzle 504 into aligned collision chamber 498. Channel 520 has a taper 534 that tapers slim chamber nozzle 504 from a wide end to a narrow end located at nozzle outlet 536 and nozzle tip 530.

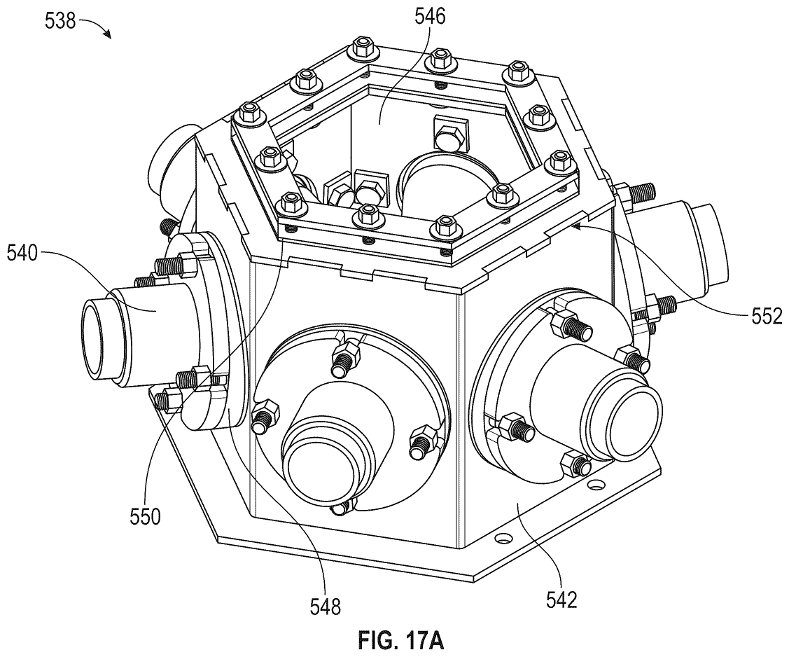

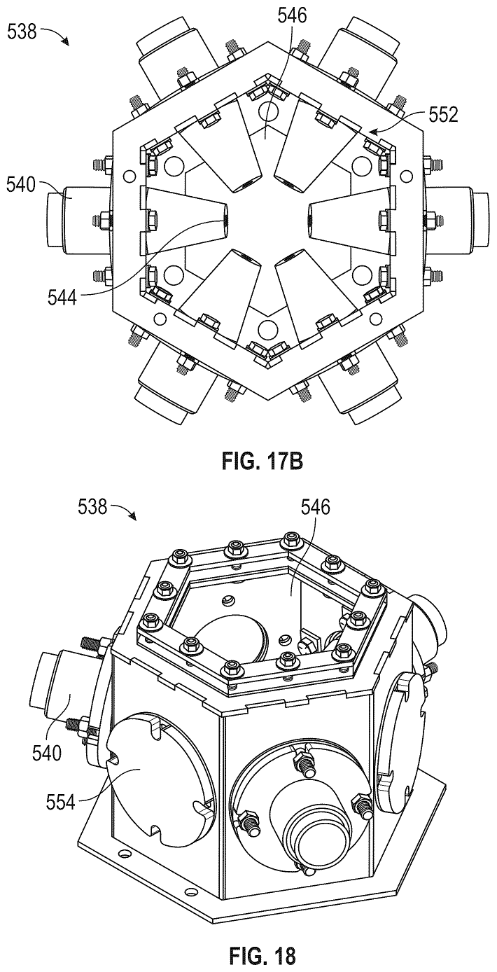

As shown in FIGS. 17A and 17B, two or more nozzles 540 are used in multiple nozzle chamber 538. FIGS. 17A and 17B show different perspective views of multiple nozzle chamber 538. Multiple nozzle chamber 538 may be run in configurations of one, two, three, four, five, or six nozzles 540. Multiple nozzle chamber 538 comprises chamber body 542, sight window 546, gaskets 550, adapter spacers 548, nozzles 540, and nozzle outlets 544. Multiple nozzle chamber 538 comprises a hexagonal shaped chamber body 542, with straight walls. Multiple nozzle chamber 538 comprises tab and slots 552 to allow chamber wall alignment before welding. Adapter spacers 548 are used to set both the angle and spacing of nozzles 540 relative to each other. Adapter spacers 548 are machined for high precision. The configuration of multiple nozzle chamber 538 in FIGS. 17A and 17B have adapter spacers 548 for about 5 degrees and/or about 3.5 inches between nozzle outlets 544. Different adapter spacers 548 may be built to allow about 5.5 inches to about 7.5 inches between nozzle outlets 544 with the same about five-degree angle. Adapter spacers 548 may be made at angles greater than or less than five degrees. Adapter spacers 548 may also vary depending on the angle used. Gasket 550 is used between adapter spacers 548 and the walls of chamber body 542 to prevent material or water from leaking out of multiple nozzle chamber 538 while operating. Nozzles 540 used in multiple nozzle chamber 538 have a tapered end leading to nozzle outlet 544.

FIG. 18 shows multiple nozzle chamber 538 with only three nozzles 540 installed. Blind mounting plates 554 are installed to cover the excess nozzle 540 openings.

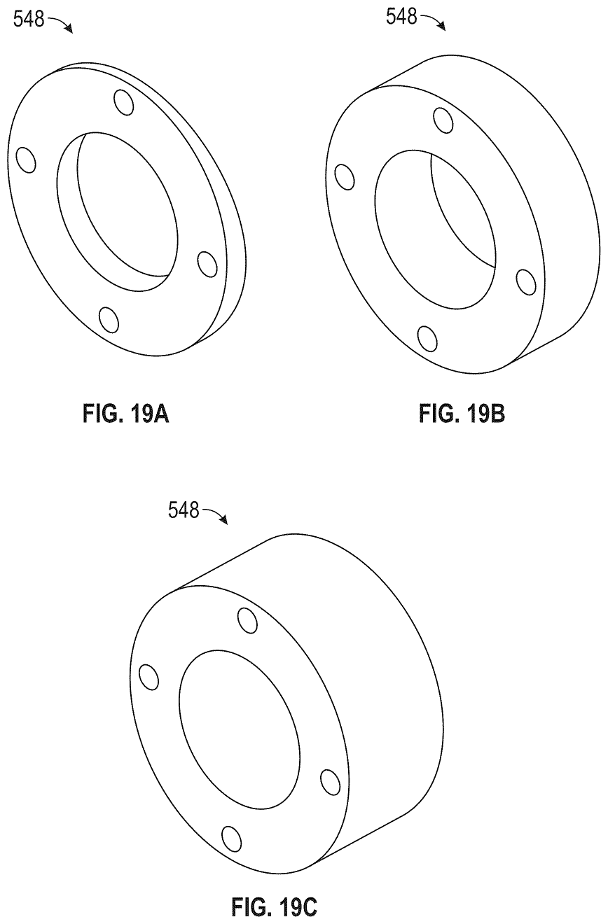

FIGS. 19A, 19B, and 19C show different sized versions of adapter spacers 548. FIG. 19A shows a thin adapter spacer 548, FIG. 19B shows a thicker adapter spacer 548, and FIG. 19C shows an even thicker adapter spacer 548.

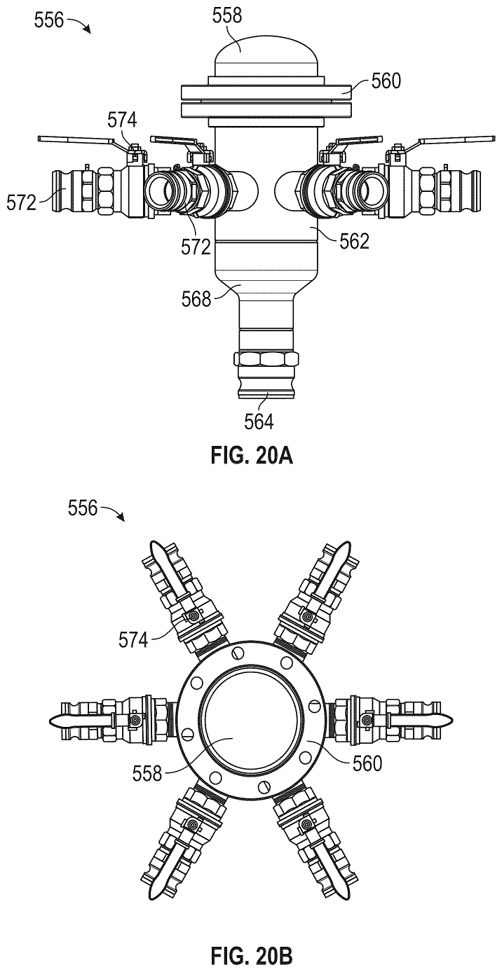

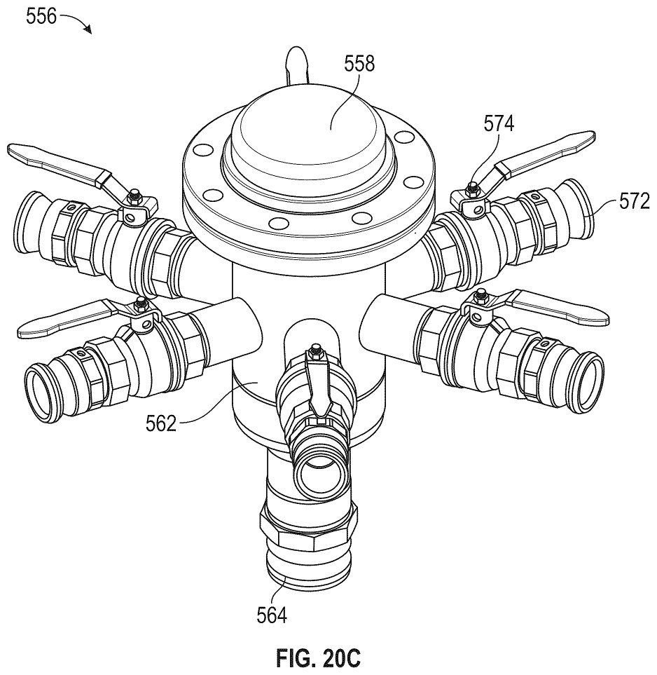

FIGS. 20A, 20B, and 20C show distributor 556 used with multiple nozzle chamber 538 to feed all nozzles 540 from a single pump. Distributor 556 comprises inlet 564, reducer 568, distributor body 562, hemispherical distributor cap 558, outlets 572 with valves 574, and mounting plate 560. Each outlet 572 feeds one nozzle 540. Outlets 572 have valves 574, which allow distributor 556 to feed multiple nozzle chamber 538 when operating with any number of nozzles 540 by closing valves 574. Material comes in through inlet 564, is pressurized and distributed with reducer 568, then output through outlets 572. Hemispherical distributor cap 558 redirects the material flow towards outlets 572 without damaging distributor 556. Mounting plate 560 allows distributor 556 to secured on a support structure.

FIG. 21 show removable insert nozzles 576. Removable insert nozzles 576 allow nozzles to be more easily serviced. Removable insert nozzle 576 comprises permanent outer shell 578, connection flange 580 mounting plate 582, sacrificial insert 588, tapered surface 590, threads 586, and nozzle cap 584. FIG. 21 shows the configuration of removable insert nozzle 576. Sacrificial insert 588 may be made of any material, including but not limited to wear resistant materials. These materials may include, but are not limited to, hardened steel, ceramic, urethane, natural rubber, tungsten carbide, thermoplastics, or a combination thereof. Sacrificial insert 588 protects and allows for inexpensive and easy service of removable insert nozzle 576 from any internal wear of removable insert nozzle 576 constriction due to flow. Sacrificial insert 588 comprises a tapered surface 590. Nozzle cap 584 holds sacrificial insert 588 in place with threads 586. This assists with materials that are not rigid enough to keep their shape under the force of the material through removable insert nozzle 576. Nozzle cap 584 also serves to allow removable insert nozzle 576 to be pushed out while the nozzle is being serviced. Nozzle cap 584 provides a short straight section for the material to flow through before exiting removable insert nozzle 576, which helps to reduce turbulent flows. The wear in this section is minimal since there is no taper, but if this section is worn then nozzle cap 584 may be replaced. If the material flows of two removable insert nozzles 576 become unbalanced, the material will impact nozzle cap 584, which may be replaced instead of having to replace the entire removable insert nozzle 576. Nozzle cap 584 may be made of a hardened steel or similar machinable wear resistant material.

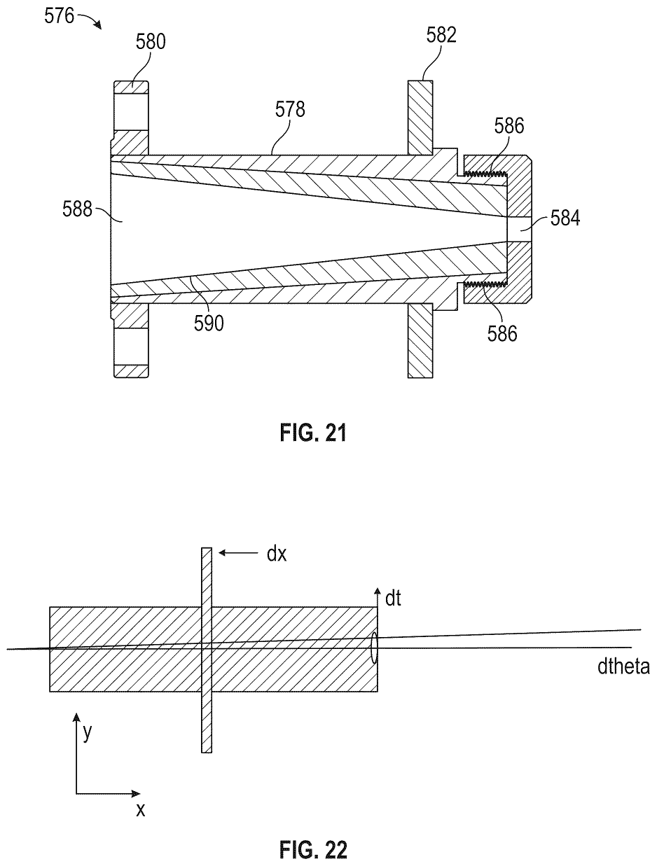

FIG. 22 shows nozzle alignment calculations where dx represents the height of shim 500, dt represents the change from original tip location, and dtheta represents change in angle offset.

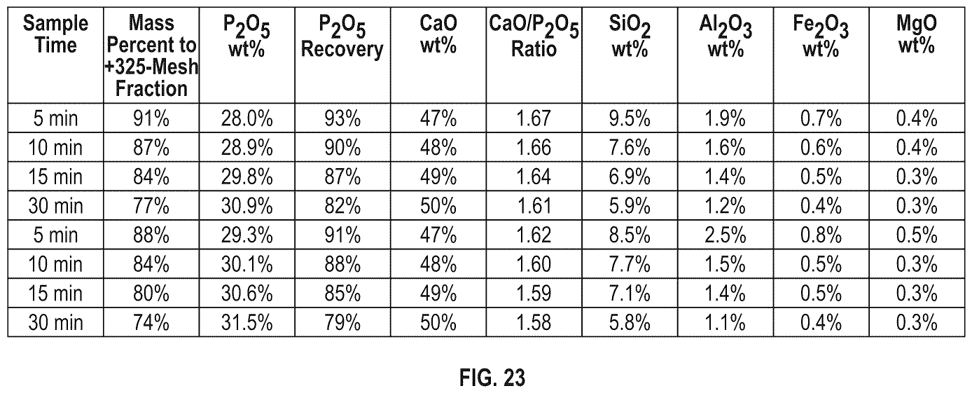

FIG. 23 is a table showing the results from separating material at 325-mesh.

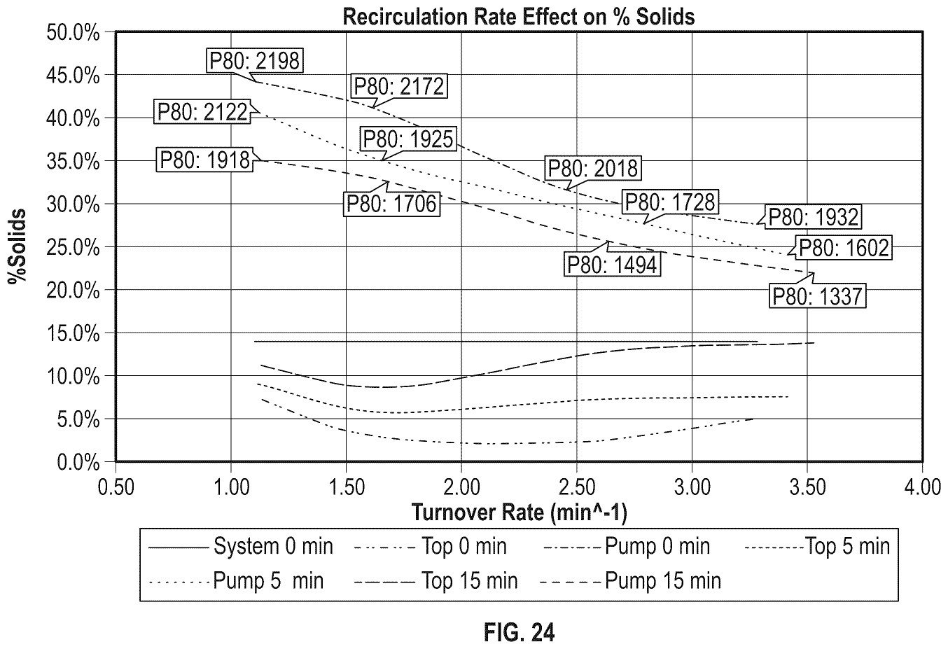

FIG. 24 is a graph showing the results of suspension testing in an high-pressure slurry ablation batch unit with a conical bottom tank. The test may be conducted using a pump with a constant flow rate and recirculating the contents of the tank through an high-pressure slurry ablation collision chamber. The turnover rate may be adjusted by changing the volume of slurry in the tank in each test. In one embodiment, four tests in total may be conducted, with samples taken at 0 minutes, 5 minutes, and 15 minutes. The results may be grouped by time sample between each of the tests. Samples may be taken from the discharge of the pump and from the top of the tank. The results show that homogeneity of the tank increased as recirculation rate increased in the tank. Also, as the particles were processed further by the high-pressure slurry ablation collision chamber, homogeneity increased further at the same turnover rate. This may be due to particle breakage and slower settling rates of finer particles. The P80 (product 80% passing) for each of the pump discharge samples is noted on the graph of FIG. 24, in units of micron.

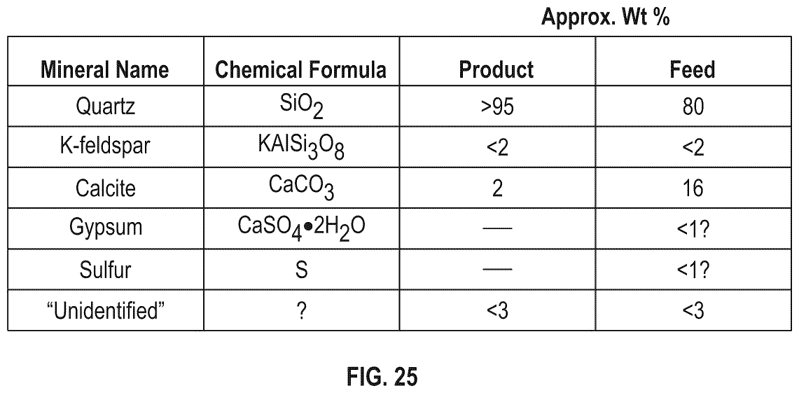

FIG. 25 shows the results from a filter sand processing pilot project. The feed to the high-pressure slurry ablation unit comprises quartz filter sand with calcite contamination. After processing in the continuous high-pressure slurry ablation unit, the product comprises >95% quartz content and a reduction of calcite from 16% to 2%. These results demonstrate the ability of high-pressure slurry ablation to clean contaminated filter sand particles and reject the contaminants into the fines size fraction.

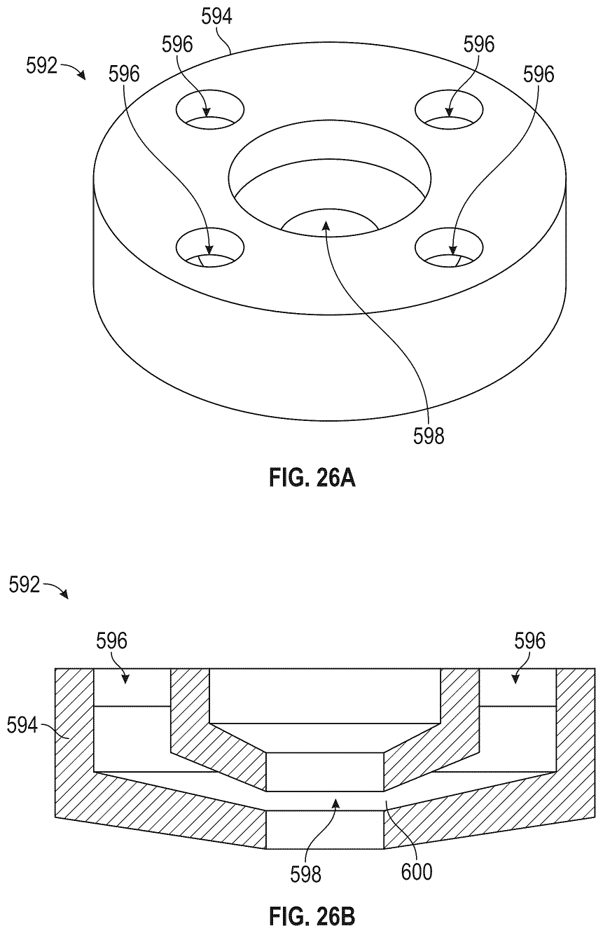

FIGS. 26A and 26B show isometric and section views, respectively, of collision chamber 592. Collision chamber 592 includes a single continuous nozzle that collides slurry towards a center point in the middle of a disk-shaped chamber. Collision chamber 592 includes chamber body 594, slurry inlets 596, collision region 598, and continuous nozzle 600. Pressurized slurry enters collision chamber 592 through four slurry inlets 596. The slurry enters and is distributed throughout the internal cavity of collision chamber 592. The pressurized slurry is forced through continuous nozzle 600. The shape of continuous nozzle 600 allows slurry to exit continuous nozzle 600 with velocity towards the center of continuous nozzle 600 in collision region 598. The velocity causes particle-to-particle collisions in the center of collision region 598. Slurry then falls through the opening below collision region 598.

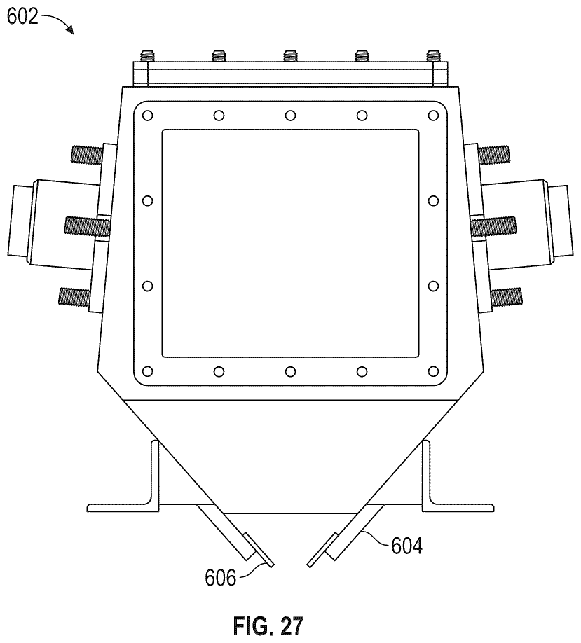

FIG. 27 shows load cell collision chamber 602. Load cells 604 are used to measure force applied. The force is applied at load disk 606. Load disk 606 is impacted by material that is exiting load cell collision chamber 602. When load cell collision chamber 602 and slurry flows from the nozzles are equal and balanced, the forces applied at the oppositely oriented load disks 606 are equal. When the flows are unbalanced the forces exerted on load disks 606 are different. The amount that the force differs on each load disk 606 may be determined through calibration. This calibration may differ due to load cell 604 orientation, nozzle outlet diameter, pump type and flow, load disk 606 shape and size, or load cell collision chamber 602 design. A calculation between the differential forces detected by load cells 604 placed on the exit of load cell collision chamber 602 may be used to detect system issues. This calculation may be performed by a programmable logic controller (“PLC”) communicating through controls conduit connected to the instruments of load cell 604. The PLC may be in communication with any component of the system. The PLC may control, regulate, modify, adjust, and/or monitor any component of the system. The PLC may comprise a software program. The software program may employ machine learning, artificial intelligence, a neural network, an algorithm, or a combination thereof.

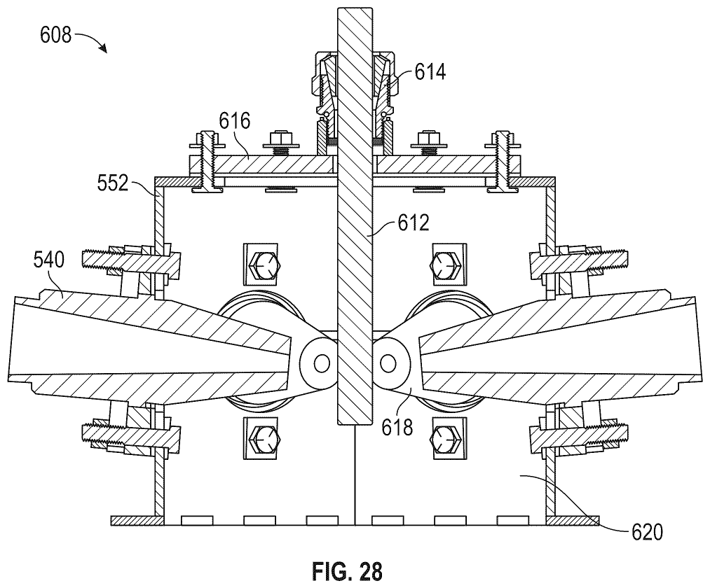

FIG. 28 shows system 608 that allows slurry jet to rod collisions. System 608 includes collision rod 612, sealing compression fitting 614, rod feeder adapter plate 616, nozzle 618, and chamber body 620. Slurry enters chamber body 620 through nozzles 618. Nozzles 618 are radially oriented around collision rod 612, which may be centrally located in chamber body 620. Collision rod 612 may be a type of metal, a metal alloy ceramic, or a combination thereof. Selection of the material of construction for collision rod 612 may be influenced by the material fracture mechanism. The material fracture mechanism of collision rod 612 has materials of construction to produce flakes. When these flakes fracture from collision rod 612 and return to the recirculating high-pressure slurry ablation pump, it will minimize or prevent damage. As particles from the slurry impact collision rod 612, the particles are fractured through selective liberation. As the particles are liberated, collision rod 612 may also wear down. As collision rod 612 wears, more collision rod 612 may be fed through sealing compression fitting 614 to allow a fresh surface for particles to impact. System 608 may be automated with the addition of an automatic feeder that slowly moves collision rod 612 down into chamber body 620 continuously as system 608 operates. A basket screen may be used to catch any large pieces of collision rod 612 that break off through the course of operation. The basket prevents these pieces from dropping into the suction of the pump that feeds nozzles 618, preventing damage, clogging, and wear.

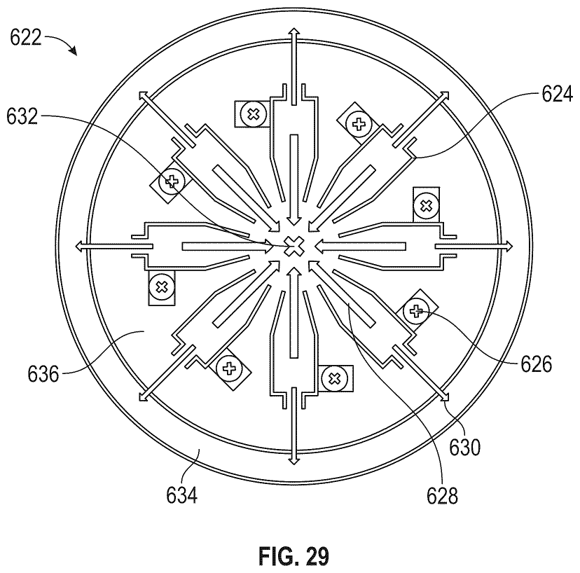

FIG. 29 shows a top-down view of system 622 for combined high-pressure slurry ablation collision and particle classification by size. System 622 includes hydrocyclone nozzles 624, hydrocyclone nozzle inlets 626, hydrocyclone nozzle underflow 628, hydrocyclone nozzle overflow 630, and collision point 632. In system 622, a plurality of hydrocyclone nozzles 624 may be arranged radially so that coarse particles exiting hydrocyclone nozzle underflow 628 may exit into collision point 632 allowing only coarse particles to collide while finer particles are classified out of hydrocyclone nozzles 624 and collected in overflow collection launder 634. After collision, coarse particles exit out of the plane of view, falling into collection tank 636 for further processing. Each hydrocyclone nozzle underflow 628 is oriented towards the center of the radial arrangement. Slurry is split to several different streams before entering hydrocyclone nozzle inlets 626. The hydrocyclone classifies, i.e., separates, the particles in the slurry. Fine particles are directed towards hydrocyclone nozzle overflow 630. Coarse particles are directed towards hydrocyclone nozzle underflow 628. The streams from hydrocyclone nozzle underflow 628 impact at collision point 632, causing particle-particle collisions of coarse particles and high-pressure slurry ablation selective liberation. The fine particles are removed from system 622, increasing efficiency of collisions due to larger particles carrying more kinetic energy and potentially increasing throughput of system 622 by removing mass that has been sufficiently processed and is fine enough to exit through hydrocyclone nozzle overflow 630.

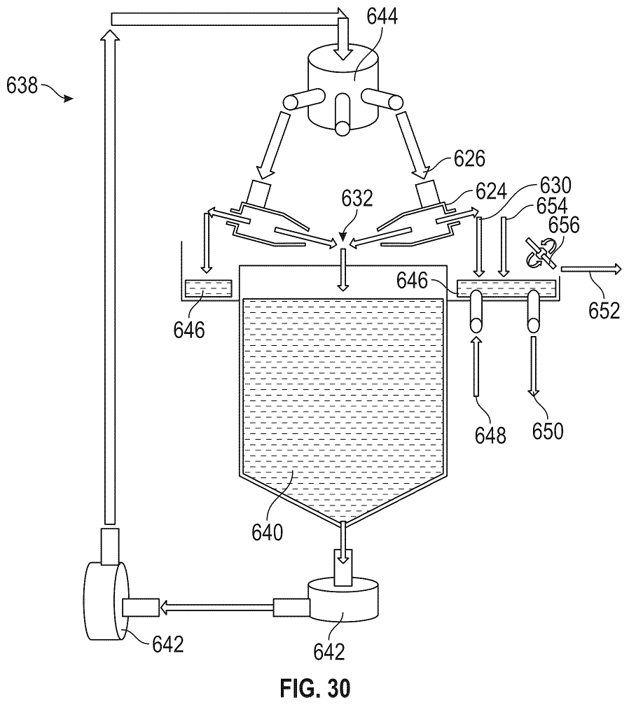

FIG. 30 shows system 638 for processing slurry that includes high-pressure slurry ablation collisions, size classification, and froth flotation. System 638 may comprise the combined high-pressure slurry ablation collision and particle classification from system 622, including hydrocyclone nozzle 624, hydrocyclone nozzle inlet 626, hydrocyclone nozzle underflow 628, hydrocyclone nozzle overflow 630, and collision point 632. System 638 may also comprise catch tank 640, staged pumps 642, distributor 644, fine material overflow 646, air inlet 648, tailings outlet 650, concentrate outflow 652, reagent addition 654, and froth paddle 656. Slurry from catch tank 640 is directed to staged pumps 642. The purpose of staged pumps 642 is to generate higher fluid pressure of the slurry. Higher fluid pressure may generate higher velocity particle-to-particle collisions. Slurry is directed from staged pumps 642 to distributor 644. Distributor 644 evenly supplies several hydrocyclone nozzles 624 with slurry. Hydrocyclone nozzles 624 classify particles by size, processing the coarse particles with high-pressure slurry ablation collisions and transferring the fine particles to fine material overflow 646. Froth flotation occurs in the fine material outflow using reagent addition 654, air, and froth paddle 656. Tailings material exits the fine material outflow through tailings outlet 650, and concentrate exits system 638 in concentrate outflow 652. Concentrate outflow 652 is pushed out by froth paddle 656. Reagents are introduced to the system by reagent addition 654, which allows froth flotation to occur.

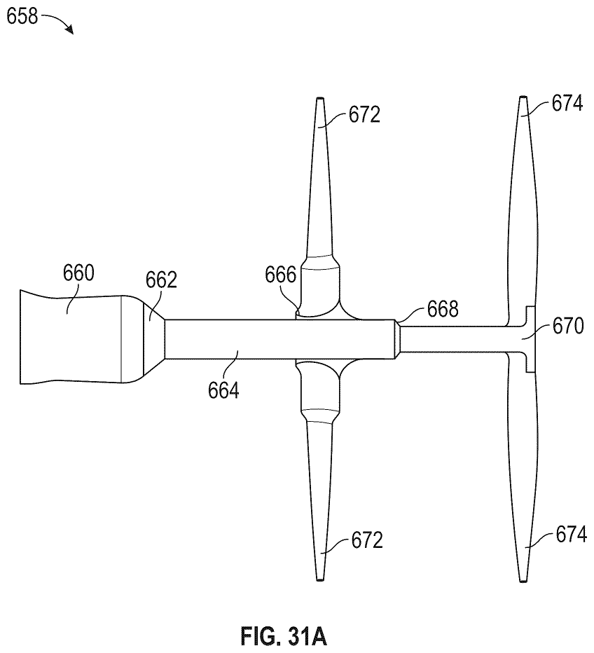

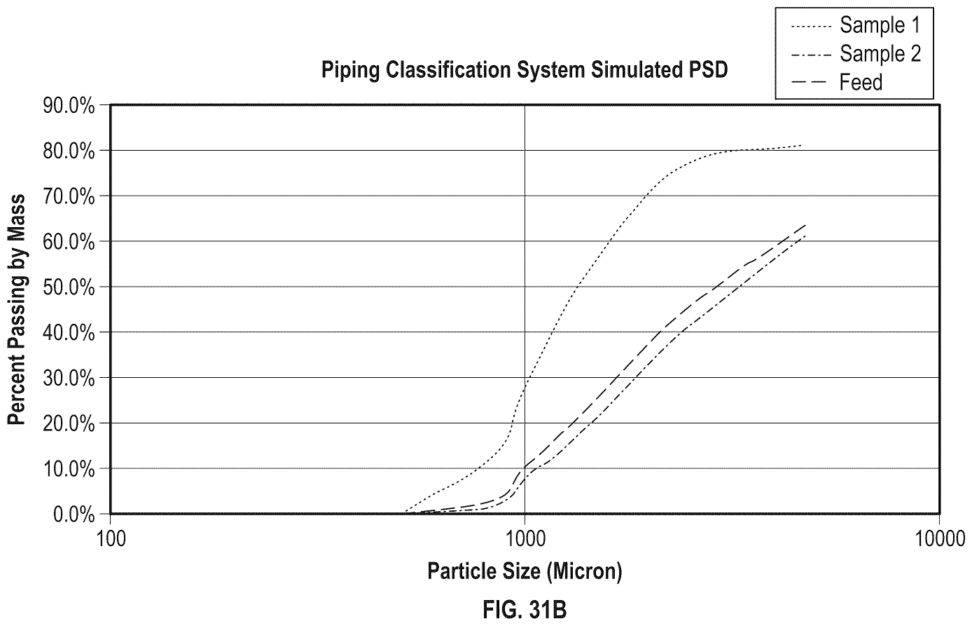

FIG. 31A shows system 658 for classification and processing of particles. System 658 includes particles 660, reducer 662, straight pipe section 664, cross pipe fitting 666, downstream reducer 668, and tee pipe fitting 670. System 658 uses pressurized slurry flow consisting of heterogeneous material. Particles 660 enter system 658 through reducer 662 and travel through straight pipe section 664. As particles enter cross pipe fitting 666, fine particles preferably exit system 658 through fine particle exits 672. Coarse particles preferably travel through downstream reducer 668. Coarse particles travel through tee pipe fitting 670 and are split to high-pressure slurry ablation collision nozzles through coarse particle exits 674, in which these particles are further processed through a high-pressure slurry ablation collision and experience selective liberation through preferential fracture. Fine particles that leave the system through fine particle exits 672 are transferred to a separate process, such as a hydrocyclone, for further classification.

FIG. 31B shows data from computational fluid dynamics (“CFD”) simulations. In one embodiment, the simulation may be conducted with particle sizes ranging from 500 microns to 6255 microns. The data may be a particle size distribution (“PSD”) in the form of percent of particles passing (or smaller than) a certain particle size by mass. System 658 may act as a classification system. Sample 1 represents the particles that travel through fine particles exit 672, and sample 2 represents the particles that travel through coarse particles exit 674. The simulated particle size distribution of the fine particles exit 672 is finer than the simulated particle size distribution of coarse particles exit 674.

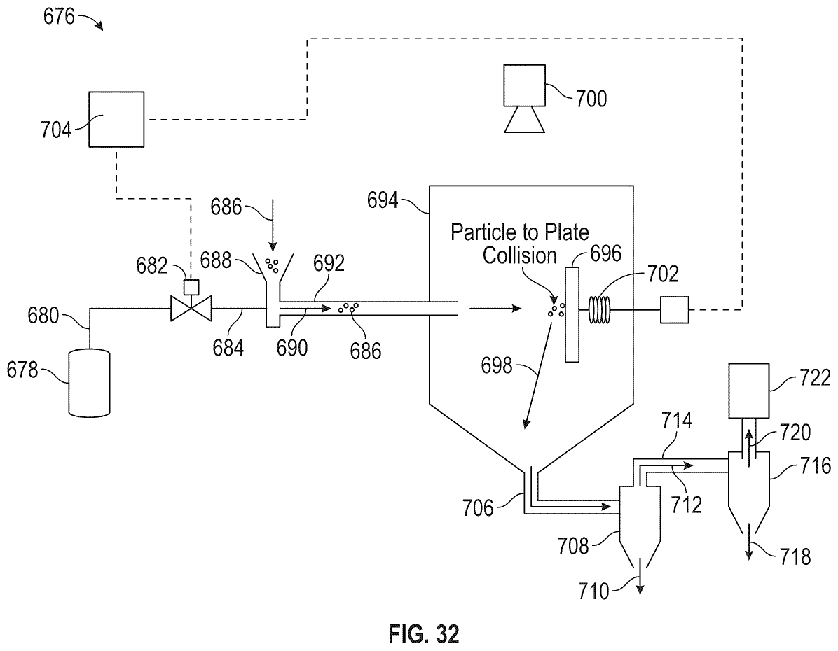

FIG. 32 shows system 676 for determination of particle fracture when propelled by an air jet into a collision box. System 676 comprises air tank 678 in fluid communication with solenoid valve 682 that is controlled by programmable logic controller 704. Air tank 678 is connected to solenoid valve 682 via conduit 680. Air tank 678 contains compressed air. Solenoid valve 682 is in fluid communication with feeder 688 and conduit 692. Feed material 686 is deposited into feeder 688. As feed material 686 funnels through feeder 688, compressed air 690 is passed through solenoid valve 682 and conduit 684 from air tank 678 and into feeder 688 and conduit 692. Compressed air 690 transports feed material 686 through conduit 692 and into collision box 694. Conduit 692 is affixed to collision box 694. Feed material 686 comprising of one or more heterogenous material particles is loaded into feeder 688 at the entrance of conduit 692 such that when programmable logic controller 704 commands solenoid valve 682 to open, compressed air 690 released from air tank 678 propels feed material 686 through conduit 692 and collide them with collision plate 696 installed inside collision box 694, generating collided material 698.

Collision box 694 may comprise of, but is not limited to, steel, acrylic, or a combination thereof to allow observation of the particle collisions within collision box 694. Collision box 694 may comprise acrylic windows to allow for high-speed camera 700 to be positioned outside of collision box 694. Optionally, high-speed camera 700 may be positioned inside of collision box 694. High-speed camera 700 takes images or videos of particles of feed material 686 travelling through collision box 694 to determine the particle velocities prior to the particle-to-plate collisions at collision plate 696. High-speed camera 700 may also be used to measure the deflection of collision plate 696 when collision plate 696 is affixed to a spring that is further affixed to collision box 694. Image analysis of the deflection of collision plate 696 or the compression of the spring attachment may be used to estimate the force of the collisions of the heterogeneous material with collision plate 696. Collision plate 696 is attached to load cell 702 or other instrument capable of transmitting the force registered by the particles colliding with collision plate 696.

System 676 may operate for batch testing of an individual particle or particles. Collision box 694 comprises collision box exit 706. Collision box exit 706 may be opened to discharge collided material 698 to a collection tank for storage and analysis of the daughter particles produced by the particle-to-plate collisions.

System 676 may run while continuously loading feed material 686 into feeder 688. Collision box 694 is in fluid communication with one or more cyclones to separate material into various daughter particle size fractions. Driven by the pressure of compressed air 690 entering collision box 694 through conduit 692, collided material 698 exits collision box 694 and enters first cyclone 708 where coarse particles 710 are separated from fine particles 712. Fine particles 712 convey out of first cyclone 708, through conduit 714, and into second cyclone 716. Second cyclone 716 separates fine particles 712 into finer particles 718 and ultrafine particles 720. Coarse particles 710 and finer particles 718 are collected from the outlets of first cyclone 708 and second cyclone 716, respectively. Ultrafine particles 720 generated by the particle-to-plate collisions are collected in air filter 722, which is connected to second cyclone 716.

Programmable logic controller 704 may be programmed to control the amount of air released from air tank 678 to result in various ranges of particle velocities propelled through conduit 692 into collision box 694.

Collision plate 696 may be removed from system 676 and replaced with a second conduit for propelling particles into collision box 694 to more accurately approximate the particle-to-particle collisions observed in a high-pressure slurry ablation system.

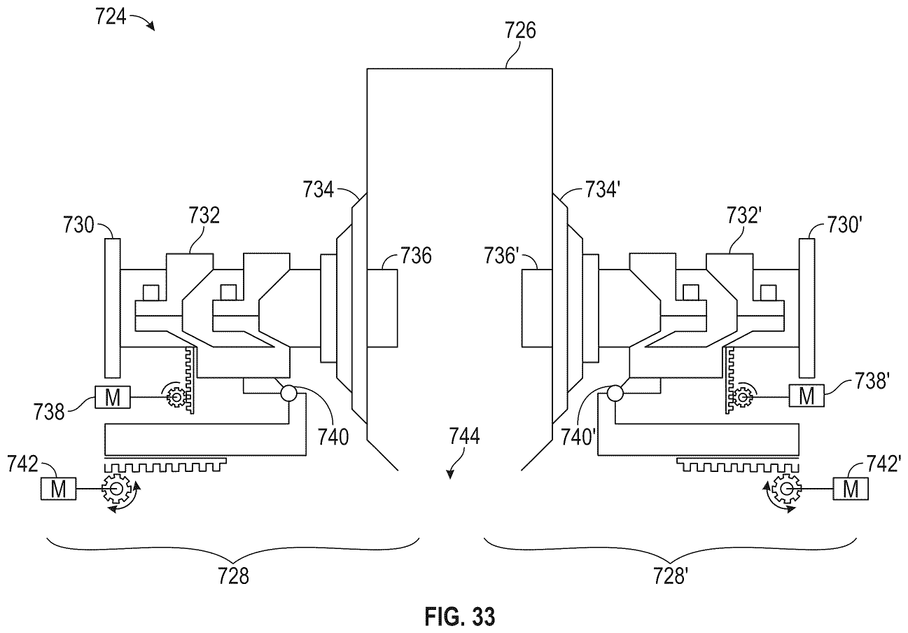

FIG. 33 shows collision chamber 724. Collision chamber 724 is an adjustable collision chamber which may be used in a high-pressure slurry ablation system where the nozzle process connections is in fluid communication with upstream process hoses comprising heterogenous material in slurry form. Collision chamber 724 comprises collision box 726 and nozzle assemblies 728 and 728′. Nozzle assemblies 728 and 728′ comprise nozzle process connections 730 and 730′, nozzle vices 732 and 732′, corrugated rubbers 734 and 734′, nozzles 736 and 736′, nozzle angle adjustment systems 738 and 738′, hinges 740 and 740′, and nozzle distance adjustment systems 742 and 742′. Collision box 726 comprises collision box exit 744. Nozzle angle adjustment systems 738 and 738′ and nozzle distance adjustment system 742 and 742′ comprises a series of motors, gears, and teeth. Collision box exit 744 may be placed over the top of a process tank to allow collided material discharge from the system into a high-pressure slurry ablation catch tank. Collision chamber 724 may comprise one or more nozzle assemblies 728 and 728′ where nozzles 736 and 736′ comprise jet streams of heterogeneous material that are directed towards a single region for collision within collision box 726.

Collision chamber 724 comprises collision box 726 with entrances on the sides for nozzles 736 and 736′ of nozzle assemblies 728 and 728′ to be attached to collision box 726 by corrugated rubbers 734 and 734′ and allowing flexibility in the motion of nozzle assemblies 728 and 728′ into and out of collision box 726 as well as rotation in the vertical plane to adjust the angle of nozzles 736 and 736′ jet into collision box 726. Nozzles 736 and 736′ are held in place by nozzle vice 732 and 732′ which may be attached to nozzle angle adjustment systems 738 and 738′ with a gear system on one end and hinges 740 and 740′ on the opposite end. Hinges 740 and 740′ are attached to nozzle distance adjustment systems 742 and 742′ and a gear system. When an electric motor in nozzle angle adjustment systems 738 and 738′ and nozzle distance adjustment systems 742 and 742′ are operated, nozzles 736 and 736′ are moved into and out of collision box 726, adjusting the distance between the outlets of nozzles 736 and 736′.

Collision chamber 724 may be adjusted in real time using a central control system in communication with nozzle angle adjustment systems 738 and 738′ and gear systems as well as nozzle distance adjustment systems 742 and 742′ and gear systems. Nozzle angles may be measured by inclinometers affixed to nozzle vices 732 and 732′. Adjustment of collision chamber 724 may be done to achieve better collision region balance between the two jet streams entering collision box 726. This can be done visually if collision box 726 is comprised of acrylic or some other transparent material sturdy enough to withstand collision forces or it can be done by including load cells underneath collision box exit 744 to determine if flow of ablated heterogeneous material exiting the collision region is more concentrated on one side of collision box 726. The central control system may be in communication with any component of the system. The central control system may control, regulate, modify, adjust, and/or monitor any component of the system. The central control system may comprise a software program. The software program may employ machine learning, artificial intelligence, a neural network, an algorithm, or a combination thereof.

A multi-hole and/or shaped-hole nozzle may increase the efficiency of a high-pressure slurry ablation process. A multi-hole and/or shaped-hole nozzle may comprise a plurality of nozzle orifices that are not circular and/or may comprise a plurality nozzle orifices on a single nozzle. Nozzle orifice shapes may include, but are not limited to, circular, plus-shaped, triangular, slotted, elliptical, or a combination thereof. The multi-hole and/or shaped-hole nozzle may comprise an orifice of any shape and may include any number of nozzle orifices in any specific orientation and pattern.

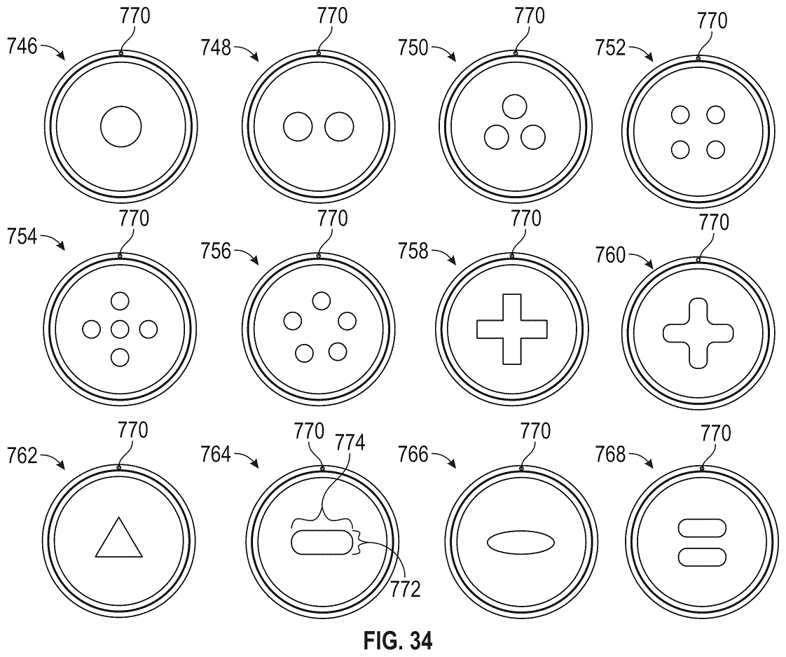

FIG. 34 shows some embodiments of nozzles with multiple holes and/or varying hole shapes. FIG. 34 shows examples of nozzle orifice designs and the possible angular orientations relative to the top of the chamber when inserted. The nozzle orifices may include, but are not limited to, single orifice nozzle 746, double orifice nozzle 748, triple orifice nozzle 750, quadruple orifice nozzle 752, quintuple cross orifice nozzle 754, quintuple pentagonal orifice nozzle 756, plus orifice nozzle 758, rounded plus orifice nozzle 760, triangular orifice nozzle 762, slotted orifice nozzle 764, elliptical orifice nozzle 766, and double slot orifice nozzle 768. Single orifice nozzle 746 may direct fluid through only a single nozzle orifice. As nozzle throughput increases and total nozzle pressure is maintained, nozzle orifice patterns and sizes may be varied to overcome particle velocity losses associated with single orifice nozzle 746. Nozzle orifice shape, size, and quantity may be varied to maintain a slurry flowrate through the nozzle at the same pressure an equivalent nozzle orifice exit area may be achieved by changing the number of nozzle orifices on a single nozzle, such as double orifice nozzle 748, triple orifice nozzle 750, and the rest of the nozzles with multiple orifices (i.e., as shown in FIG. 34, this may include, but is not limited to, quadruple orifice nozzle 752, quintuple cross orifice nozzle 754, quintuple pentagonal orifice nozzle 756, and double slot orifice nozzle 768).

The total orifice cross-sectional area of each nozzle orifice orientation may be made equivalent to each of the other nozzle orifices. The multi-orifice nozzles may be used to achieve the same cross-sectional area as single orifice nozzle 746 while maintaining smaller individual orifice diameters. This may generate smaller diameter fluid streams while maintaining a larger total cross-sectional area to allow for a higher fluid flow rate in a single collision chamber or nozzle set. A nozzle may comprise of one to five or more uniform nozzle orifices. Alternatively, the nozzle orifices may be nonuniform, in which each orifice is not the same shape and/or size as the other orifices on the same nozzle.

FIG. 34 also shows nozzles with irregularly shaped orifices, including but not limited to, plus orifice nozzle 758, rounded plus orifice nozzle 760, and triangular orifice nozzle 762. These irregularly shaped nozzles form a stream with a larger surface area than a circular orifice with the same cross-sectional area. The large surface area may allow fluid to more effectively evacuate the collision region and reduce the particle velocity loss in the collision region. Nozzle orifice shapes may be optimized for specific purposes when used in specific applications, particle sizes, or materials.

FIG. 34 also shows examples of oblong orifice nozzles, including but not limited to, slotted orifice nozzle 764, elliptical orifice nozzle 766, and double slot orifice nozzle 768. Slotted orifice nozzle 764 may maintain the same cross-sectional area as single orifice nozzle 746 due to a shorter stream height 772 and longer stream width 774. Alternatively, slotted orifice nozzle 764 may be operated in a configuration in which stream height 772 is longer than stream width 774. Slotted orifice nozzle 764, elliptical orifice nozzle 766, and double slot orifice nozzle 768 allow for a smaller effective diameter, causing the collision region to behave similarly to a small diameter single orifice nozzle 746 but have the benefits of a larger outlet area.

FIG. 34 further shows mounting plate alignment hole 770 on each of the nozzles. Mounting plate alignment hole 770 ensures that the orientation of the asymmetric nozzle faces is correct when the nozzle mounting plate is installed. The nozzle mounting plate may include a second mounting plate alignment hole 770. During assembly, a precision machined dowel pin may be inserted through the two mounting plate alignment holes 770 to maintain the angular alignment of the nozzle mounting plate with respect to the orientation of the nozzle orifice orientation and nozzle mounting plate bolt pattern.

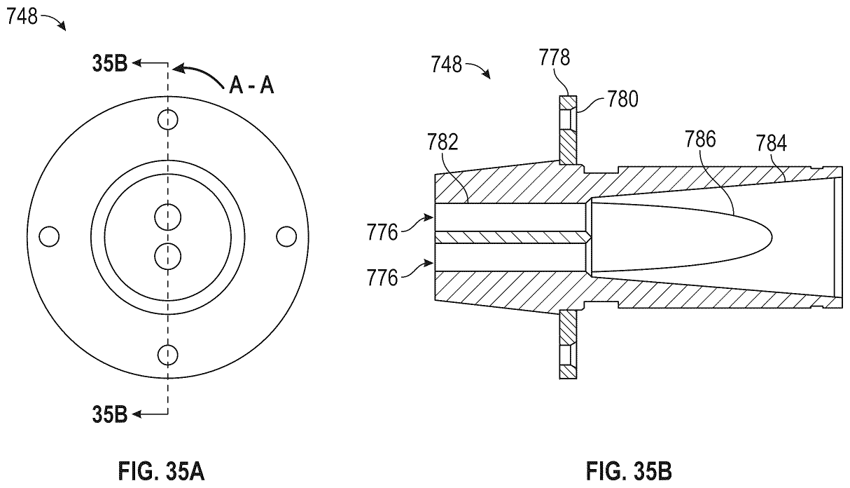

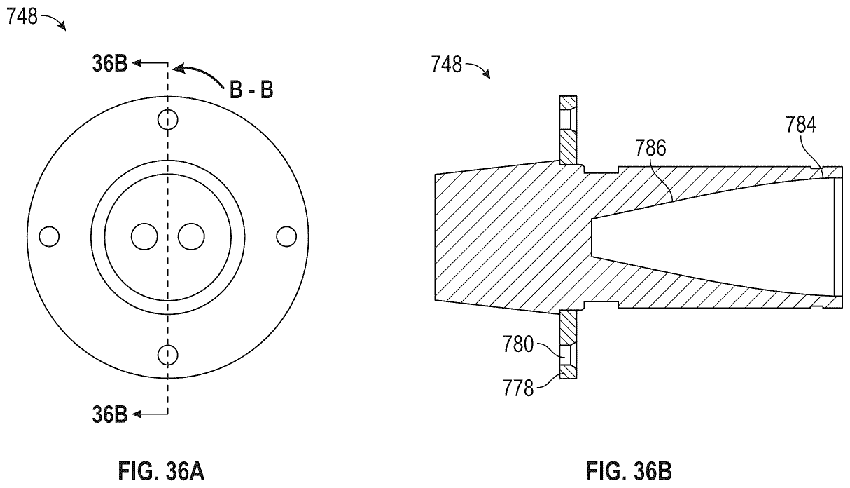

FIG. 35A shows a front view of double orifice nozzle 748 with section line A-A. FIG. 35B shows a section view along section line A-A of double orifice nozzle 748. FIG. 36A shows another front view of double orifice nozzle 748 with section line B-B. FIG. 36B shows a section view along section line B-B of double orifice nozzle 748. The two frontal views of double orifice nozzle 748 (FIG. 35A and FIG. 36A) are oriented 90 degrees from each other to demonstrate the internals of double orifice nozzle 748 from both angles. To taper double orifice nozzle 748, primary taper 784 and secondary taper 786 may be used. Primary taper 784 is about constant across the entire circumference of double orifice nozzle 748. Secondary taper 786 may be present on the walls adjacent to nozzle orifices 776. Since the transition between a single straight taper and two streams may require a flat section on the nozzle internal geometry, secondary taper 786 may be used to ensure that the change in cross-sectional area throughout the axial length of double orifice nozzle 748 remains gradual. Rapid changes in the cross-sectional area can cause issues related to wear, cavitation, or clogging.

FIG. 35B and FIG. 36B show mounting hole chamfer 780 on nozzle mounting plate 778. Mounting hole chamfer 780 allows nozzle mounting plate 778 to be fastened to a collision chamber with the use of conical nut 782. The conical nut may have same chamfer angle as mounting hole chamfer 780, allowing nozzle mounting plate 778 to center itself on a collision chamber mounting stud. Having nozzle mounting plate 778 centered on a collision chamber mounting stud may allow consistent mounting location on the collision chamber during nozzle installation.

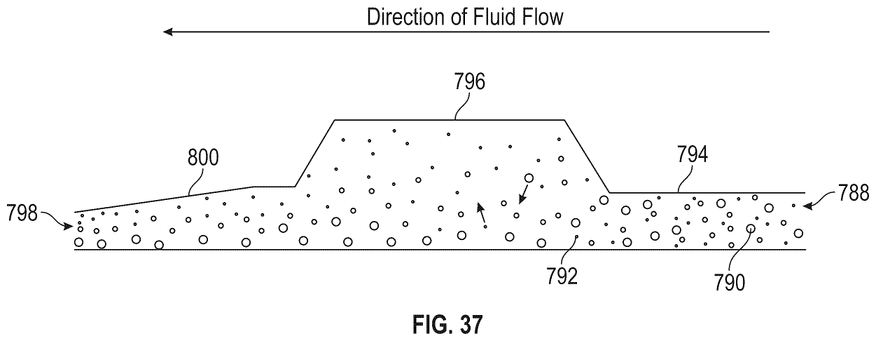

FIG. 37 shows the particle dispersion upstream of a nozzle that forces particle segregation. Mixed flow 788 may be a slurry comprising particles of varying sizes and water. Mixed flow 788 may comprise of coarse particles 790 and fine particles 792 that are randomly distributed throughout pipe 794. As mixed flow 788 enters settling chamber 796, slurry velocity decreases. As a result, particles may drop out of suspension due to gravity. Coarse particles 790 settle more rapidly than fine particles 792, causing sorting of particles within the cross section of the flow. While the coarsest particles concentrate towards the bottom of pipe 794, progressively finer particles concentrate above the coarsest particles. The finest particles may stay in suspension due to low settling rates. The flow may become segregated flow 798 in settling chamber 796. Downstream of settling chamber 796 is a nozzle with eccentric taper 800. Eccentric taper 800 may be gradual enough to discourage fluid mixing and turbulence, which homogenizes the particles in the flow and causes a mixed flow.

Segregated flow 798 may collide with another segregated flow 798 in a mirrored orientation with respect to the nozzle outlet. This may cause high-pressure slurry ablation particle collisions between the particles in each segregated flow 798. Segregated flow 798 increases the probability of particle collisions between similarly sized particles, which decreases the probability of non-significant collisions between particles of mismatched size. Non-significant collisions do not contribute to particle liberation or breakage. Additionally, the nozzle can be non-circular to continue to encourage maintenance of the particle segregation as the particles exit the nozzle.

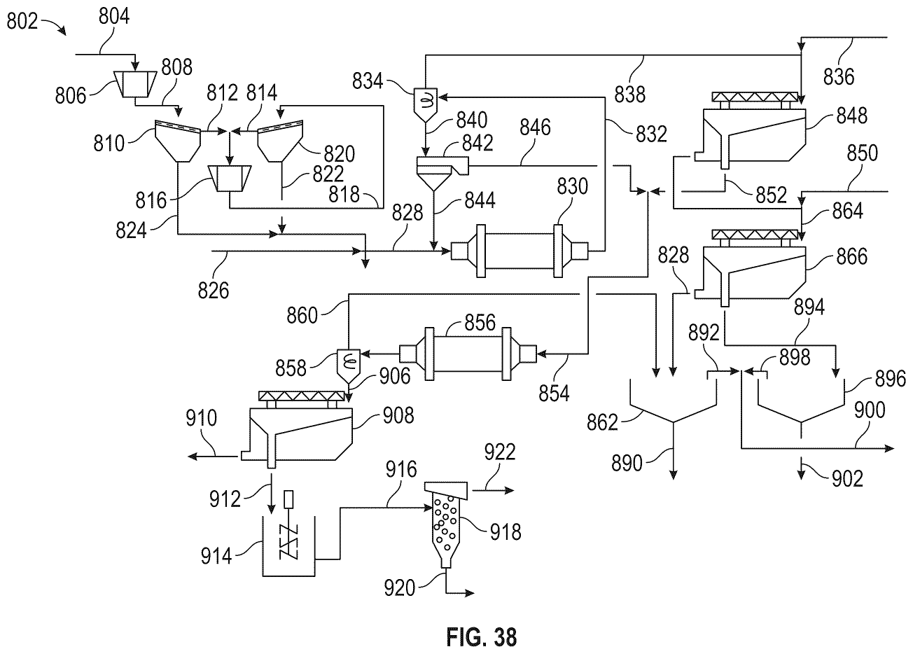

FIG. 38 shows mineral processing system 802. Primary ore feed 804 may be collected and hauled from an underground mine and/or blasted from a surface mining deposit. Primary ore feed 804 is loaded into primary crusher 806. Primary crushed ore 808 is discharged from primary crusher 806 after the size of the ore has been reduced. Primary crushed ore 808 is disposed onto primary screen 810 to separate ore into a primary screen oversize stream 812 and primary screen undersize stream 824. Primary screen 810 may have a separation point of about 10 millimeters (“mm”) to about 1 mm depending on the overall dry throughput.

To ensure primary grinding feed stream 828 has been sufficiently sized for downstream processing, a loop of multiple crushers and screeners may be present in the flowsheet design. Secondary crusher 816 receives feed streams of both the primary screen oversize stream 812 and secondary screen oversize stream 814. Secondary crusher discharge stream 818 is recycled over the top of secondary screen 820 in a closed loop while primary screen undersize stream 824 and secondary screen undersize stream 822 combine to form primary grinding feed stream 828. The initial ore preparation upstream of primary grinding is a dry process and process water 826 is added to primary grinding feed stream 828 prior to entering primary grinding mill 830. Optionally, primary grinding mill 830 may be a tumbling mill, an autogenous grinding mill, semi-autogenous grinding mill, a ball mill, a rod mill, or a combination thereof depending on the liberation and size reduction requirements of the downstream processing steps.

The primary grinding circuit is a closed circuit application, wherein primary grinding mill discharge stream 832 is fed to primary hydrocyclone 834 to segregate smaller particles from larger particles. The closed circuit is used to allow primary cyclone overflow stream 838 which feeds primary flotation cell 848 to contain adequately small particle sizes for primary flotation cell 848 to effectively separate liberated target minerals from the liberated gangue minerals. Primary flotation reagents 836 are added prior to primary cyclone overflow stream 838 entering primary flotation cell 848. This may be done in an agitated conditioning tank to ensure adequate mixing of primary flotation reagents 836 and primary cyclone overflow stream 838 prior to flotation.

Primary cyclone underflow stream 840 enters primary flash flotation cell 842. Primary flash flotation cell 842 separates target minerals from gangue that have been liberated at a coarser particle size by the primary grinding mill 830 a target mineral from a gangue mineral at a coarser particle size than specified as the cut point for primary hydrocyclone 834. Primary flash flotation cell concentrate 846 from primary flash flotation cell 842 is combined with the primary flotation concentrate 852 from primary flotation cell 848 to form secondary grinding mill feed 854 while primary flash cell tails 844 from primary flash flotation cell are combined with primary grinding feed stream 828 entering into primary grinding mill 830 to be liberated further and/or further reduced in size. Optionally, when a target mineral cannot be liberated at coarser particle sizes, primary flash flotation cell 842 may be removed from mineral processing system 802 or bypassed and primary cyclone underflow stream 840 may be combined with primary grinding feed stream 828.

Primary flotation tails stream 864 enters secondary flotation cell 866 where a stream of secondary flotation reagents 850 comprising a different chemical composition than primary flotation reagents 836 is added. Secondary flotation cell 866 separates primary flotation tails stream 864 into secondary flotation tails 888 and secondary flotation concentrate 894. Secondary flotation cell 866 recovers separate minerals that are separated from the gangue in the primary flotation cell 848 but must be separated from each other and for further downstream processing steps.

Secondary flotation tails 888 and secondary flotation concentrate 894 enter thickener 862 and thickener 896, respectively, as downstream solid-liquid handling steps. Thickener 862 and thickener 896 separate out process water from secondary flotation tails 888 and secondary flotation concentrate 894, respectively. Thickener overflow stream 892 from thickener 862 and thickener overflow stream 898 from thickener 896 are combined into recycle process water stream 900 for mill operations. The thickener underflow 890 from thickener 862 and thickener underflow 902 exit to downstream processing steps.

Downstream processing steps may comprise pumping the thickener underflow 890 and/or 902 to a chemical processing plant. Thickener underflow 890 and/or 902 exiting thickener 862 or thickener 896 may be fed to a filter press, centrifuge, or other dewatering and drying system to be transported as a final product. Optionally, thickener underflow 890 and/or 902 may be diverted to separate tailings impoundments for long term storage.

Secondary grinding mill feed 854 is fed to secondary grinding mill 856. Secondary grinding mill 856 may be a tumbling mill, autogenous, semi-autogenous, ball mill, rod mill, or a combination thereof. Where less size reduction of secondary grinding mill feed 854 is required, secondary grinding mill may be replaced by an attrition cell (not shown) to scrub surfaces of materials and liberate remaining gangue prior to downstream processing steps. Secondary grinding mill 856 discharge is fed to secondary hydrocyclone 858. Secondary hydrocyclone 858 separates the discharge stream by size into secondary cyclone overflow 860 and the secondary cyclone underflow 906. Secondary grinding mill 856 is used in an open circuit (i.e., a desliming process) with secondary cyclone overflow 860 entering thickener 862. Secondary cyclone underflow 906 enters tertiary flotation cell 908 for further recovery of the target mineral. This open circuit or desliming configuration of secondary grinding mill 856 and secondary hydrocyclone 858 is employed where secondary grinding mill feed 854 does not require significant size reduction such as with phosphate flotation applications.

In milling processes where further size reduction is required for performance of tertiary flotation cell 908, secondary grinding mill 856 and secondary hydrocyclone 858 may be configured in a closed circuit similar to primary grinding mill 830 and primary hydrocyclone 834, where secondary cyclone underflow 906 re-enters secondary grinding mill 856 and secondary cyclone overflow 860 enters tertiary flotation cell 908. The closed-circuit configuration may be used in hard copper ore processing where copper minerals are present as fine interstitials within particles and a significant size reduction down to 75 microns or finer is required.

The tertiary flotation concentrate 912 exiting the tertiary flotation cell 908 is further processed in attrition cell 914. A ceramic or steel grinding media (not shown) may be introduced into attrition cell 914 to increase mineral liberation of the particles within attrition cell 914. The grinding media may be separated by size, magnetic, or other means from attrition cell discharge 916. Attrition cell discharge 916 is fed into flotation column 918. Flotation column 918 yields column flotation concentrate 922 or column flotation tails 920. Optionally, tertiary flotation tails 910 exit tertiary flotation cells 908 and enter further downstream processing, thickener 862, thickener 896, and/or a separate thickener and dewatering process depending on the mineral processing application.

A high-pressure slurry ablation system and/or process may be integrated into mineral processing system 802 to process (i.e., ablate) primary screen undersize stream 824, secondary screen undersize stream 822, secondary crusher discharge stream 818, and/or combined primary grinding feed stream 828. The high-pressure slurry ablation system and/or process may receive heterogeneous material either as a slip stream, taking a fraction of the mass less than 100 percent, or may receive the entire stream to add benefit to the downstream processing steps. The high-pressure slurry ablation system and/or process may be integrated in a closed or open circuit when processing these streams.

The high-pressure slurry ablation system and/or process may be integrated into mineral processing system 802 by replacing either primary grinding mill 830, secondary grinding mill 856, attrition cell 914, or any other grinding and liberation step prior to flotation, desliming, or other separation such as magnetic separation with a high-pressure slurry ablation system and/or process. Depending on the number of tumbling mills or attrition cells in the flowsheet, the high-pressure slurry ablation system and/or process may be integrated into the flowsheet to replace multiple or all liberation steps.

The high-pressure slurry ablation system and/or process may be integrated into mineral processing system 802 by serving as a conditioning mixing tank for the mixing of primary cyclone overflow stream 838 and/or primary flotation reagents 836 prior to feeding the material into primary flotation cell 848. The high-pressure slurry ablation system and/or process may also be integrated to serve as a conditioning mixing tank for the mixing of primary flotation tails stream 864 and/or secondary flotation reagents 850. The high-pressure slurry ablation system and/or process may also be integrated to serve as a conditioning mixing tank for the mixing of reagents entering tertiary flotation cell 908 and/or flotation column 918. At any of these integration points, the high-pressure slurry ablation system and/or process may serve as a unit operation providing both liberation and mixing of the reagents with the heterogenous material. It may also serve as a unit operation providing liberation, mixing of the reagents with the heterogenous material, and recovery of flotation concentrate from the high-pressure slurry ablation system and/or process. When serving as a system for liberation, mixing, and flotation concentrate recovery, integration of a high-pressure slurry ablation system and/or process may replace multiple unit operations at the same time. For example, when integrated in into mineral processing system 802 process tertiary flotation concentrate 912, the high-pressure slurry ablation unit may replace both attrition cell 914 and flotation column 918 to produce an equivalent of column flotation concentrate 922 and column flotation tails 920.

The high-pressure slurry ablation system and/or process may be integrated into mineral processing system 802 by serving solely as a size reduction unit operation preparing the final product for downstream processing by processing a portion or the entire stream in closed or open circuit configuration for secondary flotation tails 888, secondary flotation concentrate 894, thickener underflow 890, thickener underflow 902, column flotation concentrate 922, column flotation tails 920, or tertiary flotation tails 910 depending on the downstream process. For example, in some phosphate mineral processing applications, beneficiation processes are located miles away from phosphoric acid production plants. Due to these distances, slurries are generally transported by high pressure pumps through pipelines which can wear or more easily clog if particle size requirements, particularly large particle sizes are present in the slurry. A high-pressure slurry ablation system and/or process may be integrated as a product preparation step to reduce the percentage of coarse particles in the product pipeline due to its utilization of slurry jets wherein the coarser particles tend to follow the center region of the collision jet and fracture while the finer particles spread with the water transporting the particles reducing their fracture rate.

The high-pressure slurry ablation system and/or process may be integrated into mineral processing system 802 in the following areas either in an open circuit or closed circuit configuration, processing either a slipstream or the full stream in preparation for a downstream processing step to improve ablation and/or liberation: primary cyclone overflow stream 838, primary cyclone underflow stream 840, primary flash cell tails 844, primary flash flotation cell concentrate 846, primary flotation concentrate 852, primary flotation tails stream 864, secondary flotation tails 888, secondary flotation concentrate 894, secondary grinding mill feed 854, secondary cyclone overflow 860, secondary cyclone underflow 906, tertiary flotation tails 910, tertiary flotation concentrate 912, attrition cell discharge 916, column flotation concentrate 922, column flotation tails 920, thickener underflow 890, thickener underflow 902, or a combination thereof. An additional separation step may be included directly after the high-pressure slurry ablation system and/or process when processing these streams. The separation step may be size separation through a screen or hydrocyclone, magnetic separation, or flotation separation. Additionally, where tertiary flotation tails 910, column flotation tails 920, thickener underflow 890, or thickener underflow 902, or a combination thereof are stored in tailings impoundments or otherwise segregated and stored, the high-pressure slurry ablation system and/or process may be used as a reprocessing step for these tailings streams. When used as a reprocessing step, high-pressure slurry ablation system and/or process may either process the material and return it to a separation step depicted in mineral processing system 802 or an additional separation step may be included after high-pressure slurry ablation to create a desired product.

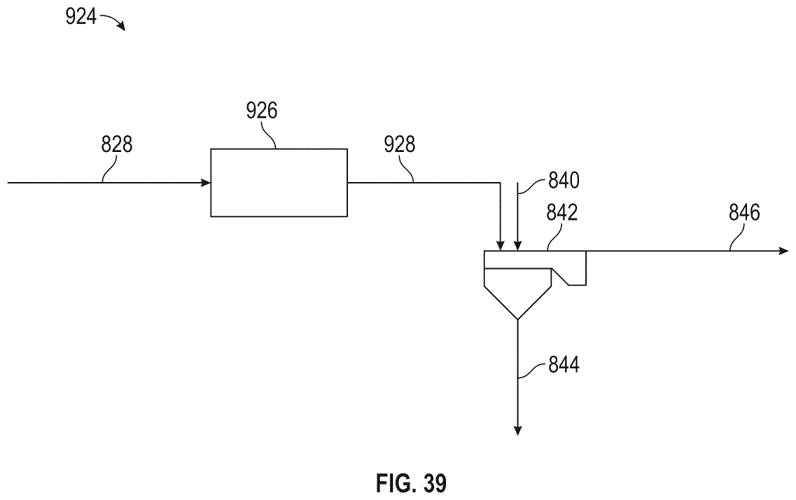

FIG. 39 shows integration of high-pressure slurry ablation system 926 into grinding feed system 924. High-pressure slurry ablation system 926 may process the primary grinding feed 828 and discharge ablated heterogenous material 928 into primary flash flotation cell 842, where coarser liberation particle sized produced by high-pressure slurry ablation system 926 allows for target minerals to be recovered into primary flash flotation cell concentrate 846 without overgrinding the mineral of the heterogeneous material and creating the potential for the mineral to be lost in primary flotation tails stream 864. Primary flash cell tails 844 flow into the primary grinding mill 830 (see FIG. 38) as depicted or be processed by a separate high-pressure slurry ablation system configured for size reduction. Processing of primary grinding feed 828 with high-pressure slurry ablation system 926 then discharging into primary flash flotation cell 842 may occur in a graphite processing circuit, where larger graphite flakes are worth more and the desire to prevent overgrinding of the graphite flakes with traditional tumbling mill technology is likely. Primary cyclone underflow stream 840 enters primary flash flotation cell 842 where primary cyclone underflow stream 840 is combined with ablated heterogenous material 928.

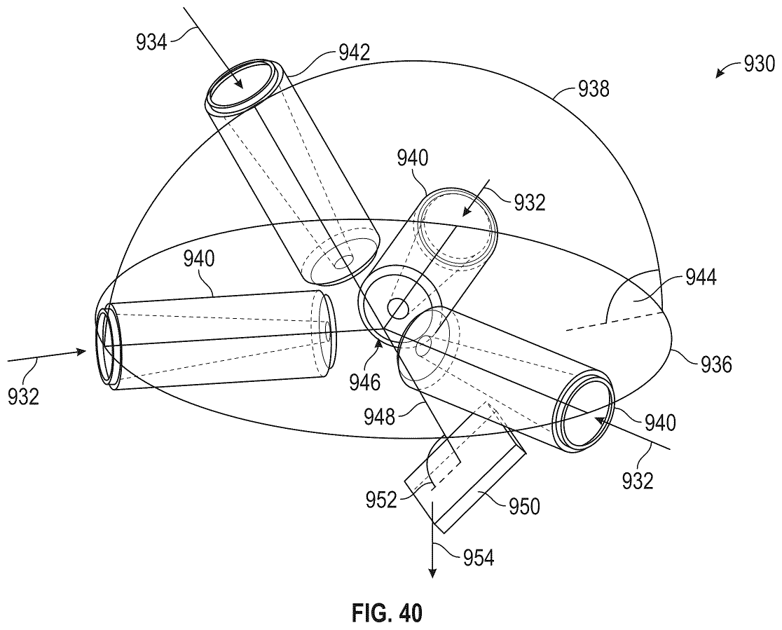

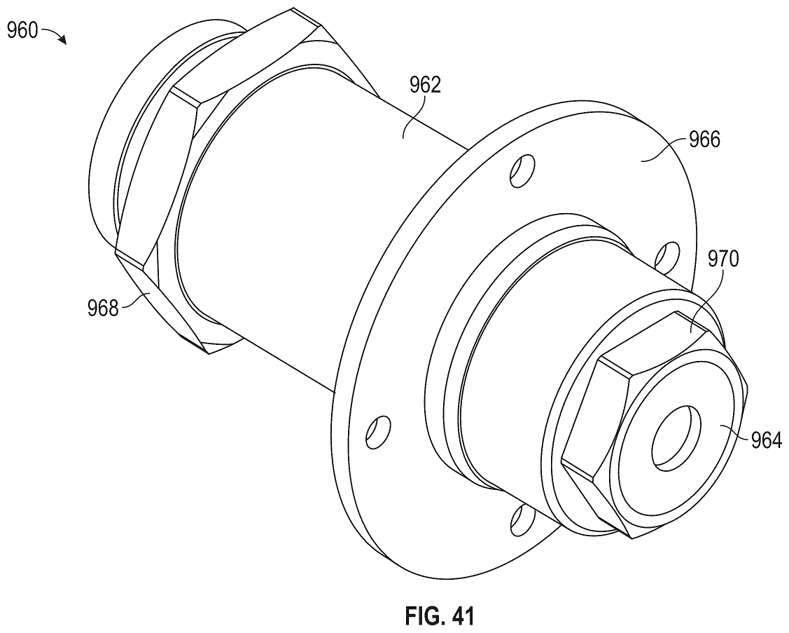

FIG. 40 illustrates collision regime 930. Collision regime 930 may comprise one or more nozzles where material streams may enter. Namely, collision regime as illustrated in FIG. 40 comprises first plane nozzles 940 and second plane nozzle 942. First plane nozzles 940 lie on first plane 936. Second plane nozzle 942 lies on second plane 938. The angle generated between first plane 936 and second plane 938 is given by inter-plane angle 944. First plane streams 932 may enter collision regime 930 through first plane nozzles 940. Second plane stream 934 may enter collision regime 930 through second plane nozzle 942. First plane streams 932 may collide with second plane stream 934 at collision point 946. Orientation of the nozzles can be from about 0 degrees to about 360 degrees.

The collision between first plane streams 932 and second plane stream 934 at collision point 946 may generate jet-collided slurry 948. Jet-collided slurry 948 may be directed onto collision plate 950. The angle between jet-collided slurry 948 and collision plate 950 is given by plate collision angle 952. Plate-collided slurry 954 may be generated after jet-collided slurry 948 collides with collision plate 950.

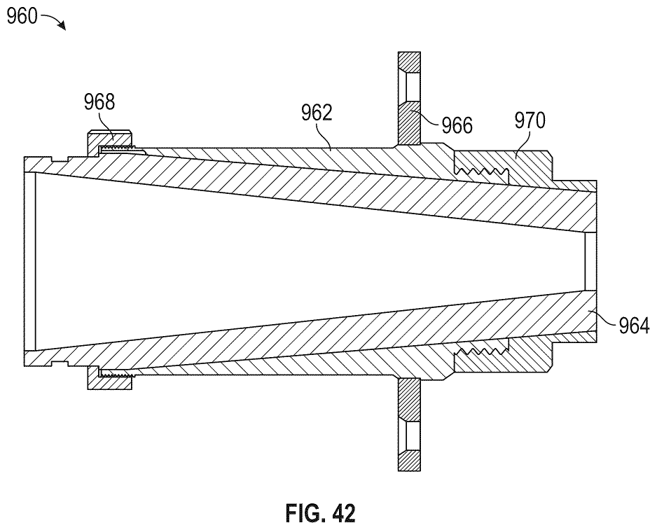

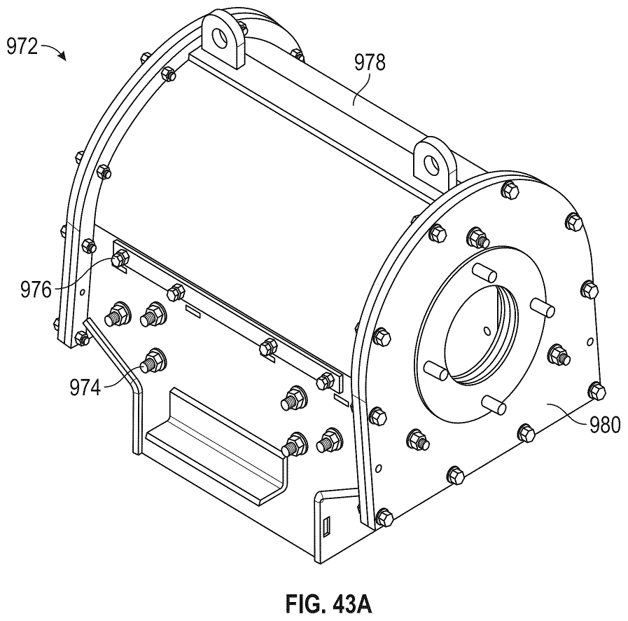

FIGS. 41 and 42 show multiple views of removable insert nozzle 960. The assembly of removable insert nozzle 960 may comprise outer shell 962 and nozzle insert 964 as two separate parts. Outer shell 962 may be a permanent fixture that retains nozzle insert 964. Nozzle insert 964 may comprise a fluid pipe fitting (not shown) on the nozzle inlet. This pipe fitting may be a flange, grooved-end, threaded fitting, or other fluid pipe fitting. slurry may travel through the feed pipe into nozzle insert 964 without contacting outer shell 962. Mounting plate 966 may be press fit onto outer shell 962. Mounting plate 966 allows removable insert nozzle 960 to be mounted to a collision chamber.

Nozzle insert 964 may comprise has a small lip to allow retaining nut 968 to provide compression between nozzle insert 964 and outer shell 962. Retaining nut 968 may be removed to allow nozzle insert 964 to slide out of outer shell 962 for replacement after nozzle insert 964 is worn out. Nozzle inserts may comprise a sensor to indicate wear life and alert operator of worn nozzle inserts which may need refurbishment or replacement. Wear sensors may be electronic, such as a small wire, ultrasonic imaging, vibration sensor, temperature sensor, moisture sensor, pressure sensor, load cell, strain gauge, optical sensor, microphone, or other sensor. The sensor may be in communication with any component of the system. The sensor may control, regulate, modify, adjust, and/or monitor any component of the system. The sensor may comprise a software program. The software program may employ machine learning, artificial intelligence, a neural network, an algorithm, or a combination thereof.

Removable insert nozzle 960 may comprise nozzle cap 970. Nozzle cap 970 may be threaded onto the end of outer shell 962. Nozzle cap 970 functions as a sacrificial component to protect outer shell 962 from damage.

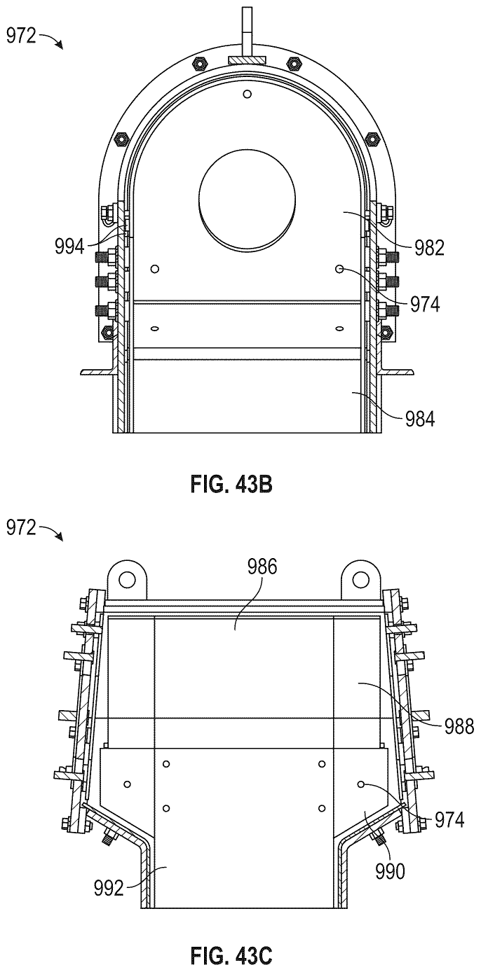

High-pressure slurry ablation collision chambers described herein may comprise wear plate collision chambers 972. Wear plate collision chamber 972 may comprise one or more wear plates, for example, chamber side plate 980, nozzle wear plate 982, chute wear plate 984, curved collision wear plate 986, curved side wear plate 988, corner wear plate 990, and lower collision wear plate 992, as illustrated in FIGS. 43A, 43B, and 43C. Wear plates allow for slower wear rates and longer maintenance intervals on high-pressure slurry ablation equipment. Wear plates can be made of any material. Hard materials may include, but are not limited to, tungsten carbide, hardened weld bead, silicon carbide, abrasion-resistant (“AR”) steel plate, ceramic tiles, ceramic matrix composites, steel alloys, hardened steel, stainless steel, or a combination thereof. Soft materials may include, but are not limited to, polyurethane, ultra-high molecular weight (“UHMW”) polyethylene, high-density polyethylene (“HDPE”), natural rubber, styrene-butadiene rubber (“SBR”), nylon, or a combination thereof. Wear plates may be made of two different materials, bonded with methods including, but not limited to, adhesives, fasteners, welding, dovetail joints, tab and slot, or a combination thereof.

Wear plates may comprise a sensor to indicate wear life and alert operator of worn wear plates which may need refurbishment or replacement. Wear sensors may be electronic, such as a small wire, ultrasonic imaging, vibration sensor, temperature sensor, moisture sensor, pressure sensor, load cell, strain gauge, optical sensor, microphone, or other sensor. Wear plate condition may be measured using a variety of sensors and machine learning techniques. Sensors may be installed anywhere inside or outside of wear plate collision chamber 972, or anywhere around the tank, collector, or wear plate collision chamber 972 outlet.

FIGS. 43A, 43B, and 43C show multiple views of wear plate collision chamber 972. Wear plates (chamber side plate 980, nozzle wear plate 982, chute wear plate 984, curved collision wear plate 986, curved side wear plate 988, corner wear plate 990, and lower collision wear plate 992) may be retained within wear plate collision chamber 972 with retaining studs 974. Retaining studs 974 may thread into threaded holes on wear plates. Location of retaining studs 974 may be flush with the inner surface of the wear plate, or they may protrude slightly into or out of the threaded hole. Retaining studs 974 may be fasteners made of a corrosion resistant material, or a hardened material, or a soft abrasion resistant material. Retaining studs 974 may be held in place with an industrial adhesive or epoxy to prevent retaining studs 974 from turning during removal of wear plates. Epoxy may fill divots caused by the threaded hole in the wear plate for retaining studs 974.

For service, curved collision wear plate 986 and curved side wear plate 988 may be removed from wear plate collision chamber 972. This can be accomplished by removing chamber side plate 980. Collision wear plate 992 and curved side wear plate 988 may be removed by releasing pressure from set screws 976 and sliding the wear plates out along wear plate slider strips 994. After sliding the wear plates out, they may be refurbished or replaced. Set screws 976 prevent curved collision wear plate 986 and curved side wear plate 988 from shifting inside of wear plate collision chamber 972 during normal operation. Wear plates fastened to chamber 978 with retaining studs 974 may be accessed and replaced by removing chamber side plate 980.

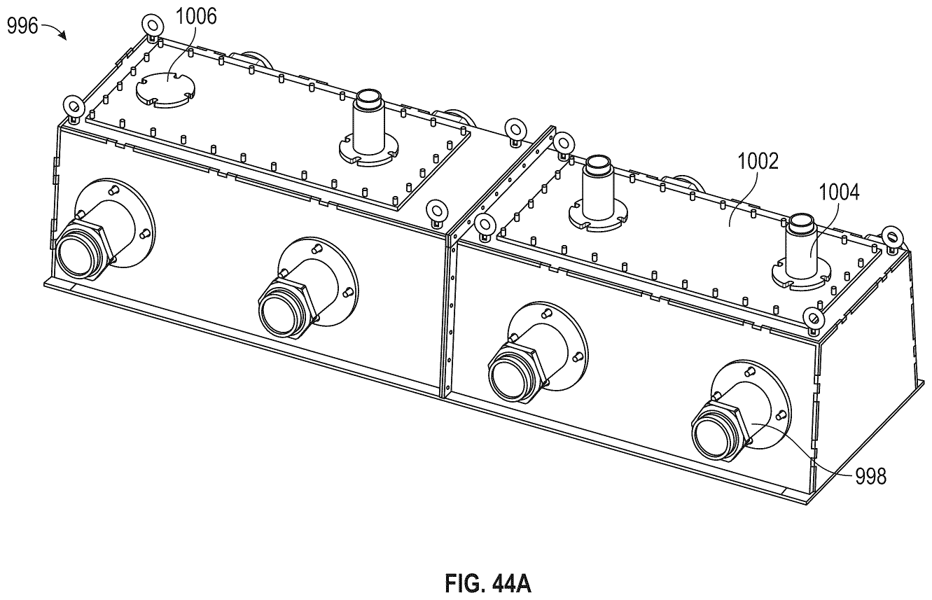

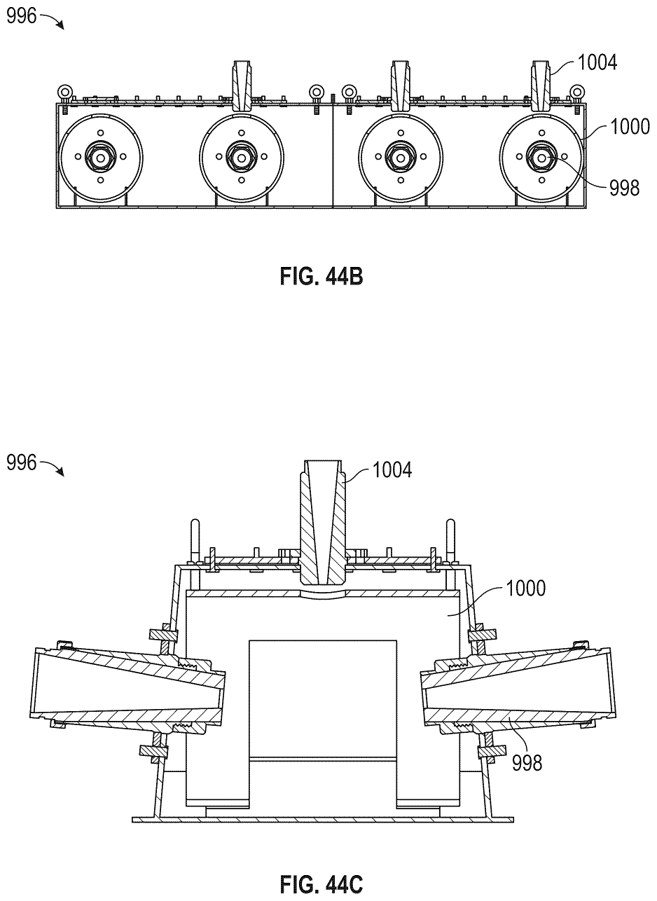

Referring now to FIGS. 44A, 44B, and 44C, high-pressure slurry ablation array collision chamber 996 may be built to house multiple sets of nozzles in a single chamber. High-pressure slurry ablation array collision chamber 996 may be horizonal or vertical with respect to the discharge plane. Multiple sets of collision nozzles 998 may exist within a single collision chamber. These sets of nozzles may exist with or without dividers to separate fluid, or with partial separators. Slurry may be kept from mixing between collision nozzle 998 sets or allowed to mix. One benefit of allowing slurry to mix may be a secondary collision between two nozzle sets after a primary collision, which may provide additional particle breakage or liberation.

High-pressure slurry ablation array collision chamber 996 may be made of flat or bent metal plate or other hard plate material. Additionally, high-pressure slurry ablation array collision chamber 996 may be made of threaded or welded piping components. For example, high-pressure slurry ablation array collision chamber 996 may be made of multiple arranged pipe tees. Metal may be cut out between tees to allow fluid flow between tees, and flat plate may be welded around the voids to ensure a fluid-tight seal and redirect slurry flow in a specific direction.

An example of high-pressure slurry ablation array collision chamber 996 with multiple views is shown in FIGS. 44A, 44B, and 44C. High-pressure slurry ablation array collision chamber 996 may comprise four pairs of collision nozzles 998. The internals of high-pressure slurry ablation array collision chamber 996 may be open, allowing slurry to move throughout the entire chamber. Optional wear pipes 1000 may be installed in the chamber. Wear pipes 1000 may be installed to prevent high velocity fluid impact with chamber walls to prevent chamber wear. Wear pipes 1000 may be constructed from or coated with various wear resistant materials. Wear pipes 1000 may be cut to allow slurry to flow between collision nozzle 998 sets, or they may prevent slurry from flowing between collision regions. Slurry from collisions from a specific collision nozzle 998 set may have a moderate to high velocity when exiting the collision region. This slurry may flow towards more slurry moving in the opposite direction from another collision region. The resulting slurry and particle impact may provide additional particle breakage or liberation. Wear pipes 1000 may protect nozzles from adjacent collisions by blocking fluid flow from a collision region to the adjacent collision nozzle 998 in the event of a natural fluctuation or collision imbalance. Wear pipes 1000 may be accessed, removed, or replaced by removing access hatch 1002 on the top of high-pressure slurry ablation array collision chamber 996.

High-pressure slurry ablation array collision chamber 996 may comprise optional blowdown nozzles 1004. Blowdown nozzles 1004 propel slurry towards the top of the collision region produced by collision nozzles 998. Blowdown nozzles 1004 serve the purpose of changing direction of slurry flowing out of the collision region. By directing slurry downwards, particles in slurry do not impact some parts of high-pressure slurry ablation array collision chamber 996, reducing wear. Additionally, particles may undergo high-pressure slurry ablation collision interactions for breakage and liberation. Blowdown nozzles 1004 may be fed by a main high-pressure slurry ablation collision pump, dedicated blowdown nozzle pump, system feed pump, or system product pump. One or multiple mounting locations on high-pressure slurry ablation array collision chamber 996 may be covered by blind mounting plate 1006 when blowdown nozzles 1004 are not in use. Blowdown nozzles 1004 may be identical to collision nozzle 998 designs, or they may be made of threaded or welded piping components, or they may be a new and novel design specific to blowdown nozzle 1004 function and optimal geometry.

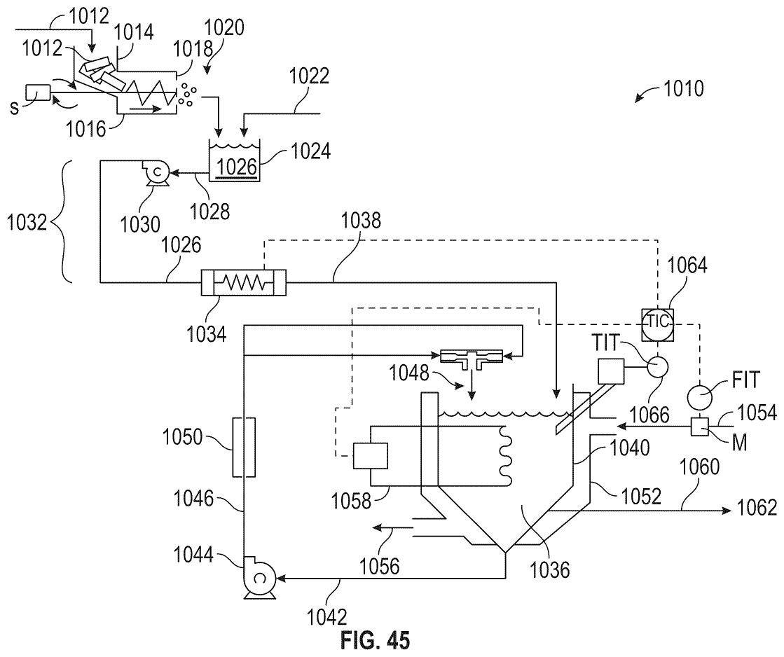

FIG. 45 illustrates hydrocarbon processing system 1010. Hydrocarbon feed 1012 may be deposited into feed hopper 1014. Auger 1016 within feed hopper 1014 may process hydrocarbon feed 1012 into pellets 1020. Pellets 1020 may exit feed hopper 1014 through extrusion point 1018. Pellets 1020 and dilution water 1022 may then enter slurry mix tank 1024. Pellets 1020 and dilution water 1022 combined may produce slurry 1026, which is held in slurry mix tank 1024.

Slurry 1026 may be transported out of slurry mix tank 1024, via conduit 1028 and pump 1030, along hydro transport conduit 1032 and into heat exchanger 1034. Heat exchanger 1034 heats slurry 1026. Slurry 1026 may transport from heat exchanger 1034, through conduit 1038, and into process tank 1040.

Process tank 1040 may hold process slurry 1036. Process slurry 1036 may convey from process tank 1040 through conduit 1042 into pump 1044, via suction from pump 1044. Pump 1044 may convey process slurry 1036 through conduit 1046 into collision chamber 1048. Conduit 1046 may be insulated with conduit insulation 1050. Collision chamber 1048 splits process slurry 1036 into one or more streams of fluid. The one or more streams of fluid are collided with one another within collision chamber 1048. The collided process slurry 1036 may then fall back into process tank 1040 and be combined with existing process slurry 1036. Therefore, process slurry 1036 may comprise process slurry coming from heat exchanger 1034, process slurry coming from collision chamber 1048, and a combination thereof. Slurry product 1062 may exit process tank 1040 through exit conduit 1060.

Process tank 1040 may be encapsulated with tank heating jacket 1052. Heating medium 1054 may be conveyed into the cavity generated between process tank 1040 and tank heating jacket 1052. Heating medium 1054 transfers thermal energy to process slurry 1036. As thermal energy from heating medium 1054 is transferred, spent heating medium 1056 may exit tank heating jacket 1052. Electrical heating coil 1058 may be used to heat process slurry 1036 within process tank 1040.

Temperature control loop 1064 and tank temperature transmitter 1066 may be used to monitor and control temperatures of process slurry 1036 by directing temperature changes in electrical heating coil 1058 and heating medium 1054.

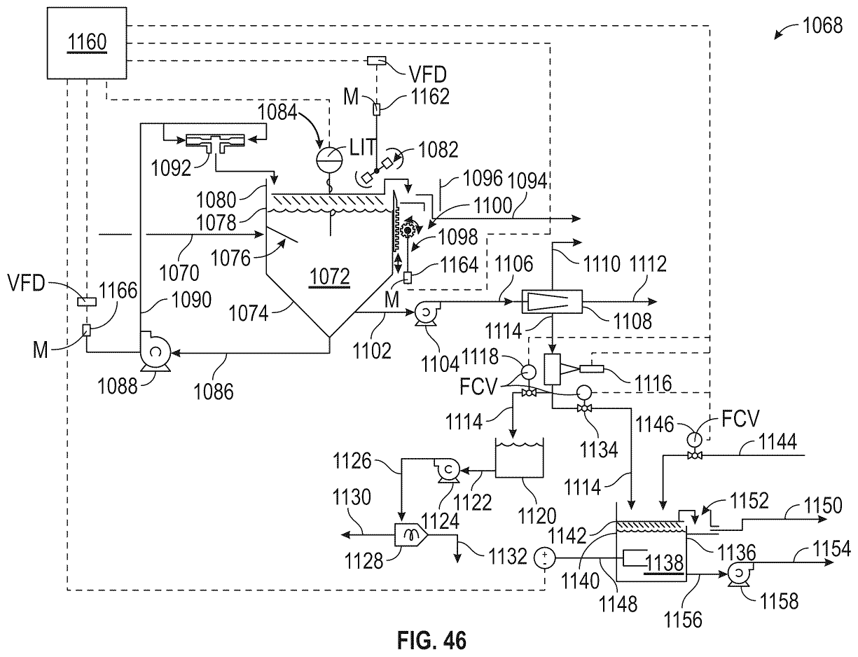

FIG. 46 illustrates hydrocarbon processing system 1068. Feed material 1070 may enter process tank 1074. Process tank 1074 may comprise tank baffle 1076. Tank baffle 1076 may direct feed material 1070 away from the top opening of process tank 1074. Fluid levels within process tank 1074 may be monitored with slurry level 1078 and free oil level 1080, measured with level transmitter 1084. Rotating paddle 1082 may be used to mix process slurry 1072 within process tank 1074. Process slurry 1072 may convey from process tank 1074, through conduit 1086 and conduit 1090, via suction from pump 1088 into collision chamber 1092. Collision chamber 1092 splits process slurry 1072 into one or more streams of fluid. The one or more streams of fluid are collided with one another within collision chamber 1092. The collided process slurry 1072 may then fall back into process tank 1074 and be combined with existing process slurry 1072. Therefore, process slurry 1072 may comprise process slurry coming from feed material 1070, process slurry coming from collision chamber 1092, and a combination thereof.

Process tank 1074 may comprise motor driven gear system 1098 and adjustable weir 1100 which allow overflow launder 1096 to adjust in height relative to the top of process tank 1074. As overflow launder 1096 moves down, overflow oil 1094 may spill out of and exit process tank 1074.

Process slurry 1072 may exit process tank 1074 through exit conduit 1102 via suction from pump 1104. Pump 1104 may convey process slurry 1072 through conduit 1106 into tricanter centrifuge 1108. Tricanter centrifuge 1108 may split process slurry 1072 into one or more streams, including but not limited to, tricanter separated oil 1110, tricanter separated sand 1112, and tricanter separated water 1114. Tricanter separated water 1114 may convey through oil droplet imaging system 1116. Oil droplet imaging system 1116 measures and images the oil content within tricanter separated water 1114. Tricanter separated water 1114 may convey past oil droplet imaging system 1116 and split into one or more paths.

In one path, tricanter separated water 1114 may convey through first flow control valve 1118 and into cyclone charge tank 1120. Tricanter separated water 1114 may flow from cyclone charge tank 1120, through conduit 1122, into pump 1124 via suction from pump 1124. Pump 1124 may convey tricanter separated water 1114 through conduit 1126 into emulsion separation cyclone 1128. Emulsion separation cyclone 1128 may separate tricanter separated water into cyclone separated oil 1130 and cyclone separated water 1132.

In another path, tricanter separated water 1114 may convey through second flow control valve 1134 and into electrolytic separation tank 1136. Reagents 1144 may also flow into electrolytic separation tank 1136 through reagent control valve 1146. Tricanter separated water 1114 and reagents 1144 may mix in electrolytic separation tank 1136 with electrolytic device 1148 to produce mixed slurry 1138. Mixed slurry 1138 within electrolytic separation tank 1136 may comprise water level 1140 and free oil level 1142. Separated oil 1150 may convey out of electrolytic separation tank 1136 through overflow launder 1152. Cleaned fluid 1154 may exit electrolytic separation tank 1136 through conduit 1156 via suction from pump 1158.

Hydrocarbon processing system 1068 may comprise central control system 1160. Central control system 1160 may provide power, directions, and instructions to electric motor 1162, electric motor 1164, and electric motor 1166. Central control system 1160 may comprise one or more variable frequency drives (“VFDs”) that that controls the speed and torque of a motor by varying the frequency and voltage of the power supplied to it. Central control system 1160 directs electric motor 1162, which in turn controls rotating paddle 1082. Central control system 1160 directs electric motor 1164, which in turn controls motor driven gear system 1098 and adjustable weir 1100. Central control system 1160 directs electric motor 1166, which in turn controls pump 1088.

Central control system 1160 may provide power, directions, and instructions to level transmitter 1084, oil droplet imaging system 1116, first flow control valve 1118, second flow control valve 1134, reagent control valve 1146, electrolytic device 1148, and any other components that call for electricity or control.

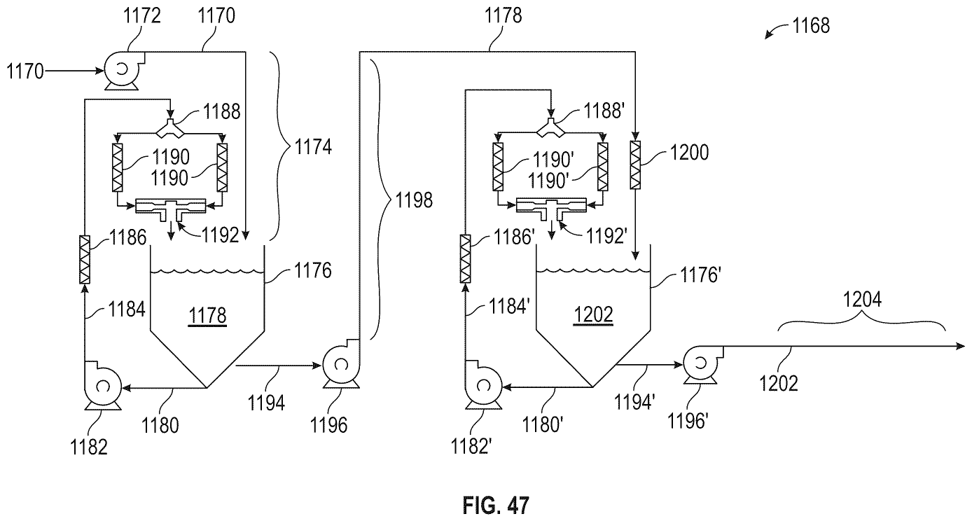

FIG. 47 illustrates hydrocarbon processing system 1168. Feed material 1170 may convey through pump 1172, through first hydro transport conduit length 1174, and into process tank 1176. Feed material 1170 may be unablated. Process tank 1176 may hold first stage ablated material 1178, which may comprise unablated material from feed material 1170 and ablated material from collision chamber 1192. First stage ablated material 1178 may convey from process tank 1176, through conduit 1180, into pump 1182. Pump 1182 may convey first stage ablated material 1178 from pump 1182, through conduit 1184 and primary flow conditioner 1186, into splitter 1188. Primary flow conditioner 1186 may comprise of a chamber with bulbs or ribs surrounding the internal circumference of the chamber such that the solid particles in the slurry medium may collide with the bulbs and ribs. Splitter 1188 splits first stage ablated material 1178 into one or more streams, where each stream may flow through secondary flow conditioners 1190. Secondary flow conditioner 1190 may comprise of a chamber with bulbs or ribs surrounding the internal circumference of the chamber such that the solid particles in the slurry medium may collide with the bulbs and ribs. First stage ablated material 1178 may convey from secondary flow conditioner 1190 into collision chamber 1192. The one or more streams of fluid from secondary flow conditioner 1190 are collided with one another within collision chamber 1192. The collided first stage ablated material 1178 may then fall back into process tank 1176 and be combined with existing first stage ablated material 1178. Therefore, first stage ablated material 1178 may comprise slurry coming from feed material 1170, slurry coming from collision chamber 1192, and a combination thereof.

First stage ablated material 1178 may convey out of process tank 1176, through conduit 1194 via suction from pump 1196. Pump 1196 may convey first stage ablated material 1178 through second hydro transport conduit length 1198 and into tertiary flow conditioner 1200. Tertiary flow conditioner 1200 may comprise of a chamber with bulbs or ribs surrounding the internal circumference of the chamber such that the solid particles in the slurry medium may collide with the bulbs and ribs. First stage ablated material 1178 may convey through tertiary flow conditioner 1200 and into process tank 1176′. Process tank 1176′ may hold second stage ablated material 1202, which may comprise ablated material from first stage ablated material 1178 and ablated material from collision chamber 1192′. Second stage ablated material 1202 may convey from process tank 1176′, through conduit 1180′, into pump 1182′. Pump 1182′ may convey second stage ablated material 1202 from pump 1182′, through conduit 1184′ and primary flow conditioner 1186′, into splitter 1188′. Splitter 1188′ splits second stage ablated material 1202 into one or more streams, where each stream may flow through secondary flow conditioner 1190′. Second stage ablated material 1202 may convey from secondary flow conditioner 1190′ into collision chamber 1192′. The one or more streams of fluid from secondary flow conditioner 1190′ are collided with one another within collision chamber 1192′. The collided second stage ablated material 1202 may then fall back into process tank 1176′ and be combined with existing second stage ablated material 1202. Therefore, second stage ablated material 1202 may comprise slurry coming from first stage ablated material 1178, slurry coming from collision chamber 1192′, and a combination thereof.

Second stage ablated material 1202 may convey out of process tank 1176′, through conduit 1194′ via suction from pump 1196′. Pump 1196′ may convey second stage ablated material 1202 through third hydro transport conduit length 1204 and out of hydrocarbon processing system 1168.

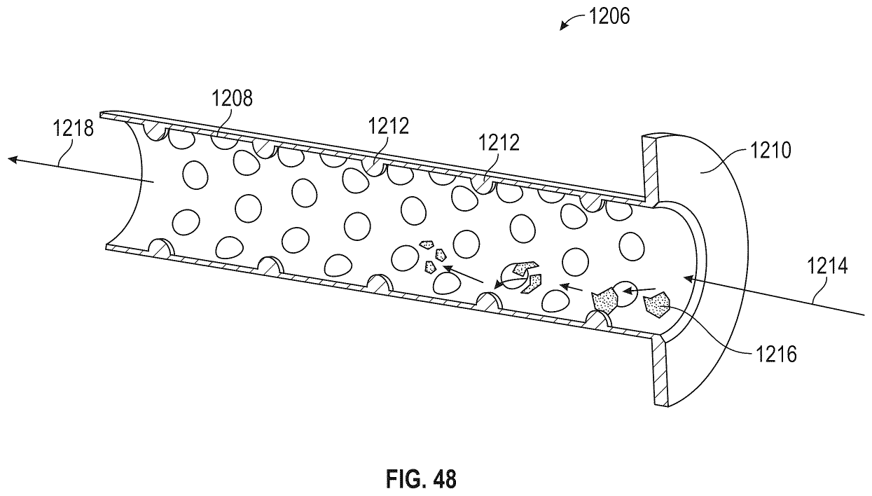

FIG. 48 illustrates cross section side profile of flow conditioner 1206. Flow conditioner 1206 may comprise chamber 1208, flange 1210, and bulbs 1212. Flange 1210 provides an opening in flow conditioner 1206 for slurry 1214 to enter. Slurry 1214 may comprise bituminous lumps 1216. Chamber 1208 comprises a plurality of bulbs 1212 on its inside wall. As slurry 1214 conveys through chamber 1208, slurry 1214 comes into contact with bulbs 1212. Bulbs 1212 break apart and fracture bituminous lumps 1216 within slurry 1214 into smaller pieces. Exit slurry flow 1218, comprising bituminous lumps 1216 broken down into smaller pieces, may exit flow conditioner 1206 on the end opposite from the end where slurry 1214 entered flow conditioner 1206.

Flow conditioners may comprise primary flow conditioners, secondary flow conditioners, and/or tertiary flow conditioners.

FIG. 48 illustrates the cross section side profile of one possible design for the flow conditioners (including primary flow conditioners, secondary flow conditioners, and tertiary flow conditioners) and the theory behind its use in promotion of the breakdown of bituminous lumps. The flow conditioner comprises of a chamber with bulbs or ribs surrounding the internal circumference of the chamber such that the solid particles in the slurry medium may collide with the bulbs and ribs. Bulbs and ribs may decrease in diameter along the progression of the chamber length to affect varying degrees of fracture on the bituminous particles. Slurry flow containing heterogeneous material may enter the flow conditioner from the side with the larger bulbs and exit the flow conditioner once bituminous particles have sufficiently fractured as precursors for downstream processing steps.

A high-pressure slurry ablation system and/or process may be integrated into a mineral processing application and/or circuit. The high-pressure slurry ablation system may replace any part of the mineral processing circuit including, but not limited to, a crush, grinding mill, cyclone (e.g., hydrocyclone), or a combination thereof. The high-pressure slurry ablation system may pass ablated heterogeneous materials into another mineral processing circuit or a portion of a mineral processing circuit. The mineral processing circuit may include, but is not limited to, circuits described in FIGS. 3 and 4 above. The mineral processing circuit may include, but is not limited to, a crusher, a grinding mill, a cyclone, a flotation cell, an attrition cell, a screen, crushing circuit, grinding circuit, cyclone circuit, flotation circuit, attrition cell circuit, or a combination thereof. The mineral processing circuit may comprising components in series and/or parallel that process (e.g., concentrate, reduce the size of, and/or purify) a heterogenous material.

Primary ore feed that may be collected and hauled from an underground mine or blasted from a surface mining deposit may be loaded by any practical means into a primary crusher. Primary crushed ore may be discharged from the primary crusher after the size of the ore has been reduced onto a primary screen to separate ore into a primary screen oversize stream and a primary screen undersize stream. This primary screen may have a separation point of about 10 mm, about 10 mm to about 8 mm, about 8 mm to about 6 mm, about 6 mm to about 4 mm, about 4 mm to about 1 mm, or less than about 1 mm, depending on the overall dry throughput of the mill.

To ensure the primary grinding feed stream has been sufficiently sized for downstream processing, a loop of multiple crushers and screeners may be present in the system. A secondary crusher may receive feed streams of both the primary and secondary screen oversize heterogeneous material. A secondary crusher discharge stream may be recycled over the top of a secondary screen in a closed loop while the primary and secondary screening undersize streams combine to form the primary grinding feed stream.

The initial ore preparation upstream of primary grinding may be a dry process and process water may be added to a primary grinding feed stream prior to entering a primary grinding mill. This primary grinding mill may comprise a tumbling mill and may be an autogenous grinding mill, semi-autogenous grinding mill, a ball mill, a rod mill, or a combination thereof depending on the liberation and size reduction requirements of the downstream processing steps. A primary grinding circuit may be employed as a closed circuit application, wherein the primary grinding mill discharge stream may be fed to a primary cyclone to classify smaller particles from larger particles. Closed circuits may be used to ensure that the primary cyclone overflow stream which feeds the primary flotation cells is of adequately small particle size for the primary flotation cells to effectively separate liberated target minerals from the liberated gangue minerals. The primary flotation cells may be replaced with a system specific to recover coarser particles in conjunction with a system to recover fine particles allowing the cyclone to classify at a coarser size.

A primary flotation reagent may be added prior to the primary cyclone overflow stream entering the primary flotation cells. This may be done in an agitated conditioning tank to ensure adequate mixing of primary flotation reagents and primary cyclone overflow slurry prior to flotation. The primary cyclone underflow stream may enter a primary flash flotation cell. Primary flash flotation cells may be used when target minerals can be liberated from gangue minerals at a coarser particle size than specified as the cut point for the primary cyclone. The primary flash cell concentrate may be combined with the primary flotation concentrate to create a secondary grinding mill feed stream while the primary flash cell tails may recombine with the primary grinding feed stream entering into the primary grinding mill to be liberated further or further reduced in size. When target minerals cannot be liberated at coarser particle sizes, the primary flash floatation cell may be removed from the flowsheet design altogether or bypassed and the primary cyclone underflow may directly combine with the primary grinding feed stream.

Depending on the configuration system and the target mineral to be recovered, the primary flotation tails and/or concentrate streams may enter secondary flotation cells where a stream of secondary flotation reagents with a different chemical composition than the primary flotation reagents may be added. The secondary flotation cells may separate tails and/or concentrates into separate downstream processing or storage steps. As an example, as is common with sulfide flotation circuits, potentially acid generating tails containing iron sulfide minerals may be floated (the concentrate) from the non-acid generating tails containing mostly silicate minerals. Similarly, the secondary flotation cells may be used to recover separate minerals that are both valuable and separated from the gangue in the primary flotation cells but must be separated from each other and for further downstream processing steps as with copper molybdenum milling processes.

Both the secondary flotation tails and secondary flotation concentrate streams may enter into a thickener as downstream solid-liquid handling steps. The thickener separates out process water from the relative entering streams creating thickener overflow streams into a reusable recycle process water stream for the mill operations. A thickener underflow stream may then exit to downstream processing steps.

Downstream operations may comprise pumping the thickener underflow to a chemical processing plant. The thickened slurry material exiting the thickener may be fed to a filter press, centrifuge, other dewatering and drying system, or a combination thereof to be transported as a final product. The thickener underflow stream may be diverted to separate tailings impoundments for long term storage.

The secondary grinding mill feed stream may be fed to a secondary grinding mill. The secondary grinding mill may comprise a tumbling mill which may either be an autogenous, semi-autogenous, ball mill, rod mill, or a combination thereof. Where less size reduction of the secondary grinding mill feed stream is preferred, the secondary grinding mill may be replaced by an attrition cell. The attrition cell may scrub surfaces of materials and liberate remaining gangue prior to downstream processing steps. The secondary grinding mill discharge may be fed to a secondary cyclone as depicted to separate the discharge stream by size into the two separate streams shown as the secondary cyclone overflow and the secondary cyclone underflow. The secondary grinding mill may operate in an open circuit, also referred to as a desliming configuration, with the secondary cyclone overflow stream entering a tailings thickener, while the secondary cyclone underflow stream enters the tertiary flotation cells or circuit for further recovery of target minerals. The open circuit or desliming configuration of the secondary grinding mill and secondary cyclone may be employed in circuits where the secondary grinding mill feed stream does not require significant size reduction such as phosphate flotation applications.

In milling processes where further size reduction is required for performance of the tertiary flotation cells, the secondary grinding mill and secondary cyclone circuit may be configured in a closed circuit similar to the primary grinding mill and primary cyclone, where the secondary cyclone underflow re-enters the secondary grinding mill and the secondary cyclone overflow enters the tertiary flotation cells or circuit. The above-described closed-circuit configuration may be employed in hard copper ore processing where copper minerals are present as fine interstitials within particles and a significant size reduction down to about 75 microns, about 75 microns to about 1 micron, about 70 microns to about 5 microns, about 60 microns to about 10 microns, about 50 microns to about 20 microns, about 40 microns to about 30 microns, or less than about 1 micron is required.

Tertiary flotation tails and/or concentrate exit the tertiary flotation cells or circuit and enter further downstream processing, a thickener, dewatering process, or a combination thereof depending on the mineral processing application. For processes requiring high grade products, the tertiary flotation concentrate stream exiting the tertiary flotation cells may be further processed using one or more attrition cells. Ceramic or steel grinding media may be introduced into the attrition cells to increase mineral liberation of the particles within the slurry. The grinding media may be separated by size, magnetic, or other means prior to the attrition cell discharge feeding one or more flotation columns or be allowed to break down and enter the downstream flotation column without separation. The flotation column and/or array of flotation columns may be used to produce high purity products for downstream refinement or product packaging for either the column flotation concentrate or column flotation tails streams.

The high-pressure slurry ablation system and/or process may be integrated into a mineral processing system to receive primary screen undersize, secondary screen undersize, secondary crusher undersize, or combined primary grinding feed stream either as a slip stream, taking a fraction of the mass less than 100 percent, or processing the entire stream to add benefit to the downstream processing steps. High-pressure slurry ablation may be integrated in a closed or open circuit when processing these streams and/or replace any part of the closed or open circuit when processing these streams.

The high-pressure slurry ablation system and/or process may be integrated into a mineral processing system by replacing the primary grinding mill, the secondary grinding mill, the attrition cell, or any other grinding and liberation step prior to flotation, desliming configuration, other separation such as magnetic separation, or a combination thereof. Depending on the number of tumbling mills or attrition cells in the flowsheet, the high-pressure slurry ablation system and/or process may be integrated into a mineral processing system to replace multiple or all liberation steps.

The high-pressure slurry ablation system and/or process may be integrated into a mineral processing system by serving as a conditioning mixing tank for the mixing of the primary cyclone overflow stream and the primary flotation reagent stream prior to feeding the material into the primary flotation cells or circuit. The high-pressure slurry ablation system and/or process may also be integrated to serve as a conditioning mixing tank for the mixing of the primary flotation tails and/or concentrate and secondary flotation reagent stream. The high-pressure slurry ablation system and/or process may also be integrated to serve as a conditioning mixing tank for the mixing of reagents from the prior to the tertiary flotation cells or flotation columns. At any of these integration points, the high-pressure slurry ablation unit may serve as a unit operation providing both liberation and mixing of the reagents with the slurry. The high-pressure slurry ablation system and/or process may also serve as a unit operation providing liberation, mixing of the reagents with the slurry, and recovery of flotation concentrate or tails from the high-pressure slurry ablation system. When serving as a system for liberation, mixing, and flotation concentrate recovery, integration of a high-pressure slurry ablation system and/or process may replace multiple unit operations at the same time. For instance, when integrated into a mineral processing system to process the tertiary flotation concentrate or tails streams, the high-pressure slurry ablation system and/or process may replace both the attrition cell and the flotation column to produce an equivalent of the depicted column flotation concentrate and column flotation tails streams.

The high-pressure slurry ablation system and/or process may be integrated a mineral processing system by serving solely as a size reduction unit operation preparing the final product for downstream processing by processing a portion or the entire stream in closed or open circuit configuration for the secondary flotation tails, secondary flotation concentrate, thickener underflow, column flotation concentrate, column flotation tails, tertiary flotation tails and/or concentrate streams, or a combination thereof depending on the downstream process. As an example, in some phosphate mineral processing applications, beneficiation processes are located miles away from phosphoric acid production plants. Due to these distances, slurry (i.e., heterogenous material) is transported by high pressure pumps through pipelines which can wear or more easily clog if particle size requirements, particularly large particle sizes are present in the slurry. A high-pressure slurry ablation system and/or process may be integrated as a product preparation step to reduce the percentage of coarse particles in the product pipeline due to its use of slurry jets wherein the coarser particles tend to follow the center region of the collision jet and fracture while the finer particles spread with the water transporting the particles reducing their fracture rate.

The high-pressure slurry ablation system and/or process may be integrated into the mineral processing system in the following areas either in an open circuit or closed circuit configuration, processing either a slipstream or the full stream in preparation for a downstream processing step to improve liberation: primary cyclone overflow, primary cyclone underflow, primary flash cell tails, primary flash cell concentrate, primary flotation concentrate, primary flotation tails, secondary flotation tails, secondary flotation concentrate, secondary grinding mill feed, secondary cyclone overflow, secondary cyclone underflow, tertiary flotation tails, tertiary flotation concentrate, attrition cell discharge, column flotation concentrate, column flotation tails, thickener underflow, or a combination thereof. An additional separation step may be included directly after high-pressure slurry ablation when processing these streams. This separation step may be size separation through screening or hydrocyclone, magnetic separation, flotation separation, or a combination thereof. Further, in cases where tertiary flotation tails and/or concentrate, column flotation tails, thickener underflow, are stored in tailings impoundments or otherwise segregated and stored, a high-pressure slurry ablation system and/or process may be used as a reprocessing step for these tailings streams. When used as a reprocessing step, the high-pressure slurry ablation system and/or process may process the material and return the material to a separation step. Alternatively, an additional separation step may be included after high-pressure slurry ablation to create a desired product.

A high-pressure slurry ablation system and/or process may be integrated into a grinding feed stream. The high-pressure slurry ablation system and/or process may process the grinding feed stream and discharge the ablated material into the a flash flotation cell or circuit, where the high-pressure slurry ablation's coarser liberation size may allow for target minerals to be recovered into the flash cell concentrate stream without overgrinding the minerals and creating the potential for them to be lost in a flotation stream. The flash cell tails may then flow into a grinding mill or be processed by a separate high-pressure slurry ablation system and/or process configured for size reduction. Processing of primary grinding feed with a high-pressure slurry ablation system and/or process then discharging into a flash cell may be improve yields of a graphite processing circuit, where larger graphite flakes are worth more and the desire to prevent overgrinding of the graphite flakes with traditional tumbling mill technology is likely.

The system and method may be used for the production of chemicals including, but not limited to, base chemicals, fine chemicals, fertilizers, specialty chemicals, or a combination thereof. When integrated into a mineral recovery, the high-pressure slurry ablation system may ablate heterogeneous material in the presence of an acid to enhance reaction kinetics by simultaneously facilitating particle size reduction, liberation, and effective mixing of the slurry. Integration of the high-pressure slurry ablation system into a mineral recovery process may increase the available surface area of the particles contained in the slurry for chemical reactions and provides thorough agitation, thereby reducing reaction time and minimizing the required reactor footprint. The high-pressure slurry ablation system may also be used for emulsions, dispersing solids in liquids, specifically for sorbents to enhance the free surface for contact between the sorbent and the constituent leading to improved kinetics.

The collision regime may comprise one or more first plane nozzles oriented on a first plane which direct their first plane streams into a central collision point also located in the first plane. The collision regime may also comprise one or more second plane nozzles oriented in a second plane that directs second plane streams into the same central collision point. The collision regime may comprise at least three first plane nozzles and streams and at least one second plane nozzle and stream.

The orientation of the second plane nozzles may be rotated along the second plane to affect the direction of the jet-collided slurry's discharge out of the first plane. Similarly, the orientation of the second plane nozzle may be kept constant in the second plane while the orientation of the first plane nozzles in the first plane are adjusted to affect the direction of the jet collided slurry's discharge out of the first plane.

The inter-plane angle between the first plane and the second plane may be adjusted to affect the discharge of the jet collided slurry out of the first plane.

The streams entering the nozzles in the first plane may be heterogeneous material mixed with water, or they may comprise of pure water. The stream entering the nozzle in the second plane may be fed by a heterogeneous material of heterogeneous material and water or it may be fed by pure water.

The streams entering the nozzles on the first plane may all be fed by a pump pumping slurry through a distribution system to the nozzles while the nozzle in the second plane is fed by the same pump, or a separate pump pumping pure water through the nozzle and into the central collision point. The pure water may serve as dilution for the system if the process tank is fed by slurry at higher percent solids than the system can handle.

The jet-collided slurry may directly enter the process tank below the central collision point in the first plane.

The collision plate may be placed below the first plane with an orientation such that the jet-collided stream forms a plate collision angle that may be adjusted to affect varying degrees of heterogeneous material fracture. The collision plate may comprise carbon steel, chrome carbide, stainless steel, other hardened steel, steel alloy, or a combination thereof.

A housing may be placed around the nozzles in the collision regime such that the housing fixes the first plane nozzles in the first plane in place but allows for adjustment of the second plane nozzle in the second plane as well as the adjustment of the second plane relative to the first plane. The housing may be as simple as a rubber mat extending over the collision regime affixed to the mating surface between the nozzle and the hose injecting slurry into it. Inclinometers may be affixed to the nozzles or the conduit entering them to provide indication of nozzle positioning. Nozzles can be either cylindrical or tapered.

The removable insert nozzle may function as a component that improves the maintenance process and reduces replacement cost of high-pressure slurry ablation collision nozzles. The nozzle insert may comprise any wear resistant material. The outer shell may benefit from a material selection that reduces corrosion, such as a coated steel, stainless steel, aluminum, or other material or coating that resists corrosion and deterioration in wet and corrosive environments. If the outer shell experiences abrasive wear, the material may be selected to reduce abrasion.

The hydrocarbon processing system may comprise a high-pressure slurry ablation unit and be applied to hydrocarbon material oil sands processing. Hydrocarbon material/feed may comprise, but is not limited to, an oil sands material comprising bitumen, coarse sand, fine clays, or a combination thereof.

Hydrocarbon material may be extracted in the form of large lumps by general processes and loaded into a feed material hopper. The feed material hopper may allow the lumps to flow into an extruding feed auger with a rotating screw powered by an electric motor. The motion of this screw may convey the material down the shaft of the auger to the end of the extruding feed auger where material is pressed through extrusion points comprising of small apertures. The apertures may be different size ranges to generate extruded pellets with resulting spherical diameters of at least about 0.25 inches, about 0.25 inches to about 3 inches, about 0.5 inches to about 2.5 inches, and about 1 inch to about 2 inches.

Extruded pellets may enter the top of the slurry mix tank by gravity means where they are combined with dilution water to form a process slurry. The dilution water may be at a temperature of least about 50 degrees, about 50 degrees to about 400 degrees, about 75 degrees to about 350 degrees, about 100 degrees to about 300 degrees, about 150 degrees to about 250 degrees, or about 400 degrees Fahrenheit. Higher temperature dilution water may increase the mobility of the process slurry and promote the breakdown of lumps when transported over a hydro transport conduit. The dilution water may be in a gaseous or liquid state. The dilution water may comprise steam. The dilution water may be pressurized.

The slurry mix tank may be in fluid communication with a feed pump through a feed pump suction conduit. The feed pump may pump the slurry feed stream over a hydro transport conduit to achieve the desired material feed size for the system. The feed pump may be in fluid communication with a slurry feed heat exchanger after the hydro transport length of conduit to reheat the slurry to a temperature of least about 50 degrees, about 50 degrees to about 400 degrees, about 75 degrees to about 350 degrees, about 100 degrees to about 300 degrees, about 150 degrees to about 250 degrees, or about 400 degrees Fahrenheit. The temperature of the slurry may decrease over the course of the hydro transport length.

The heated slurry feed stream may enter the process tank which is in fluid communication with the collision pump. The collision pump may discharge material to the collision chamber through a pump discharge to chamber conduit which may have pipe insulation installed around it to maintain a slurry temperature in the range of at least about 70, about 70 to about 250, about 80 to about 225, about 90 to about 200, about 100 to about 180, about 120 to about 160, about 130 to about 150, or about 250 degrees Fahrenheit prior to the slurry entering the nozzles of the collision chamber. Heat trace may be installed in this pipe insulation to maintain system temperature.

Slurry transported through the pump discharge to chamber conduit may enter the collision chamber, where it may be ablated, and return to the process tank to be processed again. The process tank may be in fluid communication with an outlet stream conduit which may exit the system either through gravity draining means or by being discharged from the system with a pump.

A tank heating jacket may be installed around the circumference of the process tank where a high temperature heating medium may enter the tank heating jacket and exchange heat with the process slurry to maintain a temperature of between about 50 degrees to about 250 degrees, about 60 degrees to about 240 degrees, and about 70 degrees to about 230 degrees Fahrenheit. The high temperature heating medium may be a liquid or gaseous fluid transported through the tank heating jacket by use of a compressor or a pump. Spent heating medium may exit the tank heating jacket once it has transferred heat to the process slurry in the process tank.

An electrical heating coil may be installed through the side of the process tank to increase or maintain the temperature of the process slurry to between about 50 degrees to about 250 degrees, about 60 degrees to about 240 degrees, and about 70 degrees to about 230 degrees Fahrenheit.

A tank temperature transmitter may be installed to measure the process slurry temperature. The tank temperature transmitter may be in communication with a temperature control loop allowing variance of the flow of the high temperature heating medium, the power supplied to the electrical heating coil, or the power supplied to the feed heat exchanger. All methods of temperature control may be used to maintain the process slurry temperature or one method depicted may be used to maintain the process slurry temperature or two of the methods may be used to maintain the process slurry temperature.

The heating medium may comprise, but is not limited to, steam generated from a boiler, an organic fluid, or a combination thereof.

The electrical heating coil may be substituted with an organic Rankin cycle for heat transfer, or a refrigeration cycle can be used in place of the electrical heating coil with the condenser inside of the tank.

The hydrocarbon processing system may comprise a high-pressure slurry ablation unit and be applied to hydrocarbon material processing with a hydro transport pipeline to break down bituminous lumps. High-pressure slurry ablation may be integrated in various stages of the hydro transport pipeline such that the various hydro transport conduit lengths allow for some conditioning of the slurry and breakdown of the bituminous lumps for optimal lump size in each of the high-pressure slurry ablation stages.

Feed material, which may comprise slurried oil sands material, that has not been processed by high-pressure slurry ablation may transported by a hydro transport pump along a pipeline for a specified first hydro transport length prior to feeding into a first process tank. The first process tank may be in fluid communication with the first collision pump. The pump discharge to chamber conduit from this collision pump may be in fluid communication with a primary flow conditioner prior to a slurry splitter. The primary flow conditioner may be used to provide flow development for more even splitting of the slurry to each nozzle as well as promote the breakdown of bituminous lumps prior to collision of the heterogeneous material in the first stage collision chamber.

The splitter may be in fluid communication with secondary flow conditioners installed prior to slurry entry into the first stage collision chamber to provide flow development and a more uniform jet stream from the nozzle exits in the first stage collision chamber. Secondary flow conditioners also promote the breakdown of bituminous lumps prior to collision of the heterogeneous material in the first stage collision chamber. The first stage collision chamber may be capable of processing bituminous lumps with diameters of about 0.5 inches to about 3.5 inches, about 1 inch to about 3 inches, and about 1.5 inches to about 2.5 inches.

After material has collided in the first stage collision chamber, it may return to the first process tank to either be reprocessed or discharged by a second hydro transport pump over a specified second hydro transport conduit length. The second hydro transport pump may be in fluid communication with a tertiary flow conditioner prior to discharging into the second process tank. The tertiary flow conditioner may be used to promote breakdown of bituminous lumps.

The second process tank may be in fluid communication with a secondary collision pump. The secondary collision pump may be in fluid communication with a primary flow conditioner, a slurry splitter, and secondary flow conditioners as well as a second stage collision chamber. This second stage collision chamber may comprise nozzles capable of processing bituminous lumps with diameters of about 0.25 inches to about 1.75 inches, about 0.5 inches to about 1.5 inches, and about 0.75 inches to about 1.25 inches.

After heterogeneous material has collided in the second stage collision chamber, it may be discharged into the second process tank either for reprocessing or discharge by another hydro transport pump. The hydro transport pump may transport the ablated material over another specified hydro transport conduit length to general downstream processing for oil sands material or it may enter a tertiary high-pressure slurry ablation processing tank that is similar to the first or second high-pressure slurry ablation processing tanks. The first stage high-pressure slurry ablation process tank and second stage high-pressure slurry ablation process tank may incorporate any of the design elements of temperature control and oil recovery as described in other processes herein. Additional high-pressure slurry ablation systems arranged in parallel and/or series may be used to ablate the heterogeneous material.

The hydrocarbon processing system may comprise a high-pressure slurry ablation unit and be applied to hydrocarbon material processing with multiple methods for bitumen recovery and separation of the slurry constituents of sand, oil, and water. The feed material stream may enter the process tank beneath a baffle installed in the process tank in order to direct the unprocessed heterogeneous material contained in the feed material stream toward the bottom of the process tank.

The process slurry in the process tank may be drawn off by a collision pump which is in fluid communication with the process tank. The collision pump may discharge process slurry through the pump discharge to chamber conduit into the nozzles of the collision chamber. Collided material may fall from the collision chamber into the process tank where it can be processed again.

The process tank may be in fluid communication with a product pump, connected by the outlet stream conduit. The product pump may discharge process slurry in the process tank into a tricanter centrifuge. The tricanter centrifuge may separate the process slurry into three separate streams comprising oil, sand, and water. Due to the high velocity collisions of the jets in the collision chamber, oil droplets may decrease in size to the degree which they form emulsions in the water and may not be fully separated from the water in the tricanter centrifuge.

The tricanter centrifuge may be in fluid communication with an oil droplet imagining system capable of determining the degree to which processed oil has been entrained into the tricanter separated water. Depending on the degree to which the oil has been emulsified in the water, emulsions may be removed either through cyclone separation or an electrolytic separation process. The oil droplet imaging system may be in communication with a central control system which is in communication with a first flow control valve and a second flow control valve.

The laser diffraction system may be installed to measure the oil droplet size in place of the oil droplet imaging system.

A time domain nuclear magnetic resonance instrument may receive subsamples from the tricanter separated water at a certain frequency for quick analysis and report of results back to the central control system. The time domain nuclear magnetic resonance instrument may determine the oil droplet size.

The central control system may direct flow of the tricanter separated water either through the first flow control valve into a cyclone charge tank or through the second flow control valve into the electrolytic separation tank. When oil-water separation through use of a cyclone is used, the cyclone charge tank may be in fluid communication with a cyclone feed pump. The cyclone feed pump may be in fluid communication with an emulsion separation cyclone which separates the oil from the water for recovery. When oil-water separation through use of electrolytic separation is used, sodium chloride may be added to the electrolytic separation tank. An electrolytic device comprising of a device with an anode and a cathode where a voltage can be applied may be installed in the electrolytic separation tank so that the anode and cathode are submerged in the fluid. This separates the free oil into a layer above the water level in the tank. The electrolytic separation tank may be in fluid communication with a water pump to pump cleaned process water out of the system or back into the feed system to conserve water in the circuit while an overflow launder at the top of the unit may be installed to allow the layer of separated oil to overflow out of the electrolytic separation tank to be recovered.

The electrolytic device may comprise an anode and a cathode with a current density of at least about 25 Amperes per meters squared (“A/m²”), about 25 A/m² to about 250 A/m², about 50 A/m² to about 225 A/m², about 75 A/m² to about 200 A/m², about 100 A/m² to about 175 A/m², about 125 A/m² to about 150 A/m², or about 250 A/m². Additionally, if electrolysis is used in flotation (versus a settling tank) then smaller bubbles may be produced such that high-pressure slurry ablation may introduce air via the collision chamber and thus less energy is used for additional bubble formation.

The emulsion separation cyclone may comprise a de-oiling hydrocyclone. The de-oiling hydrocyclone may reduce the oil content of the incoming produced water.

Reagents may be added to the electrolytic separation tank to assist or be used in place of electrolytic separation. The reagents may be surfactants to assist in breaking of the emulsion or a wide range of organic solvents including, but not limited to, hexane, petroleum ether, chloroform, other organic solvents, or a combination thereof. The rate of addition of the reagent stream may be adjusted through use of a reagent control valve in communication with the central control system.

A level transmitter may be installed on the process tank to determine the level and report it back to a central control system. After slurry has collided in the collision chamber, some free oil may be generated by liberation from the underlying sand. The free oil may separate from the slurry based on its density and form a free oil layer above the slurry level in the process tank. The level transmitter installed in the tank may be a guided wave radar level sensor with highway addressable remote transducer (“HART”) capabilities, allowing it to determine both the level of the slurry in the process tank and the level of the free oil layer.

An adjustable weir and overflow launder system may be designed into the tank to allow for overflow and recovery of the free oil layer. The adjustable weir may be adjusted manually based on operator observation of the tank, or through a motor driven gear system that is in communication with the central control system. The central control system may command the adjustable weir to raise or lower depending on the level of the free oil layer and the level of the slurry as detected and communicated to the central control system by the level transmitter. This adjustable weir may also be raisable and lowerable through a hydraulically actuated means or other means.

A rotating paddle powered by an electric motor in communication with a variable frequency drive (“VFD”) and the central control system may also be installed to assist with scraping free oil into the overflow launder. The central control system may command the VFD on the electric motor to rotate the paddle and recover free oil at a higher or lower rate depending on the level readings from the level transmitter. The central control system may also command the VFD in communication with the collision pump to raise or lower frequency depending on the level of the free oil layer in comparison to the slurry level.

The high velocity collisions of the jets in the collision chamber may cause oil to form emulsions in the process slurry. The VFD and pump speed setting can be optimized through machine learning to recover as much free oil as possible relative to the pump speed. This system design may additionally include any of the temperature control methods and feed preparation methods as described in other systems herein.

The system may comprise a heterogeneous material and dilution water that is flown into a feed tank, creating a heterogeneous material. The heterogeneous material may then be conveyed through a conduit by at least one feed pump into a distributor. The distributor may split the flow of the heterogeneous material into one or more streams. The heterogeneous material may then flow from the distributor into a collision chamber through conduits. The collision chamber may ablate the heterogeneous material into an ablated heterogeneous material. After exiting the collision chamber, the ablated heterogeneous material may then flow into a main tank. A recirculation pump may convey the ablated heterogeneous material from the main tank through a conduit and back into the feed tank. A recirculation pump may control the heterogeneous material amount in the feed tank, leading to fewer process fluctuations as well as providing greater collision probability for particles feeding into the distributor and collision chamber. A pump may also convey the ablated heterogeneous material out of the main tank. A collision chamber may further ablate the ablated heterogeneous material. A product pump may withdraw the ablated heterogeneous material from the main tank through a conduit to be stored in a product tank.

The system may comprise a heterogeneous material that is anywhere between at least about 50%, about 70% to about 90%, about 55% to about 85%, about 60% to about 80%, about 65% to about 75%, or about 90% solids by mass. Dilution water may dilute the heterogeneous material to anywhere between at least 1%, about 1% to about 50%, about 5% to about 45%, about 10% to about 40%, about 15% to about 35%, about 20% to about 30%, or about 50% solids by mass. The diluted heterogeneous material within feed tank may then be conveyed by a feed pump in a conduit through a distributor. The conduit may connect to the distributor through its bottom to reduce space consumed and increase access to the chambers around the distributor.

The system may comprise a collision chamber, a knife gate, conduit, pressure sensors, pressure transducer, valve, nozzles, and splitter. A heterogeneous material may enter the collision chamber through a valve. The valve may split the heterogeneous material into two streams, via the splitter, which travels through conduits. The conduits may transport the heterogeneous material onto opposite ends of the knife gate, where the two streams of heterogeneous material collide as they exit the nozzles. Pressure sensors measure the pressure flow of the heterogeneous material as it goes through nozzles. Pressure transducers measure the force that the heterogeneous material exerts on surfaces in contact with it.

The system may comprise ablated heterogeneous material that flows into a distributor, where the flow is split radially between at least two collision chambers. The entering stream of heterogeneous material may be controlled with a main pump, pressure sensors, pressure transducers, conduits, and valves. The entering stream of ablated heterogeneous material may be controlled with a main pump, pressure sensors, pressure transducers, conduits, and valves. The system may comprise a collision chamber array valve to toggle between the use of or bypass chambers. At least one of valve may be closed at all times to ensure that there is a backup chamber for maintenance while in operation. A distributor may operate with at least one valve opened.

The system may comprise more than two distributors that split the flow of the heterogeneous material or ablated heterogeneous material to one or more collision chambers.

The system may comprise an about 0.25-inch to 10-inch outlet diameter and/or about 1-inch to 20-inch inlet diameter nozzle that is installed in the collision chambers around the distributor. The distributor may operate with at least one valve open.

The system may comprise a distributor that splits the flow of the heterogeneous material in any direction, e.g., radially, to at least 1, 1 to 30, 5 to 25, 10 to 20, or 30 collision chambers. The system may also comprise a distributor that splits the flow of the heterogeneous material radially to 1, 1 to 30, 5 to 25, 10 to 20, or 30 collision chambers.

The system may comprise accessing the knife gates from an upper platform. The upper platform may comprise cutaways in the grating to allow for sticking a tool through. These tools may then be used to open or close valves. In the event of conduit, chamber, or piping component rupturing and expelling heterogeneous material, this allows an operator to close the valve feeding the piping system without the operator coming into contact with the material.

The system may comprise an overflow launder. The overflow launder may allow ablated heterogeneous material to overflow into an exit and through the attached overflow launder pipe from the main tank to a draining system installed at a mill. The overflow launder may be used to dewater a heterogeneous material that enters the system at a lower percent solids by mass of less than about 40%, about 40% to about 1%, about 35% to about 5%, about 30% to about 10%, about 25% to about 15%, or about 1%. Suction from recirculation pump may be attached to the overflow launder pipe to draw water residing near the top of main tank away from the ablated heterogeneous material to return it to the mill's process water repository while solid particles will settle to the bottom of the main tank where solid particles may be drawn off by a pump and collided through collision chambers.

The system may be configured to process at least about 3.5 metric tons, about 3.5 metric tons to about 2,500 metric tons, about 5 metric tons to about 2,250 metric tons, about 10 metric tons to about 2,000 metric tons, about 50 metric tons to about 1,750 metric tons, about 100 metric tons to about 1,500 metric tons, about 250 metric tons to about 1,250 metric tons, about 500 metric tons to about 1,000 metric tons, or about 2,500 metric tons per hour in closed-circuit operation with a hydrocyclone. The system may be operated with any material including, but not limited to, graphite ore to achieve a certain P80 (80% of particles are smaller than a certain size). Particles may circulate around the system multiple times until the particle size is reduced to a desired size. As a result of the recirculation around the system, the actual throughput of the system may be higher than about 3.5 metric tons to about 100 metric tons, about 5 metric tons to about 90 metric tons, about 10 metric tons to about 80 metric tons, about 20 metric tons to about 70 metric tons, about 30 metric tons to about 60 metric tons, about 40 metric tons to about 50 metric tons, or about 100 per hour. The throughput of the system may have circulating load ratio of about 0%, about 0% to about 5,000%, about 20% to about 4,500%, about 40% to about 4,000%, about 60% to about 3,500%, about 80% to about 3,000%, about 100% to about 2,500%, about 150% to about 2,000%, about 200% to about 1,500%, about 250% to about 1,250%, about 500% to about 1000%, or about 5000%.

The system may comprise a hydrocyclone. A pump may transfer the contents of a tank into a hydrocyclone via a conduit. Overflow (“O/F”) of the hydrocyclone may be transferred to the next downstream process if the particle is small enough. Overflow may be transferred to another vessel including, but not limited to, a froth flotation bank or circuit. Underflow (“U/F”) of the hydrocyclone may comprise the coarse particles for further processing. Underflow may be transferred via a conduit to a first recirculation tank, which may be a high-pressure slurry ablation recirculation tank. The first recirculation pump and conduit may process the material through one or more high-pressure slurry ablation collision chambers, each comprising a knife gate. The conduit may be a gravity fed line between the first recirculation tank and second recirculation tank. The recirculation tank may also comprise a mechanical agitator. The mechanical agitator may achieve particle suspension.

The system may comprise streamflow through a conduit that comprises a heterogeneous material that is transported out of a second recirculation tank through a screen pump and into a dewatering screen. The dewatering screen may be a fine mesh (e.g., 325 M or 200 M) screen that allows water and some small particles to pass through into a screen undersize (“U/S”). As a result, screen oversize (“O/S”) may have a higher heterogeneous material density than the screen undersize. Dilution water may be used to control the heterogeneous material concentration in each respective tank.

The system may be operated at least about 3.5 metric tons, about 3.5 metric tons to about 2,500 metric tons, about 5 metric tons to about 2,250 metric tons, about 10 metric tons to about 2,000 metric tons, about 50 metric tons to about 1,750 metric tons, about 100 metric tons to about 1,500 metric tons, about 250 metric tons to about 1,250 metric tons, about 500 metric tons to about 1,000 metric tons, or about 2,500 metric tons per hour. Feed to the high-pressure slurry ablation unit in the first recirculation tank may be received from a hydrocyclone as underflow (“U/F”). The output of the system may be dewatered from the operating percent solids using static a dewatering screen. The system may operate at a solids percentage of at least about 1%, about 1% to about 50%, about 5% to about 45%, about 10% to about 40%, about 15% to about 35%, about 20% to about 30%, or about 50% solids with an integrated dewatering screen for recycling of process water back to the high-pressure slurry ablation unit. A sump, such as an air operated diaphragm displacement (“AODD”) sump, may also be used for the water recycling loop.

Underflow of the hydrocyclone may comprise a coarse material and may require further processing. The underflow may be combined with a low density heterogeneous material. The system recycle water and dilution water may be combined in a recycle water tank to reduce heterogeneous material density. System recycle water may be of very low heterogeneous material density. The low density heterogeneous material may be transferred by a pump from the recycle water tank to be combined with underflow. System recycle water may comprise the combined tailings of many downstream froth floatation banks. Optionally, the heterogeneous material density of system recycle water may range from less than about 1%, about 1% to about 10%, about 1% to about 9%, about 2% to about 8%, about 3% to about 7%, about 4% to about 6%, or about 10% solids. The underflow may be combined with a low density heterogeneous material and transferred via conduit to a high-pressure slurry ablation recirculation tank.

The system may comprise other types of distributors, namely, side entry linear distributors, top entry linear distributors, and top entry split linear distributors. The side entry linear distributor may be used with the discharge of a first recirculation pump. The side entry linear distributor, top entry linear distributor, and top entry split linear distributor may comprise knife gates and valves to toggle flow between two collision chambers. The side entry linear distributor, top entry linear distributor, and top entry split linear distributor may each comprise two collision chambers, one serving as an operating chamber and one as a bypass chamber. The flow may be switched between the chambers to allow them to be serviced when necessary. The side entry linear distributor may have material entering the distributor from the side via a conduit. The top entry linear distributor and top entry split linear distributor may have material entering from the top via a conduit. The top entry linear distributor may have material directly entering the top of the distributor. With the top entry split linear distributor, the material may diverge into two flows and then reconverge before being directed towards the collision chamber that is operating. The top entry option distributors may result in an even distribution of solids and liquids across the flow profile.

The system may comprise conduits with the side entry linear distributor, top entry linear distributor, and top entry split linear distributor that comprise piping crosses instead of tees when the material is split from one flow to two flows. Piping crosses may be capped on the end opposite to where the material enters the pipe fitting. This may allow solid material to accumulate in the pipe cap.

The system may comprise another distributor with either the side entry linear distributor, top entry linear distributor, or top entry split linear distributor, which may be used on the discharge of a recirculation pump. This configuration may have material feeding in through the top of the distributor body and split to at least two collision chambers. Two of these collision chambers may be normally operating, while two collision chambers are on standby (bypass) for use when chamber bypass happens.

The system may comprise a linear distributor. The linear distributor may comprise a side entry linear distributor, top entry linear distributor, and/or top entry split linear distributor.

The system may comprise a recirculation tank that is configured with a cylindrical top section and a conical bottom section; a round bottom and/or bottom; a polygonal top and/or bottom; a rectangular sump style tank comprising slopes to direct material to a collision pump; a round bottom; or a combination thereof. The recirculation tank may comprise a tapered side. The conical bottom directs all settling material in the tank to a funnel so the suction of the recirculation pump may pull it through. The angle of the conical bottom may be less than about 35 degrees, about 35 degrees to about 1 degree, about 30 degrees to about 5 degrees, about 25 degrees to about 10 degrees, about 20 degrees to about 15 degrees, or about 1 degrees, which may prevent fluctuation in solids that enter the recirculation tank. The steep conical bottom angle prevents material from accumulating and sloughing off the side of the recirculation tank. The volume of the recirculation tank may be chosen to allow suspension of material through pump recirculation. When particles reach the bottom of the recirculation tank, they may be directed towards a funnel and conveyed through a collision chamber. This may drop the material at the top of the recirculation tank. If the flow rate of a recirculation pump is high, it may reduce the effect of particle settling in the recirculation tank and allow particles to remain in a suspension without requiring a mechanical agitator or other suspension system. The suspension may be quantified by looking at the percent solids of the pump compared to the percent solids of the system (tank). The ratio of pump flow rate to tank volume may be referred to as the “tank recirculation ratio”. Recirculation ratios are tested with a similar recirculation tank between values of at least about 1, about 1 to about 3.5, about 1.5 to about 3, about 2 to about 2.5, or about 3.5. Higher tank recirculation ratios provide better suspension, but a lower recirculation ratio may provide sufficient suspension for the application. The difference between the percent solids of the pump and system plotted against tank recirculation ratio has an exponential decay relationship. The system may comprise a recirculation ratio of about 1, about 1 to about 3.5, about 1.5 to about 3, about 2 to about 2.5, or about 3.5.

The system may comprise a collector underneath a collision chamber. This allows for a high-pressure slurry ablation skid and a tank skid to exist separately and be moved into various configurations. The collector may comprise a collector outlet that allows heterogeneous material to move from the collector to a tank via a transfer line. The transfer line allows heterogeneous material to be moved from the high-pressure slurry ablation skid to tank skid. The system may comprise a fluid communication between the high-pressure slurry ablation skid and tank skid.

The system may comprise a high-pressure slurry ablation skid that is collapsable. The high-pressure slurry ablation skid may comprise a first platform, second platform, collector mounting space, locking pins and pinholes, and fork pockets. For ease of transportation and service, the high-pressure slurry ablation skid may be collapsable with locking pins and pinholes for both collapsed and raised configurations. Fork pockets may be mounted in a lower position on the base of the second platform so that a forklift may be used to raise and safely lower the second platform. The second platform may comprise a collector mounting space where a collector is located. The second platform may be raised or lowered from the first platform, and locking pins and pinholes will hold the second platform and first platform in place.

The system may comprise high-pressure slurry ablation abandoned uranium mine (“AUM”) remediation. Feed material within a conduit may enter an oversize screen where larger material is separated out and finer material is separated into a pre-cut screen. The pre-cut screen may separate fine material that is less efficiently processed by high-pressure slurry ablation while sending coarser material that is more efficiently processed by high-pressure slurry ablation into a tank. Material may be conveyed from the tank into a high-pressure slurry ablation collision chamber, which then returns to the tank. Depending on the concentration requirements of the uranium, radium-226, or other contaminants of concern, a fraction of streamflow may be split from the coarse product and recycled back to the tank. This provides more selective liberation of the contaminants and may reduce the final contaminant concentrations.

The system may comprise a high-pressure slurry ablation system applied to filter sand treatment and reuse. High-pressure slurry ablation may be used to clean the surfaces of foul sand through particle collisions to regenerate and reuse. Pre-process sand (which may be filter sand) may pass through a high-pressure slurry ablation process, which results in course clean sand and post-process sand which has fine contaminants removed. The quantities of filter sand media at each site using sand filters may be small, ranging from at least about 10, about 10 to about 1,000, about 50 to about 900, about 100 to about 800, about 200 to about 700, about 300 to about 600 or about 1,000 short tons per site.

The system may comprise pre-process sand stored in a container. Pre-process sand may travel up a conveyor and into a filter sand high-pressure slurry ablation skid to be processed. Filter sand high-pressure slurry ablation may be operated independently as a mobile processing unit for an about 5 ton per hour throughput rate. With remote sites and low volumes of material requiring treatment, filter sand high-pressure slurry ablation may be self-contained on a highway legal trailer mounted system, requiring only the associated equipment of a generator for power, a water supply from a fire hydrant, and a skid steer or other loading equipment for material loading. To provide effective cleaning of the filter sand using the filter sand high-pressure slurry ablation, a trailer may be fitted to provide a treated filter sand product of at least about 95% quartz from feed material ranging between about 60% to about 80% quartz content.

The system may comprise a filter sand trailer that processes raw feedstock removed from a filter sand tank. Feed sand may enter the filter sand high-pressure slurry ablation and be loaded by a skid steer or other loader into a vibrating feed screen. The vibrating feed screen may filter out oversize material and send it to the ground without crushing or processing.

The system may comprise a heterogeneous material. The heterogeneous material may comprise dilution water and feed sand that enters a first stage high-pressure slurry ablation tank along. The first stage high-pressure slurry ablation tank may comprise an agitator to agitate the heterogeneous material and allow material to be suspended. A pump may recirculate the heterogeneous material in first stage high-pressure slurry ablation tank to two operating chambers or a third bypass chamber with a normally closed gate valve within a collision chamber.

The system may comprise a product size separation screen. Ablated material may be conveyed by a pump into product size separation screen. Oversize material (>100-micron particle size) may be sorted out by vibrating the product size separation screen and is disposed into a cleaned product pump. The cleaned product pump may comprise a vertical Sala Pump design. Undersize material (about <100-micron particle size) from the vibrating of the product size separation screen may be disposed into a reject fines pump. The reject fines pump may comprise a vertical Sala Pump design.

The system may comprise a high-pressure slurry ablation skid that is placed in front of a rod mill with a 32″ gap for a walkway between the skid and the rod mill. A dewatering screen may sit flush against the side of the high-pressure slurry ablation skid and near a ball mill and ball mill discharge tank for gravity feeding of screen oversize. Access to the top of a screen skid and high-pressure slurry ablation skid lower and upper decks may be provided with ladders (removable for shipment). Removable rails and swing gates may be provided for operator safety when accessing these parts of the skids.

The system may further comprise a shim. The shim may adjust a nozzle on a collision chamber. The shim may compensate for collision chambers that have mounting structures that may not be completely aligned. Shims may vary from at least about 0.005″, about 0.005″ to about 5″, about 0.005″ to about 4.5″, about 0.05″ to about 4″, about 0.5″ to about 3.5″, about 1″ to about 3″, about 1.5″ to about 2.5″, or about 5″ in thickness. Shims may be placed at any location around a nozzle mounting plate.

The system may comprise an aligned collision chamber. The aligned collision chamber may comprise a body, viewing window, slim chamber nozzles, mounting bracket, and nozzle mounting adapter. Slim chamber nozzles may further comprise a piping connection flange and channel. The body may be connected to the slim chamber nozzles via a nozzle mounting adapter, which allows the user to adjust the angle of slim chamber nozzles. By changing the angle, the location of the tip of the slim chamber nozzle changes. Adjusting slim chamber nozzles allows the flow from each slim chamber nozzle to impact each other completely, and the collision point to be centered in aligned collision chamber. A viewing window may be used that allows a user to see what is happening inside of the aligned collision chamber. The aligned collision chamber may comprise a body with walls that are closer together than other chamber designs. The aligned collision chamber may comprise tab and slot components.

The system may comprise a multiple nozzle chamber. The multiple nozzle chamber may comprise a plurality of nozzles. The number of nozzles may be at least 2, 2 to 100, 5 to 95, 10 to 90, 20 to 80, 30 to 70, or 40 to 60. The multiple nozzle chamber may comprise a hexagonal, or any corresponding polyhedron shaped chamber body with straight walls. The chamber body may also be curved and/or circular. The chamber body may also be partially polyhedron shape and partially curved. Adapter spacers may be used to set both the angle and spacing of nozzles relative to each other. The multiple nozzle chamber may comprise various configurations. The multiple nozzle chamber may comprise an adapter-spacer with at least about 1 degrees, about 1 degrees to about 89 degrees, about 5 degrees to about 80 degrees, about 10 degrees to about 70 degrees, about 20 degrees to about 60 degrees, about 30 degrees to about 50 degrees, or about 89 degrees; and/or at least about 1 inch, about 1 inch to about 100 inches, about 2 inches to about 95 inches, about 5 inches to about 90 inches, about 10 inches to about 80 inches, about 20 inches to about 70 inches, about 30 inches to about 60 inches, about 40 inches to about 50 inches, or about 100 inches between nozzle outlets. The nozzles may comprise a tapered end leading to a nozzle outlet. The adapter-spacer may comprise different thicknesses.

The system may comprise blind mounting plates. Blind mounting plates may be installed to cover the excess nozzle openings.

The system may comprise removable insert nozzles. The removable insert nozzles may comprise a permanent outer shell, connection flange mounting disk, sacrificial insert, tapered surface, threads, and nozzle cap. The sacrificial insert may comprise any material, including but not limited to wear resistant materials. These materials may include, but are not limited to, hardened steel, ceramic, urethane, natural rubber, tungsten carbide, thermoplastics, or a combination thereof. The sacrificial insert may comprise a tapered surface. The nozzle cap may hold the sacrificial insert in place with threads. The nozzle cap may comprise a hardened steel or similar machinable wear resistant material.

The system may be configured to dissociate a subfraction of a heterogenous material. The system may comprise a pump including, but not limited to, an intake and/or discharge pump. The system may comprise a discharge port. The system may comprise a source of heterogeneous material. The system may comprise a mixer configured to receive a heterogeneous material. The mixer may be in communication with the source of a fluid. The system may comprise a nozzle in communication with another nozzle.

The system may comprise a splitter. The splitter may split a fluid stream into at least two streams. Alternatively, the splitter may split into any number of even streams, for example, two streams, four streams, six streams, eight streams, or a combination thereof. The splitter may be in communication with a nozzle.

The system may comprise a collision chamber array that may be configured to split a fluid stream in a plurality of fluid streams. The collision chamber array may be configured to direct the plurality of fluid streams into a plurality of individual collision chambers comprising nozzles.

The system may comprise a catch tank. The catch tank may be in communication with a pump and/or an intake of a pump. The pump may be a recirculation pump. The pump may be in communication with the splitter. The pump may be configured to discharge a fluid. The catch tank may be disposed across from the pump. The pump may be in communication with an inlet tank.

The system may comprise a modular nozzle. The modular nozzle may comprise an angled adapter, a motorized adapter, a position sensor, or a combination thereof. The modular nozzle may be configured to adjust the nozzle angle into a collision chamber. The angular adapter may be installed and/or exchanged. The angled adapter may change the angle and/or trajectory at which a fluid stream enters a collision chamber. The angled adapter may be disposed such that the angle of discharge below the horizontal may be at least about 0 degrees, about 1 degree to about 90 degrees, about 5 degrees to about 85 degrees, about 10 degrees to about 80 degrees, about 20 degrees to about 70 degrees, about 30 degrees to about 60 degrees, about 40 degrees to about 50 degrees, or about 90 degrees. The angled and/or motorized adapter may be disposed on one or more sides of the collision chamber. Each side of the collision chamber may be configured to receive a modular nozzle. The motorized adapter may comprise a motor that moves the nozzle to change the angle and/or trajectory at which a fluid stream enters a collision chamber. The position sensor may be attached to the collision array and/or nozzle and may gather positional data from the fluid stream and/or nozzle to direct a motorized adapter to change the angle of the nozzle. The angle of the nozzle may be changed by an angular and/or motorized adapter to optimize the ablation of fluid comprising a heterogeneous material. The nozzle may be spaced and may comprise a spacer. The spacer may adjust the position of the nozzle. Other adjustment techniques may be used for different processing requirements. The position sensor may be in communication with any component of the system. The m position sensor may control, regulate, modify, adjust, and/or monitor any component of the system. The position sensor may comprise a software program. The software program may employ machine learning, artificial intelligence, a neural network, an algorithm, or a combination thereof.

The system may comprise a combined collision chamber which may comprise a plurality of modular nozzles. The plurality of modular nozzles may be configured to direct a plurality of fluid streams, each comprising a heterogeneous material. The plurality of modular nozzles may be at least partially disposed in parallel to each other. The plurality of modular nozzles may be at least partially disposed in a vertical plane allowing for an inter-collision region space in between the plurality of fluid streams. The inter-collision region may provide a secondary collision of heterogeneous material. The plurality of modular nozzles may be at least partially disposed in the combined collision chamber and may be at least partially parallel to each other in the horizontal plane.

The system may comprise an inter-collision separation device. The inter-collision separation device may be at least partially disposed into or removed from the inter-collision region space to separate and/or allow for the collisions of the plurality of modular nozzles. The collision chamber array may be at least partially disposed between a plurality of catch tanks such that a first portion of the heterogeneous material may be ablated and exits the collision chamber over a first catch tank. The first catch tank may be in communication with a pump, e.g., a recirculation pump. A second portion of the heterogeneous material may be ablated and exit over a second catch tank to be held for further processing by other methods. The collision chamber array may be at least partially disposed between the plurality of catch tanks such that the degree of dissociation of material and throughput of the system may be controlled.

The system may comprise a flow dividing chute. The flow dividing chute may be at least partially positioned at the meeting point of the crests of a plurality of tanks. The flow dividing chute may at least partially divide a fluid stream either equally or unequally between the plurality of tanks.

The system may comprise a reagent. The reagent may comprise a surfactant and/or collection reagents. The reagent may promote froth separation of one or more subfractions of dissociated heterogeneous material. The system may be used to accommodate the flow of the generated froth into a collection system. The generated froth may flow to a product refining system or be rejected from the system.

The system may comprise a conduit for a pressurized fluid. A nozzle assembly may be in communication with the conduit. The nozzle assembly may comprise a plurality of adjustable nozzles. The adjustable nozzles may be configured such that fluid streams passing through each of the plurality of adjustable nozzles intersect at an oblique angle. The oblique angle may be at least about 1 degree, about 1 degrees to about 179.9 degrees, about 5 degrees to about 179 degrees, about 10 degrees to about 175 degrees, about 20 degrees to about 160 degrees, about 40 degrees to about 140 degrees, about 60 degrees to about 120 degrees, about 80 degrees to about 100 degrees, or about 179.9 degrees after passing through the plurality of adjustable nozzles. Each adjustable nozzle may be tilted in any direction up to 180 degrees.

The system may comprise monitoring and/or control equipment. The monitoring and/or control equipment may be in communication with any component of the system. The monitoring and/or control equipment may collect data and/or control any process and/or flow rate within the system. The monitoring and/or control equipment may be in communication with any component of the system. The monitoring and/or control equipment may control, regulate, modify, adjust, and/or monitor any component of the system. The monitoring and/or control equipment may comprise a software program. The software program may employ machine learning, artificial intelligence, a neural network, an algorithm, or a combination thereof.

The system may comprise a recovery tank. The system may be configured such that a plurality of modular nozzles and a plurality of recovery tanks are arranged in series. The series of recovery tanks may increase the number of particle collisions. The recovery tanks may each comprise a mechanical agitator that may maintain suspension.

The system may comprise a screen; a pump; a holding tank; and/or nozzle systems capable of being used in conjunction to process and sort particles by size throughout different points in the system; or a combination thereof. The pump may further comprise a pump impeller. The pump impeller may be oriented such that it evenly distributes the heterogeneous material into each fluid stream following through each of the fluid streams from the splitter.

The system may comprise a valve or other flow control device, wherein minor adjustments of the divided fluid streams may be made by means of the valve or the other flow control device. The valve or other flow control device may account for differences in flow characteristics of the intersecting fluid streams. Minor adjustments to the divided fluid streams may ensure proper impact of the fluid streams.

The system may further comprise a modular nozzle assembly wherein a plurality of modular nozzles are opposingly oriented over a recovery tank.

The system may comprise dissociating a subfraction of a heterogeneous material. A fluid stream comprising both a heterogeneous material and liquid transport medium, in communication with the discharge of a pump, may be split into multiple streams by a splitter. The pump may be a collision recirculation pump. The fluid stream may be split such that one or more streams are in communication with nozzles disposed in collision chambers operating in parallel. The discharge of the recirculation collision pump may be positioned such that the discharge stream of heterogeneous material and liquid may enter an open top catch tank. The discharge stream of heterogeneous material and liquid may exit over the top of a plurality of open top catch tanks.

The system may comprise a primary catch tank and a secondary catch tank. The primary catch tank may allow further ablation of ablated heterogeneous material, and the secondary catch tank may hold further ablated material for further processing by other methods.

The system may comprise a plurality of pumps to form fluid streams that converge to form a collision region with or without the use of a splitter. A stream exiting the discharge of one collision pump may be split into a plurality of fluid streams comprising heterogeneous material. The heterogenous material may be collided (ablated) with a plurality of jet streams comprising the same or different heterogeneous material. The jet streams may flow from an oppositely positioned pump or pumps. The jet stream may be split by a collision chamber array. The collision chamber array may be at least partially disposed between a plurality of catch tanks such that a portion of the heterogeneous material is ablated and exits the collision chamber over a first catch tank and another portion of the heterogeneous material is ablated and exits over a second catch. The collision chamber array may be at least partially disposed between the plurality of catch tanks such that the degree of dissociation of material and throughput of the system may be controlled.

The system may comprise surfactants and collection reagents to promote froth separation of one or more subfractions of the dissociated heterogeneous material. The system may generate froth and direct it into a collection system which may then flow to either further product refining or be rejected from the system.

The system may comprise a screen to separate the heterogeneous material into particles. The particles may be separated based on particle size, with the smaller particles separated out of the system as a product and the larger particles being processed by the fluid streams.

The system may comprise a catch tank comprising a cone bottom, flat bottom, or a combination thereof. The type of tank design may be further alternated in any order such that certain tanks in the series more selectively focus on transport of different varying particle sizes due to particle segregation resulting from tank design effects.

The system may comprise a transfer collision pump in fluid communication with a tank. Output from the transfer collision pump may or may not be in communication with either an individual chamber, collision chamber array, combined collision chamber, or combined collision chamber array.

The method for dissociating the heterogeneous material into subfractions may be controlled by altering the flowrate and slurry stream discharge characteristics of the transfer pumps between the tanks. The degree of dissociation may be regulated by altering the flowrate of a recirculation pump relative to the flowrate of the transfer pump. Use of this recirculation pump may not be necessary for certain applications. Regulating the degree of heterogeneous material dissociation may be achieved either manually or through the use of a control system.

The control system may vary the flowrate of the recirculation pump by use of a process monitoring instrument detecting properties of the heterogeneous material which may specify a higher or lower required recirculation pump flowrate or corresponding velocity of the heterogeneous material and liquid exiting the nozzle. The monitoring equipment may comprise an x-ray fluorescence scanning device or gamma radiation detector. The particle size may be monitored particle size slurry density or material or liquid or fluid flowrate of material entering a tank. The monitoring equipment may be in communication with the control system used to vary the flowrate. The control system may be in communication with any component of the system. The control system may control, regulate, modify, adjust, and/or monitor any component of the system. The control system may comprise a software program. The software program may employ machine learning, artificial intelligence, a neural network, an algorithm, or a combination thereof.

Pressure or flowrate may be monitored, and data may be relayed to the control system. The control system may direct either the pump to increase flowrate or the control valves to adjust either completely open, completely closed, or in-between to constrict flow for adjustment of this flowrate.

The outlet of the collision chamber may allow for distribution of the fluid stream exiting the collision chamber to be equally or unequally divided between a system inlet tank in fluid communication with the intake of the collision recirculation pump and a catch tank in fluid communication with either the intake of a collision recirculation pump or in fluid communication with the intake of a process draw off pump.

The method may comprise use of a control system to increase or decrease the flow through a plurality of nozzles. The method may comprise use of a hydrocyclone and/or cyclone size separation device recirculating coarse or fine material back into the system.

The method may comprise dissociating the heterogeneous material into subfractions. The method may comprise pumping heterogeneous material; receiving the heterogeneous material into a mixer, wherein the mixer is in communication with a source of fluid comprising the heterogeneous material and a liquid transport medium; directing a fluid with a nozzle; discharging the fluid; splitting the fluid into a plurality of streams; and balancing the pressure of fluid streams exiting the nozzle by collision of the fluid streams, such that the flowrate through all streams is balanced at the same flowrate. The method may further comprise using a control valve and/or process monitoring equipment including, but not limited to, a transducer in communication with a control system, to adjust the pressure or flow rate of the fluid exiting splitters. The control valve may form at least a partial opening between a splitter and a nozzle.

The method may comprise processing a heterogeneous material, the method comprising: entraining heterogeneous particles of a material into at least one fluid stream; passing at least one fluid stream through an adjustable nozzle; impacting the at least one fluid stream at an oblique angle in a range from about 1 degrees to about 89.9 degrees, about 90.1 degrees to about 179.9, about 180.1 degrees to about 269.9 degrees, about 270.1 degrees toa bout 259.9 degrees to ablate the heterogeneous particles of the material; and classifying the heterogeneous particles. Entraining the heterogeneous material into a fluid stream may comprise mixing the heterogeneous material with a fluid. The step of mixing the heterogeneous particles may comprise using a holding tank and a mechanical agitator to maintain particle suspension.

The method may comprise transporting the heterogeneous material into one or multiple mixing tanks to be mixed with water by means of a belt conveyor or other ore transportation device. The water may be removed from the heterogeneous particles by means of a dewatering filter, gravity-based separator, or other method, and the wastewater produced by this process is recycled back into the system. Wastewater may be held in a holding tank using controls to distribute the water to different processes throughout the system. Raw water may be added to the system as necessary to meet system requirements of the process due to the loss of small quantities of water from various processes in the system. Wastewater from the system may be recycled to be reused by the system.

The recovery tank may comprise a mechanical agitator that may maintain solids suspension. Any means of sedimentation suppression/mitigation may be used without limitation to agitation or recirculation pumping. Recirculation pumping may comprise use of a recirculation loop.

The system may comprise a screen, hydrocyclone and/or cyclone, pump, holding tank, and/or nozzle configured to be used in conjunction to process and sort particles by size throughout any point in the system.

Each pump may comprise a pump impeller. The pump impeller may be oriented such that the pump impeller evenly distributes the heterogeneous material into each stream. The pump may be peristaltic pump and may comprise any other method of accelerating a fluid known in the art.

The nozzle assembly may comprise a plurality of adjustable nozzles opposingly oriented over, or in proximity to, a recovery tank.

Any fluid conduit and/or valve in the system may be configured to allow flow to be activated or deactivated between collision chambers while in operation.

Any fluid conduit and/or valve in the system may be configured to facilitate gravity flow between multiple recovery tanks, and/or equalize tank levels to account for fluctuations in flow rates between a plurality of pumps.

Any part of the system or method may be operated as a batch or continuous system or method.

The heterogeneous material may comprise solid particles or a heterogeneous material of solid particles with a fluid. For example, the heterogeneous material may comprise an ore containing a metal to be recovered. The heterogeneous material may also comprise an oil-contaminated sand. The heterogeneous material may also comprise a fluid, wherein the fluid includes, but is not limited to, water; groundwater; processed water; culinary water; municipal water; distilled water; deionized water; sewage; an acid including, but not limited to, sulfuric acid, hydrochloric acid, nitric acid, or a combination thereof; a base including, but not limited to, sodium hydroxide, ammonia, or a combination thereof; an organic solvent including, but not limited to, pentane, hexane, heptane, or a combination thereof; a surfactant including, but not limited to, polyethylene glycol, polysorbate, polysorbate 80, polysorbate 20, sulfate, sodium dodecyl sulfate, cocamidopropyl betaine, decyl glucoside, alkyl polyglycoside, lauryl glucoside, sodium stearate, amine oxide, alkylbenzene sulfonate, or a combination thereof; a halide including, but not limited to, chloride ions, iodide ions, bromine ions, fluoride ions, or a combination thereof; a salt including, but not limited to, sodium chloride, calcium chloride, potassium chloride, or a combination thereof; an alcohol including, but not limited to, methanol, ethanol, isopropyl alcohol, or a combination thereof; any other aqueous solution; oil; mineral oil; or a combination thereof; a previously processed material which can be recycled or repurposed, including but not limited to electronic waste (e-waste), construction materials, alloys, aggregate, concrete, and other such materials. The liquid may comprise dissolved compounds and/or atoms including, but not limited to, carbonate, oxygen, oxide, hydroxide, or a combination thereof. The fluid may comprise substantially pure water, or water removed from a water source (e.g., an underground aquifer) without purification and without added components. The fluid may be selected to balance economic, environmental, and processing concerns (e.g., mineral solubility or disposal). The fluid may be selected to comply with environmental regulations. The fluid may be substantially free of a reagent (e.g., a leachate, an acid, an alkali, cyanide, lead nitrate, or a combination thereof.) that is formulated to chemically react with the particles in the heterogeneous material. The fluid may be contacted with the heterogeneous material at any point and/or step in the method. Optionally, the heterogeneous material may not comprise a fluid or be contacted with a fluid.

The system may comprise a hopper. The hopper may be configured to feed the heterogeneous material into a vessel. The hopper may be placed at a higher elevation than the vessel, such that the heterogeneous material flows by gravity into the vessel. The hopper may comprise a conveyor to move the heterogeneous material to the vessel including, but not limited to, an auger, tilt table, conveyor belt, or combination thereof, which may communicate with or be controlled by a computer including, but not limited to, a programmable logic controller (“PLC”), a computer processor, or a combination thereof. The computer may detect operating conditions of the system via one or more sensors (not shown) and may adjust the flow of the heterogeneous material. The computer may be in communication with any component of the system. The computer may control, regulate, modify, adjust, and/or monitor any component of the system. The computer may comprise a software program. The software program may employ machine learning, artificial intelligence, a neural network, an algorithm, or a combination thereof.

The system may comprise a nozzle. At least a portion of the heterogeneous material may be directed through the nozzle to form a stream. The nozzle may comprise a conical region comprising a constant taper from the nozzle inlet to the nozzle outlet. The diameter of the nozzle may decrease at a constant rate from the inlet to the outlet. The nozzles may comprise a lip on the inlet to allow a flange to be pressed onto the nozzle for attachment to piping. The nozzle may comprise a ridge located on the body of the nozzle to center the nozzle in the collision chamber or nozzle spacer. The diameter of a nozzle may be at least about 0.25 inches, about 0.25 inches to about 200 inches, about 0.5 inches to about 175 inches, about 1 inch to about 150 inches, about 5 inches to about 125 inches, about 25 inches to about 100 inches, about 50 inches to about 75 inches, or about 200 inches. The nozzle may comprise a material including, but not limited to, steel, urethane, hardened steel, D2 hardened steel, silicon carbide, tungsten carbide, hardfaced steel, latex, or a combination thereof. The nozzle may comprise a sacrificial node for wear measurement and predictive maintenance replacement.

The nozzle may be configured and/or disposed to direct the stream against an impact zone. The impact zone may be a region, a solid object, a solid surface, or a combination thereof. The system may also comprise a nozzle assembly, wherein the nozzle assembly comprises a body and a nozzle. The nozzle assembly may be a single unitary structure.

The stream may pass through one or more constriction zones separated by straight sections before exiting a nozzle. A nozzle assembly may comprise a plurality of channels, e.g., constriction zones. A plurality of constriction zones and straight sections may contribute to increased collimation and decreased wear of the nozzle assembly. Additional constriction zones may increase the efficiency of the system. The system may comprise a nozzle spacer. The nozzle spacer may adjust spacing between the nozzle and another nozzle and/or the spacing between the nozzle and the impact zone.

The nozzle spacers may be configured to simultaneously communicate with the collision chamber and the nozzle. The nozzle may protrude through an interior hole in the nozzle spacer. The chamber, nozzle, and spacer may be configured such that the chamber and nozzle may be used with or without the nozzle spacer.

Increasing the spacing between nozzles may increase the cross-sectional area of the jet stream just before entering the collision region. The space between the nozzles may be at least about 1 inch, about 1 inch to about 100 inches, about 5 inches to about 95 inches, about 10 inches to about 90 inches, about 20 inches to about 80 inches, about 30 inches to about 70 inches, about 40 inches to about 60 inches, or about 100 inches. This may be referred to as “jet spreading.” Jet spreading may change the behavior of the particle collisions. The behavior of the collisions may change by increasing the tangential forces on particles, which may be advantageous in certain applications.

The impact zone may be centrally positioned proximate to the nozzles (e.g., between or among a plurality of nozzles, or on a surface across a gap from a single nozzle). In a system comprising two nozzles, the impact zone may be located approximately midway between the two nozzles (i.e., if the streams have equivalent mass flow and particle distribution) but may be located anywhere between the two nozzles or in any location in which the streams may intersect. The dimensions of the impact zone may be determined by design parameters including, but not limited to, the velocity of the mixed heterogeneous material; the size and/or shape of the nozzle; the roughness of the material of the nozzle assembly; the alignment of the nozzle; the number of nozzles; the distance between the nozzles; the length and/or number of the straight sections; the composition of the streams; or a combination thereof. The impact zone may encompass the point at which the diameter of each stream is at a minimum, and the velocity of each stream is at a maximum. The dimensions of the impact zone may correspond to the concentration of energy of the streams. In the collision of tightly focused streams, particles may be more likely to impact or collide directly with other particles traveling in an opposite direction than they are in streams intersecting in a larger volume. The particles have a greater probability of colliding directly if the streams themselves impact directly (e.g., one stream is positioned at an angle of about 180° relative to another, opposing stream) or nearly directly (e.g., one stream is positioned at an oblique angle relative to another, opposing stream). For example, one stream may be positioned between about 45° and about 180° (e.g., near 180°) relative to another, opposing stream. Likewise, in the collision of a tightly focused stream with a surface, particles may be more likely to collide with the surface perpendicularly than they are in a stream tangentially intersecting a larger area of the surface. Limiting or preventing flaring of the streams as the streams leave the nozzles may control the volume or area of the impact zone. Flaring may be reduced or eliminated by methods including, but not limited to, lengthening the straight section; precision machining; reducing surface roughness; applying a shielding fluid (e.g., air, water, oil, or a combination thereof.) around the stream; or a combination thereof.

The kinetic energy of the streams may be used to separate heterogeneous materials of the particles in the streams, such as coatings or layers of the heterogeneous material overlying a core (e.g., a film, patina, varnish, oxide, or crust). For example, if the heterogeneous material (and therefore, each of the streams) comprises uranium ore and particles of sandstone, the kinetic energy of the streams may remove the light fines and/or the heavy fines from the grains. As another example, the kinetic energy may remove the silicate from the gold if the heterogeneous material comprises micro-fine gold particles having silicate patinas. As a further example, the kinetic energy may remove the oil coating from the grains of sand if the mixed heterogeneous material comprises oil-contaminated sand. Separation of heterogeneous materials may be a physical process (e.g., physical dissociation) and independent of any chemical process (e.g., chemical reaction, dissolution) of any heterogeneous materials. Heterogeneous materials may be separated with or without the addition of reagents (e.g., leachates, acids, alkalis, cyanide, lead nitrate, or a combination thereof.), and the system and method may be used to recover materials that are conventionally recovered by environmentally or operationally problematic techniques. Chemical compounds may be present in the fluids such as water in trace amounts. The system and method of the present invention may be used to separate components of a heterogeneous material from one another even when none of the materials has sufficient solubility in the liquid for chemical separation. Reagents may be contacted with the heterogeneous material to enhance dissolution of a material of interest. For example, sodium bicarbonate may be added to the stream to promote the dissolution of uranium in conjunction with the energy input within the system.

The reagent may comprise a surfactant (frother), collector, activator, depressant, pH modifier, or a combination thereof. The frother assists in the creation of a stable froth bed by inhibiting bubble coalescence and reducing surface tension and may include, but is not limited to, methyl isobutyl carbinol (“MIBC”), sodium lauryl sulfate (“SDS”), flottec F-171, pine oil, cresol acid, or a combination thereof. The collector may increase selectivity of flotation by increasing hydrophobicity of target mineral particles and may include, but is not limited to, potassium amyl xanthate (“PAX”), fuel oil, diesel, xanthate, dithiophosphate (“DTP”), or a combination thereof. The activator may assist collector adsorption onto target mineral particles, increasing recovery in concentrate and may include, but is not limited to, sodium silicate, copper sulphate, sodium hydrosulfide, sodium sulfide, or a combination thereof. The depressant may hinder collector adsorption onto gangue mineral particle surface, hindering recovery in concentrate and may include, but is not limited to, zinc sulfate, sodium dithiophosphate, lime, starch, or a combination thereof. The pH modifier may increase or decrease pH of slurry to increase flotation selectivity and may include, but is not limited to, lime, soda ash, sulfuric acid, sodium hydroxide, or a combination thereof. The dosing of the reagent may be at least about 1 gram per ton (“g/ton”), about 1 g/ton to about 1500 g/ton, about 10 g/ton to about 1250 g/ton, about 25 g/ton to about 1000 g/ton, about 50 g/ton to about 750 g/ton, about 100 g/ton to about 500 g/ton, or about 1500 g/ton.

Particles may be impacted with a lower energy, such as when a bond between two materials to be dissociated is relatively low. The impact energy may be lowered by adjusting one or more properties as described above. The impact energy may also be lowered by colliding the streams in a configuration other than directly opposing. Two or more streams may be aligned such that they intersect at an angle less than 180°, such as in the shape of the letter “V”. Such an arrangement may also direct the flow of the material after impact.

Nozzles may be disposed such that the axes of symmetry may intersect at an oblique angle. The streams passing through the nozzles may impact each other at an oblique angle (e.g., the axes of symmetry of the nozzles do not fall on the same line). The nozzle exits and the impact zone may not be collinear. For example, the streams may impact at an angle ranging from about 90° to less than about 180°. The angle to be near 180°, such that most of the kinetic energy of the streams is converted to impact energy. For example, the angle may range from at least about 160°, about 160° to about 179.9°, about 163° to about 179°, about 168° to about 176°, about 171° to about 173°, or about 179.9°. Impacting the streams at an oblique angle may result in relatively lower impact energy than a head-on impact. However, nozzles oriented directly head-on, or in a nozzle assembly having another configuration including an even number of nozzles, small perturbations in the flow of the streams may cause the flow through one or more of the nozzles to stop or clog the nozzles. This may not occur where nozzle assemblies comprise nozzles oriented obliquely to one another. Without being bound to any particular theory, where in which the streams impact each other directly head-on, a perturbation in the flow of the streams causes a shift in the location of the impact zone. The pressure in the impact zone may be higher than the pressure in the streams within the nozzles. A change in flow velocity or pressure of one stream relative to another stream, such that the streams are not balanced, may cause the impact zone to shift. The flow through that nozzle may stop if the impact zone shifts near one of the nozzles, because the pressure at the impact zone is greater than the pressure of the stream in the nozzle. When this occurs, flow through the system may be restarted by stopping and restarting the pump. However, a perturbation in the flow of one of the streams may cause movement of the impact zone but may not cause flow through any nozzle to stop when the streams impact at an oblique angle.

Wear on the exterior surface of the nozzle or on the interior of the straight section (e.g., the collimating tubes) may alter the nozzle geometry and change the efficiency of the ablation process. A non-brittle hard material may be disposed over and/or attached to at least one surface of the nozzle to protect the nozzle and straight section from wear. The non-brittle hard material may include, but is not limited to, a high-yield-strength metal resistant to abrasion (e.g., tungsten or hardened steel); a non-brittle ceramic; a diamond-impregnated ceramic; a hard-facing material; or a combination thereof. The non-brittle hard material may be a washer; a surface coating; a bonded plate; or a combination thereof. The non-brittle hard material may be attached to nozzles by an adhesive; a weld; fasteners (e.g., screws, nuts, bolts, nails, buckles, or a combination thereof.), or by any other means or combination. For example, the non-brittle hard material may comprise a tungsten washer bonded to the nozzle with epoxy.

The system may comprise of plurality of nozzles in communication with a plurality of recovery vessel combinations. A first nozzle or plurality of nozzles may dispose heterogeneous material into an impact zone to be ablated. The ablated heterogeneous material may enter the first recovery vessel. Pumps may be used to transfer ablated heterogeneous material in the form of slurry from the first recovery vessel to a second nozzle. The slurry may be recycled to the first nozzle to achieve many particle collisions to form an ablation loop. Valves or other flow regulating devices may be used to make minor adjustments to the stream of heterogeneous material. The adjustments may be made to make up for differences in flow between the nozzles due to piping geometry, losses, or any other flow differences. This system may comprise a pump to continuously remove a specified amount of material from the ablation loop for further sorting and processing.

The system may operate at a pressure of at least about 10 pounds per square inch (“psi”), about 10 psi to about 300 psi, about 25 psi to about 375 psi, about 50 psi to about 350 psi, about 75 psi to about 325 psi, about 100 psi to about 200 psi, about 125 psi to about 175 psi, about 320 psi. The flow rate through a nozzle may be at least about 5 gallons per minute (“gpm”), about 5 gpm to about 10,000 gpm, about 50 gpm to about 9,000 gpm, about 100 gpm to about 8,000 gpm, about 500 gpm to about 7,000 gpm, about 750 gpm to about 6,000 gpm, about 1,000 gpm to about 5,000 gpm, about 2,000 gpm to about 4,000 gpm, or about 10,000 gpm. The total volume of flow increases with increasing numbers of nozzles.

The system may comprise a splitter system comprising an impeller pump, stream splitter, and collision chamber. The orientation of the pump impeller may evenly distribute the heterogeneous material into each stream flowing through each of the streams from the splitter. The adjustments of the divided fluid stream may be made via a valve or other flow control device to account for differences in flow characteristics of the intersecting fluid streams. The adjustment may ensure optimal impact of the fluid streams.

The collision chamber may comprise nozzles mounted onto a plate. The plate may be attached to the collision chamber in any way including, but not limited to, by threaded fasteners, grooved coupling, compression devices, or a combination thereof. The plate may be configured to position the nozzle at an angle in the collision chamber. The angle of the nozzle may affect the angle at which a heterogeneous material stream enters the collision chamber. The plate may be interchanged with another collision chamber without modification to the plate. The plate may position the nozzle at any angle within a 180-degree arc.

The system and method may be used to process heterogeneous material having a concentration of mineral components too low for economic recovery by conventional processes. For example, waste or overburden from other processing operations may be processed using ablation. A heterogeneous material may be treated by ablation to aid in environmental remediation, such as by lowering the concentration of chemical species in material previously mined. For example, the system and method may be used for remediation of contaminated land near mines no longer operating. In such embodiments, the goal may be clean-up of a site. The material of interest recovered may be disposed of, sold, or further processed. The amount of the material of interest being disposed of may be less than the total amount of the heterogeneous material initially contaminated.

Transfer of the heterogeneous material, slurry, and/or water within the system may be performed by centrifugal pump, peristaltic pump, diaphragm pump, other pump or transportation device, or a combination thereof. The elements of the system such as piping, valves, connections, control systems, monitoring devices, wiring, and all other hardware may be varied by individual components, as known by a person skilled in the art.

The heterogeneous material may comprise carbonaceous matter. Carbonaceous matter may be contacted with the heterogeneous material. Any suitable carbonaceous matter may be contacted with the heterogeneous material. For example, suitable carbonaceous matter may be insoluble, fully soluble, or partially soluble. The carbonaceous matter may be agglomerated with the heterogeneous material, such that particles or chunks may not exist as discrete particles or chunks but would, for example, be agglomerated together into a mass. The carbonaceous matter may comprise carbon black; carbon black particles; activated carbon; graphite; carbon anode scrap; charcoal; coal; solid organic carbon; carbon naturally present in the heterogeneous material; or a combination thereof. The dosage and particle size of the carbonaceous matter may be any suitable dosage and particle size.

The heterogeneous material may comprise a surfactant. The surfactant may be contacted with the heterogeneous material. The surfactant may include, but is not limited to, an anionic surfactant, cationic surfactant, zwitterionic surfactant, nonionic surfactant, or a combination thereof. The surfactant may cause at least a portion of the heterogeneous material to become hydrophobic and be separated from the remaining heterogeneous material by flotation.

The system may comprise an analytical instrument. The analytic instrument may include, but is not limited to, an X-ray emitter and/or detection; X-ray fluorometer; X-ray chromatograph; fluorometer; gamma radiation emitter and/or detector; turbidity meter; pH meter; ion meter; laser particle analyzer; colorimeter; pressure meter; voltage meter; nuclear magnetic resonance spectrometer; high-performance liquid chromatograph; gas chromatograph; mass spectrometer; inductively coupled mass spectrometer; inductively coupled plasma-optical emission spectrometer; oximeter; density meter; pressure transducer; or a combination thereof. The analytical instruments may be controlled by the computer including, but not limited to, a PLC, processor, or a combination thereof. The computer may use data from the analytical instruments to calculate a mass balance in real time. The computed mass balance may be used in the control mechanism of the system including, but not limited to, quality control, maintenance, accounting, or combination thereof. For example, the computer may track the amount of material processed in the system or the amount of a selected material produced. The computer and/or analytical instrument may be in communication with any component of the system. The computer and/or analytical instrument may control, regulate, modify, adjust, and/or monitor any component of the system. The computer and/or analytical instrument may comprise a software program. The software program may employ machine learning, artificial intelligence, a neural network, an algorithm, or a combination thereof.

The method may comprise applying an analytical instrument, measurement, or method to the system and/or heterogeneous material. The analytic instrument may measure gamma radiation; X-ray radiation; other radiation; gas content, emission, and/or composition; fluid content, emission, and/or composition; solids content and/or composition; ion concentration including, but not limited to, carbonate, bicarbonate, oxide, or hydroxide concentrations, or a combination thereof; particle size and/or particle size distribution; pH; or a combination thereof. A radiation measurement may be used to determine the concentrations of isotopes of a heterogeneous material and/or material of interest.

Heterogeneous material may be processed with the system and according to the method described herein. Heterogeneous material may be crushed and/or screened to remove particles larger than a selected size, such as particles that are too large to be effectively processed in the system. For example, particles larger than about 0.25 inches (larger than about 6.35 millimeters) may be removed. A heterogeneous material may comprise at least about 5%, about 5% to about 35%, about 10% to about 30%, about 15% to about 25%, or about 35% or more of particles larger than about 0.25 inches (larger than about 6.35 millimeters) upon crushing. Heterogeneous material particles larger than about 0.25 inches that have been mechanically crushed may not contain a material of interest. Therefore, these particles need not be processed and may instead be discarded as barren waste and/or used to reclaim mines.

Optionally, the method may not comprise a screening and/or crushing step. Heterogeneous material comprising solid feedstock may be within size requirements of the system before entering the system. For example, oil-contaminated sand or silicate-coated gold may not require screening and/or crushing because the grains of these heterogeneous materials may all be within, or be substantially within, a range of sizes that may pass through the system.

The method may comprise contacting the heterogeneous material with a fluid to form a slurry. The slurry may be formed in a tank. The heterogeneous material may be contacted with the fluid before adding the heterogeneous material to the system. For example, the heterogeneous material may be an ore from an underground formation and the ore may be extracted by borehole mining. In borehole mining, the ore may be extracted from the formation by a high-pressure water jet, and may be carried to the earth's surface by the fluid. The contacting of the heterogeneous material (e.g., ore) with the fluid (e.g., water) occurs in the underground formation. The slurry may comprise any ratio of solids-to-liquids as long as the system is capable of flowing the slurry to an impact zone. The slurry may comprise from at least about 5%, about 5% to about 65%, about 10% to about 60%, about 15% to about 55%, about 20% to about 50%, about 25% to about 45%, about 30% to about 40%, or about 65% solids by mass.

The slurry that has been processed through the nozzle may be processed to separate particles by size. For example, the slurry may be passed through a size sorting apparatus to separate particles larger than the mesh size of the screen from particles smaller than the mesh size of the screen. For example, the particles of the slurry may be separated into grains larger than at least about 0.004 inches (0.10 millimeters) and fines smaller than at least about 0.004 inches (0.10 millimeters) by appropriately selecting the mesh size of the screen. A plurality of separations may be performed, such as by passing at least a portion of the slurry through a plurality of screens in series. Different size classifications may be selected by selecting one or more appropriate size sorting apparatuses.

The method may comprise removing water from the slurry by a dewatering method including, but not limited to, a dewatering filter, gravity-based separator, or a combination thereof. The waste fluid produced by this process may be recycled back into the system. The waste fluid may be held in a holding vessel in communication with controls, e.g., pumps, conduits, or a combination thereof., to distribute the water to different processes throughout the system. Fluid may be added to the system as necessary to meet system requirements of the process due to the loss of small quantities of fluid from processes in the system.

The system may comprise a recovery vessel comprising mechanical agitators to maintain suspension of a heterogeneous material. The system may also comprise a holding vessel and a mechanical agitator to maintain heterogeneous material particle suspension.

The system and method may separate particles with different compositions having approximately the same size where separation by size classification may be difficult or expensive. The system may comprise a plurality of screens, pumps, holding vessels, and nozzle systems, or a combination thereof to process and sort particles by size throughout different points in the system. The method may comprise separating particles based on particle size, with the smaller particles separated out of the system as a product and the larger particles being processed by a fluid stream.

For example, metal-rich fines may have similar sizes as non-bearing or metal-depleted fines formed from ablation of heterogeneous material from a single formation. The fines may be light or heavy fines. Light and heavy fines may require different techniques to recover a metal. The fines may be gravimetrically separated to reduce the amount of heterogeneous material that must be processed by other means (e.g., chemically) to extract the metal. The fines may be at least partially disposed in a vertical column of a first fluid. A second fluid may flow upward through the column so as to generate a turbulent flow rate. The fluid may include, but is not limited to, water, mineral oil, an organic solvent, air, a noble gas, or a combination thereof. The first fluid may be selected based on its flow properties, availability, and minimal environmental impact. The fines may be separated in the column by their densities, with heavier fines dropping to the bottom, and lighter fines rising to the top. Gravimetric separation may be performed in one or more stages, with different stages having different densities at which the separation occurs. Gravimetric separation parameters may affect the separation including, but not limited to, the type of fluid used; the temperature of the separation; the flow rate of the separation; the length and diameter of the column; or a combination thereof.

The system may be configured to ablate and sort heterogeneous material by particle size. The system may comprise a mixing vessel comprising a mechanical agitator. The mechanical agitator may mix anhydrous and/or dry heterogeneous material with a fluid. The mixing vessel may be fed by a transport conduit including, but not limited to, a conveyor, auger, or another ore transportation system. The system may comprise a screen that sorts heterogeneous material particles based on size, with undersized particles being separated out before an ablation loop. Larger particles may be transferred into a particle holding vessel and may then be transferred to the first recovery vessel.

The system may comprise a plurality of monitoring and control equipment in communication with any element of the system. The monitoring and control equipment may collect data and control the processes and flow rates within the system.

The heterogeneous material removed from the ablation loop may be processed through a size sorting apparatus including, but not limited to, a screen, filter, sieve, mesh membrane, or a combination thereof. The sorting apparatus may sort oversized particles, to be transported to particle holding vessel. The particle holding vessel may comprise a pump to transport the oversized particles into a dewatering filter or other dewatering system. The solids from this filter may be removed and/or rejected. The water from this dewatering system may be recycled into a recycled water vessel. The undersized particles removed from the screen after the ablation loop may be further processed using a clarifier or other percent solids concentration system.

The method may comprise borehole mining. The borehole mine may provide the heterogeneous material to be processed by the system and according to the method of the present invention. The use of borehole mining in conjunction with the system may provide operational, environmental, and other advantages. For example, borehole mining may be used to extract minerals from unbounded deposits, deposits located above the water table, shallow deposits with insufficient hydrologic permeability, deposits in impermeable rock formations, or small deposits of minerals that may not be economically, technically, or lawfully recoverable by conventional methods. Borehole mining may be performed in independent wells that may or may not be connected to other wells in a mining field. A single well may be used to penetrate a formation, scour heterogeneous material from the formation to form a slurry, carry the scoured heterogeneous material to the surface, and return barren fractions of processed heterogeneous material to the formation. Borehole mining may allow extraction of minerals with a reduced surface footprint in comparison to conventional methods.

Borehole mining is a technique for extracting mineral deposits from an underground formation. A borehole may be drilled to a given depth. A casing may be inserted into a portion of the borehole. A borehole mining tool may be inserted into the borehole, and water may be pumped into the tool to produce a high-pressure water jet. The water jet may scour ore or other raw material from the formation to form a raw slurry, and the mined ore or raw material may be carried to the surface.

Borehole mining may enable the removal of heterogeneous material without removing the heterogeneous material by injecting a leachate or lixiviant into a formation. In borehole mining, water jets may physically remove heterogeneous material without chemically mobilizing or dissolving metals, limiting the risk of aquifer contamination. A water jet may operate without modifying formation chemistry and without additional reagent costs. Borehole mining may begin with less information known about the formation because the heterogeneous material of the formation is extracted, rather than processed in-situ. Geochemical classification and permeability of the formation may not be necessary to perform a borehole mining operation because borehole mining may not rely on chemical reaction or on permeation.

Borehole mining may be used to scour heterogeneous material from a volume of an underground formation. The volume may be wedge-shaped. The extent of the volume may be tailored by controlling the direction, location, and intensity of the water jets. Borehole mining may be used to asymmetrically scour the formation, roughly following formation boundaries. The heterogeneous material from the volume may be extracted and processed. The volume may then be refilled, such as with barren waste or fill and, optionally, a cementing material. Additional volumes may be excavated by a water jet and may be excavated from a well from which heterogeneous material have previously been excavated and/or refilled. The refilled volumes may provide structural support for volumes excavated after an initial excavation. Reinjection of the barren waste may reduce surface disturbance and reclamation requirements. The system may comprise a surge tank to regulate the flow of heterogeneous material to the system when used in conjunction with borehole mining.

The system and method may also be used to process feedstocks from other types of mining operations, such as open-pit mining or underground mining. In such operations, heterogeneous material may be mined conventionally and processed by ablation, for example, near the mine. The barren waste may be returned to the mine, leaving a small bearing fraction. The bearing fraction may be transported elsewhere for further processing. Transportation costs may be reduced compared to conventional mining by separating the heterogeneous material according the system and method near the mine.

Fluid used in the apparatus and method may undergo a dewatering process. Fluid may be processed, added, or removed by filtration, nanofiltration, ion exchange, countercurrent ion exchange, forward osmosis, reverse osmosis, electrodialysis, evaporation, or a combination thereof. The dewatering process may reduce or increase fluid concentration and/or remove an impurity and/or a residual from the fluid. The dewatering process may enable recycling of the fluid.

The system may comprise a dewatering system. The dewatering system may comprise one or more elements for concentration and/or dewatering a solution and/or slurry comprising the heterogeneous material or the material of interest. The dewatering system may comprise a pre-ablation loop screen; a post-ablation loop screen; a gravity-based separator (e.g., a clarifier); a dewatering filter; a recycling vessel that may receive recycled water and/or recycled solution produced from the dewatering system, or a combination thereof. The method may comprise recycling fluid from any process within the system.

The recycled water and/or recycled solution disposed in the recycling vessel may be flowed to supply water to any of the elements which require water and/or solution in the system. These elements may include, but are not limited to, a mixing vessel for dry heterogeneous material; a screen; an ablation loop; a slurry holding vessel; or a combination thereof. The recycling vessel may be replenished by flowing water and/or solution into the recycling vessel.

The method may be a batch process such that a discrete amount of heterogeneous material is processed. The method may be a continuous process such that a continuous stream of heterogeneous material flows through the system.

The method may be used to liberate a first heterogeneous material component from a second heterogeneous material component. The first or second component may comprise the material of interest.

There may be a plurality of systems. The plurality of systems may operate in parallel. Operating the plurality of systems in parallel may ablate more than one heterogeneous material than a single system to produce more than one material of interest. The plurality of systems may operate in series. Operating the plurality of systems in series may improve the refinement and/or concentration of the material of interest compared to operating a single system. The system and method may be configured to be used in combination with another system to achieve operation in series. For example, a heterogeneous material (e.g., ore from a mining operation) may be processed in a first ablation system. After ablation in the first system, ablated heterogeneous material may be processed in a second system for further ablation. The ablated heterogeneous material leaving the first system may be tested to determine whether subsequent processing is necessary or desirable. The material may be processed through as many systems as necessary to achieve desired material properties. The flow of material through a system may be varied during operations. For example, during a mining operation, heterogeneous material properties may vary widely within a formation. Some materials may be profitably processed through a single ablation system, whereas other materials may be profitably processed through two or more systems in series. The flow of materials through a plurality of systems may be varied during mining operations in response to changes in materials to be processed.

The heterogenous material may comprise a contaminant, wherein the contaminant may comprise Uranium, Radium-226, or other contaminant. The contaminant may be disposed on the heterogeneous material in the form of a coating. The contaminant may comprise a Moh's hardness value distinct from the Moh's hardness value of the heterogeneous material. For example, the Moh's hardness value of the contaminant may be lower than the Moh's hardness value of the heterogeneous material.

The kinetic energy of the streams may be used to separate heterogenous materials of the particles of the stream, such as coatings or layers of contaminant disposed on the heterogenous material. For example, if the heterogenous material (and therefore, each of the streams) comprises contaminant coating and particles of heterogenous material, the kinetic energy of the streams may break off the contaminant coating from the heterogenous material through a grain-boundary fracture, inter-granular fracture, or phase boundary fracture.

The method may comprise steps of screening the heterogeneous material to remove particles of selected size from the heterogenous material using a screen. The screen may comprise a mesh of at least about 635 mesh, about 635 mesh to about 400 mesh, about 400 mesh to about 25 mesh, about 25 mesh to about 4 mesh, about 4 mesh to about ¼ in. mesh, or about ¼ in. mesh. For example, the larger particles remaining after the screening steps may be introduced into the ablation portion of the system to increase efficiency and throughput due to higher kinetic energy of larger particles when undergoing collisions. Alternatively, the screening steps may comprise the isolation of larger particles prior to introduction into the ablation portion of the system to be discarded as barren waste and/or used to reclaim mine.

The method may comprise a crushing step wherein the larger particles are crushed to form smaller particles prior to introduction into the ablation portion of the system.

The system and method may separate particles by size. The system may comprise a plurality of screens, hydrocyclones, pumps, crushers, holding vessels, and nozzle systems, or a combination thereof to process and sort particles by size throughout different points in the system. The method may comprise separating particles based on particle size, with the smaller particles separated out of the system and the larger particles being processed by a fluid stream.

The system may comprise a camera for determination of particle fracture when propelled by an air jet into a collision box. The camera may be a high-speed camera. The system may comprise a gas tank in fluid communication with a solenoid valve that may be controlled by a programmable logic controller. The gas tank my hold and may provide compressed air. The system may comprise a feeder and a conduit (e.g. a barrel) where feed material may be deposited into the feeder. As feed material funnels through the feeder, compressed air may be passed through the solenoid valve into the feeder and the conduit. Compressed air may transport feed material through the conduit and into a collision box. Feed material may be collided onto a collision plate installed inside the collision box, generating collided material.

The system may comprise a collision box. The collision box may comprise of, but is not limited to, steel, acrylic, or a combination thereof to allow observation of the particle collisions within the collision box. The collision box may comprise acrylic windows to allow for the camera to be positioned outside of collision box. The camera may be positioned inside of the collision box. The camera may take images or videos of particles of feed material travelling through the collision box to determine the particle velocities prior to the particle-to-plate collisions at the collision plate. The camera may also be used to measure the deflection of the collision plate when the collision plate is affixed to a spring that is further affixed to the collision box. Image analysis of the deflection of the collision plate or the compression of the spring attachment may be used to estimate the force of the collisions of the heterogeneous material with the collision plate. The collision plate may be attached to a load cell or other instrument capable of transmitting the force registered by the particles colliding with the collision plate.

The system may operate for batch testing of an individual particle or particles. The collision box may comprise a collision box exit. The collision box exit may be opened to discharge collided material to a collection tank for storage and analysis of the daughter particles produced by the particle-to-plate collisions.

The system may run while continuously loading feed material into the feeder. The collision box may be in fluid communication with one or more cyclones to separate material into various daughter particle size fractions. Driven by the pressure of compressed air entering the collision box through the conduit, collided material may exit the collision box and enter a first cyclone where coarse particles are separated from fine particles. Fine particles may convey out of the first cyclone and into a second cyclone. The second cyclone may separate fine particles into finer particles and ultrafine particles. Coarse particles and finer particles may be collected from the outlets of the first cyclone and second cyclone, respectively. Ultrafine particles generated by the particle-to-plate collisions may be collected in an air filter, which may be connected to the second cyclone.

A programmable logic controller may be programmed to control the amount of air released from the gas tank to result in various ranges of particle velocities propelled through the conduit into the collision box.

The collision plate may be removed from the system and replaced with a second conduit propelling particles into the collision box to more accurately approximate the particle-to-particle collisions observed in a high-pressure slurry ablation system.

The system may comprise an adjustable collision chamber which may be used in a high-pressure slurry ablation system where the nozzle process connections may be in fluid communication with upstream process hoses comprising heterogenous material in slurry form. The collision chamber may comprise a collision box and one or more nozzle assemblies. The nozzle assemblies may comprise a nozzle process connection, nozzle vice, corrugated rubber, nozzle, nozzle angle adjustment system, hinge, and nozzle distance adjustment system. The collision box may comprise a collision box exit. The nozzle angle adjustment system and nozzle distance adjustment system may comprise a plurality of motors, gears, and/or teeth. The collision box exit may be placed over the top of a process tank to allow collided material discharge from the system into a high-pressure slurry ablation catch tank. The collision chamber may comprise one or more nozzle assemblies where one or more nozzles comprise jet streams of heterogeneous material that are directed towards a single region for collision within the collision box.

The collision chamber may comprise a collision box with entrances on the sides for nozzles to be attached to the collision box by corrugated rubber allowing flexibility in the motion of nozzle assemblies into and out of the collision box as well as rotation in the vertical plane to adjust the angle of nozzle jets into the collision box. The nozzles may be held in place by a nozzle vice which may be attached to a nozzle angle adjustment system with a gear system on one end and a hinge on the opposite end. The hinge may be attached to a nozzle distance adjustment system and a gear system. When a motor in the nozzle angle adjustment system and nozzle distance adjustment system is operated, it may move nozzles into and out of the collision box, adjusting the distance between the outlets of the nozzles.

The collision chamber may be adjusted in real time using a central control system in communication with the nozzle angle adjustment system and gear systems as well as the nozzle distance adjustment system and gear systems. Nozzle angles may be measured by inclinometers affixed to the nozzle vices. Adjustment of the collision chamber may be done to achieve better collision region balance between the two jet streams entering the collision box. This can be done visually if the collision box is comprised of acrylic or some other transparent material sturdy enough to withstand collision forces or it can be done by including load cells underneath the collision box exit to determine if flow of ablated heterogeneous material exiting the collision region is more concentrated on one side of the collision box.

The system may comprise a multi-hole and/or shaped-hole nozzle. The multi-hole and/or shaped-hole nozzle may comprise nozzle orifices that are not circular or comprise multiple nozzle orifices on a single nozzle. The multi-hole and/or shaped-hole nozzle orifice shapes may include, but are not limited to circular, plus-shaped, triangular, slotted, elliptical, or a combination thereof. The multi-hole and/or shaped-hole nozzle may comprise orifices of any shape and may include any number of nozzle orifices in any specific orientation and pattern. The multi-hole and/or shaped-hole nozzle orifices may include, but are not limited to, a single orifice nozzle; a double orifice nozzle; a triple orifice nozzle; a quadruple orifice nozzle; a quintuple cross orifice nozzle; a quintuple pentagonal orifice nozzle; a plus orifice nozzle; a rounded plus orifice nozzle; a triangular orifice nozzle; a slotted orifice nozzle; an elliptical orifice nozzle; a double slot orifice nozzle, or a combination thereof. The single orifice nozzle may direct fluid through only a single nozzle orifice. As multi-hole and/or shaped-hole nozzle throughput increases and total nozzle pressure is maintained, multi-hole and/or shaped-hole nozzle orifice patterns and sizes may be varied to overcome particle velocity losses associated with the single orifice nozzle. The multi-hole and/or shaped-hole nozzle orifice shape, size, and/or quantity may be varied to maintain a slurry flowrate through the nozzle at the same pressure. An equivalent nozzle orifice exit area may be achieved by changing the number of nozzle orifices on a single nozzle, such as the double orifice nozzle, triple orifice nozzle, and the rest of the nozzles with multiple orifices (i.e., quadruple orifice nozzles, quintuple cross orifice nozzles, quintuple pentagonal orifice nozzles, double slot orifice nozzles, or a combination thereof).

The total orifice cross-sectional area of each multi-hole and/or shaped-hole nozzle orifice orientation may be made equivalent. The multi-orifice nozzles may be used to achieve the same cross-sectional area as a single orifice nozzle while maintaining smaller individual orifice diameters. This may generate a smaller diameter fluid streams while maintaining a larger total cross-sectional area to allow for a higher fluid flow rate in a single collision chamber or nozzle set. A multi-hole and/or shaped-hole nozzle may comprise of one to five or more uniform nozzle orifices. Alternatively, the multi-hole and/or shaped-hole nozzle orifices may be nonuniform, in which each orifice is not the same shape and/or size as the other orifices on the same nozzle.

The multi-hole and/or shaped-hole nozzle may comprise nozzle orifices with irregular shapes, including but not limited to, the plus orifice nozzle, the rounded plus orifice nozzle, the triangular orifice nozzle, or a combination thereof. The irregularly shaped multi-hole and/or shaped-hole nozzle may form a stream with a larger surface area than a circular orifice with the same cross-sectional area. The large surface area allows fluid to more effectively evacuate the collision region, reducing the particle velocity loss in the collision region. Multi-hole and/or shaped-hole nozzle orifice shapes may be optimized for specific purposes when used in specific applications, particle sizes, and/or materials.

The multi-hole and/or shaped-hole nozzle may comprise a nozzle orifice with oblong shapes, including but not limited to, the slotted orifice nozzle, the elliptical orifice nozzle, the double slot orifice nozzle, or a combination thereof. The slotted orifice nozzle may maintain the same cross-sectional area as a single orifice nozzle due to a shorter stream height and a longer stream width. Alternatively, the slotted orifice nozzle may be operated in a configuration in which stream height is longer than stream width. The slotted orifice nozzle, elliptical orifice nozzle, and double slot orifice nozzle may allow for a smaller effective diameter, causing the collision region to behave similarly to a small diameter single orifice nozzle but have the benefits of a larger outlet area.

The multi-hole and/or shaped-hole nozzle may comprise a mounting plate alignment hole. The mounting plate alignment hole ensures that the orientation of the asymmetric nozzle faces is correct when the nozzle mounting plate is installed. The nozzle mounting plate may comprise a second mounting plate alignment hole. During assembly, a precision machined dowel pin may be inserted through the two mounting plate alignment holes to maintain the angular alignment of the nozzle mounting plate with respect to the orientation of the nozzle orifice orientation and nozzle mounting plate bolt pattern.

The multi-hole and/or shaped-hole nozzle may comprise a double orifice nozzle. The double orifice nozzle may comprise nozzle orifices, a nozzle mounting plate, a grooved end fitting, a lifting strap groove, a mounting hole chamfer, a straight section, a primary taper, and a secondary taper. To avoid issues of excessive heat input into the double orifice nozzle or nozzle mounting plate that may occur during the welding process, the nozzle mounting plate may comprise a press-fit nozzle mounting plate. The double orifice nozzle may further comprise a machined lifting strap groove. The lifting strap groove allows a small lifting strap to fit into the groove to be easily picked up with a small crane, such as a jib crane. The taper may be varied. The varied taper may reduce wear.

To taper the double orifice nozzle, a primary taper and secondary taper may be used. The primary taper is substantially constant across the entire circumference of the double orifice nozzle. The secondary taper may be present on the walls adjacent to the nozzle orifices. Since the transition between a single straight taper and two streams may require a flat section on the nozzle internal geometry, the secondary taper may be used to ensure that the change in cross-sectional area throughout the axial length of the double orifice nozzle remains gradual. Rapid changes in the cross-sectional area can cause issues related to wear, cavitation, or clogging.

The multi-hole and/or shaped-hole nozzle may comprise a mounting hole chamfer on the nozzle mounting plate. The mounting hole chamfer allows the nozzle mounting plate to be fastened to a collision chamber with the use of a conical nut. The conical nut may have same chamfer angle as the mounting hole chamfer, allowing the nozzle mounting plate to center itself on a collision chamber mounting stud. Centering the nozzle mounting plate on a collision chamber mounting stud may enable consistent mounting location on the collision chamber during nozzle installation.

The system may comprise piping upstream of a nozzle that forces particle segregation. Mixed flow may be a slurry comprising particles of varying sizes and water. Mixed flow may comprise of coarse particles and fine particles that are randomly distributed throughout the pipe. As the mixed flow enters a settling chamber, slurry velocity decreases. Particles may drop out of suspension due to gravity. The coarse particles may settle more rapidly than the fine particles, causing sorting of particles within the cross section of the flow. While the coarsest particles concentrate towards the bottom of the pipe, progressively finer particles concentrate above the coarsest particles. The finest particles may stay in suspension due to low settling rates. The flow may become a segregated flow in the settling chamber. Downstream of the settling chamber may be a nozzle with an eccentric taper. The eccentric taper may be gradual enough to reduce fluid mixing and turbulence. Mixing and turbulence may homogenize the particles in the flow and causes a mixed flow.

The segregated flow may collide with another segregated flow in a mirrored orientation with respect to the nozzle outlet. The mirrored orientation may cause high-pressure slurry ablation particle collisions between the particles in each segregated flow. The segregated flow increases the probability of particle collisions between similarly sized particles, which decreases the probability of non-significant collisions between particles of mismatched size. Non-significant collisions may not contribute to particle liberation or breakage. Additionally, the nozzle may be non-circular to continue to encourage maintenance of the particle segregation as the particles exit the nozzle.

The system may alter the viscosity of the heterogeneous material. The system may decrease the viscosity of the heterogeneous material by increasing the temperature and/or applying surface shear stress (i.e., ablation) to the heterogeneous material. The system may perform lump ablation and add fluid to the heterogenous material to reduce the density of the heterogenous material. The system may ablate smaller oil sand lumps more rapidly than larger oil sand lumps.

The collision chamber may produce and/or maintain a jet velocity at least about 1 meter per second (“m/s”), about 1 m/s to about 100 m/s, about 2 m/s to about 90 m/s, about 5 m/s to about 50 m/s, about 10 m/s to about 40 m/s, about 20 m/s to about 30 m/s, or about 50 m/s.

The temperature of the heterogeneous material may be at least about −5° C., about −5° C. to about 60° C., about 0° C. to about 55° C., about 5° C. to about 50° C., about 10° C. to about 45° C., about 15° C. to about 40° C., about 20° C. to about 35° C., about 25° C. to about 30° C., or about 60° C. Increasing the temperature of the heterogeneous material may increase the rate of ablation.

The collision chamber may increase the temperature of the heterogeneous material by at least about 1° C., about 1° C. to about 20° C., about 2° C. to about 18° C., about 4° C. to about 16° C., about 6° C. to about 14° C., about 8° C. to about 12° C., or about 20° C. The increase in temperate may result in higher surface shear stress being applied to the heterogeneous material.

The heterogeneous material may flow through any part of the system at a velocity of at least about 1 m/s, about 1 m/s to about 10 m/s, about 2 m/s to about 9 m/s, about 3 m/s to about 8 m/s, about 4 m/s to about 7 m/s, about 5 m/s to about 6 m/s, or about 10 m/s. The heterogeneous material may be broken down by mechanical shear as it flows through the system. For example bitumen may be liberated from bituminous lumps as it passes through the system.

The heterogeneous material may be contacted with a hot medium. The hot medium may include, but not limited to, water, an aqueous solution, an aqueous heterogeneous material, or a combination thereof. The viscosity of the heterogeneous material may be reduced as it passed through the system due to contact with the hot medium. The heterogeneous material may be ablated by both heat transfer from the hot medium and by mechanical energy from the collision chamber.

The system may comprise a plurality of pumps in communication with one or more collision chamber. A single collision chamber may be in communication with one or more pumps. The plurality of pumps may convey heterogeneous material into one or more collision chambers.

The system may comprise a baffle. The baffle may disposed within any component of the system including, but not limited to, a vessel, cavity, conduit, tank, collision chamber, collision array, or combination thereof. The baffle may regulate, deflect, and/or control the passage of fluid and/or heterogenous material within the system.

The system may comprise a sieve and/or filter at least partially disposed between a collision chamber and a vessel. The sieve and/or filter may comprise a plurality of different pore sizes through which ablated material of different sizes may pass. For example, a portion of the sieve and/or filter may have a porosity of 15% and another portion may have a porosity of 60%. Each sieve and/or filter may be disposed above a section of vessel comprising a baffle such that ablated heterogenous material of a given porosity passes through a section of the sieve and/or filter with higher or lower porosity. For example, course ablated heterogenous material may pass through a portion of the sieve and/or filter with 60% porosity, while fine ablated heterogenous material may pass through a portion of the sieve and/or filter with 15% porosity. The baffle of the vessel may form separate regions in the vessel to separate courser ablated heterogenous material from finer ablated heterogenous material. For example, the baffle may separate course ablated heterogenous material passing through the portion of the sieve and/or filter with 60% porosity from fine ablated heterogenous material passing through the portion of the sieve and/or filter with 15% porosity.

The system may comprise a programmable logic controller (“PLC”), computer processor, digital processing unit, or a combination thereof. The PLC, computer processor, digital processing unit, or a combination thereof may be in communication with any component of the system. The PLC, computer processor, digital processing unit, or a combination thereof may control, regulate, modify, adjust, and/or monitor any component of the system. The PLC, computer processor, digital processing unit, or a combination thereof may comprise a software program. The software program may employ machine learning, artificial intelligence, a neural network, an algorithm, or a combination thereof.

The system may further comprise a transmitter for transmitting data from the system to a server. The system may further comprise a hard drive that stores data from the system. The data may include, but is not limited to, data related to the wear, integrity, performance, and/or operation of the system including, but not limited to, a flow rate, temperature, density, viscosity, pH, yield, or a combination thereof. The system may further comprise a graphical user interface. The graphical user interface may be in communication with any component of the system.

Embodiments of the present invention provide a technology-based solution that overcomes existing problems with the current state of the art in a technical way to satisfy an existing problem for operators generating product waste from heterogeneous material. Embodiments of the present invention achieve important benefits over the current state of the art, such as reduced waste, increased production time, and faster refinement times. Some of the unconventional steps of embodiments of the present invention include improved ablation and re-ablation of heterogeneous materials.

The terms, “a”, “an”, “the”, and “said” mean “one or more” unless context explicitly dictates otherwise. The term “and/or” as used herein means that the listed items are present, or used, individually or in combination. In effect, this term means that “at least one of” or “one or more” of the listed items is present or used.

Note that in the specification and claims, “about” means within twenty percent (20%) of the amount, value, or condition given.

Terms of degree such as “substantially” and “approximately” as used herein mean a reasonable amount of deviation of the modified term such that the end result is not significantly changed. These terms of degree should be construed as including a deviation of at least ±5% of the modified term if this deviation would not negate the meaning of the term it modifies.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for liberating and processing a heterogenous material, said method comprising:
passing the heterogeneous material into a high-pressure slurry ablation system comprising a collision chamber and a nozzle to form an ablated heterogeneous material; and
passing the ablated heterogeneous material into a mineral processing circuit.

2. The method of claim 1 wherein the mineral processing circuit comprises a flotation circuit.

3. The method of claim 1 wherein the mineral processing circuit comprises a grinding circuit.

4. The method of claim 1 wherein the mineral processing circuit comprises a cyclone circuit.

5. The method of claim 1 wherein the mineral processing circuit comprises an attrition cell circuit.

6. The method of claim 1 wherein the high-pressure slurry ablation system replaces a component of the mineral processing circuit.

7. A system for ablating a heterogeneous material, the system comprising:
a first collision chamber comprising a pressure transducer;
a knife gate;
a valve;
a splitter in communication with said valve; and
a distributor.

8. The system of claim 7 further comprising a second collision chamber.

9. The system of claim 7 wherein said distributor is a side entry linear distributor.

10. The system of claim 7 wherein said distributor is a top entry linear distributor.

11. The system of claim 7 wherein said distributor is a top entry split distributor.

12. A method for ablating a heterogeneous material, the method comprising:
passing the heterogeneous material through a knife gate;
passing the heterogeneous material through a valve;
passing the heterogeneous material through a splitter in communication with the valve;
passing the heterogeneous material through a distributor;
passing the heterogeneous material into a first collision chamber comprising a pressure transducer; and
forming an ablated heterogeneous material.

13. The method of claim 12 further comprising passing the heterogeneous material into a second collision chamber.

14. The method of claim 12 wherein the distributor is a side entry linear distributor.

15. The method of claim 12 wherein the distributor is a top entry linear distributor.

16. The method of claim 12 wherein the distributor is a top entry split distributor.

17. The method of claim 12 further comprising measuring the force that the heterogeneous material exerts on a surface.

18. The method of claim 12 wherein the splitter radially splits the heterogeneous material into a plurality of collision chambers.

19. A system for ablating a heterogeneous material, said system comprising:
a multiple nozzle chamber, said multiple nozzle chamber comprising:
a chamber body;
a plurality of nozzles; and
an adapter-spacer.

20. The system of claim 19 further comprising a removable blind mounting plate for covering at least one nozzle.

21. The system of claim 19 further comprising a removable insert nozzle.

22. The system of claim 19 wherein said chamber body is polyhedron-shaped.

23. A method for ablating a heterogenous material, the method comprising:
passing heterogeneous material into a multiple nozzle chamber comprising a chamber body and an adapter-spacer; and
forming an ablated heterogenous material.

24. The method of claim 23 wherein at least one of the plurality of nozzles is covered by a removable blind mounting plate.

25. The method of claim 23 wherein at least one of the plurality of nozzles is a removable insert nozzle.

26. The method of claim 23 wherein the chamber body is polyhedron-shaped.

27. A system for ablating a heterogeneous material, said system comprising:
a combined collision chamber, said combined collision chamber comprising a plurality of modular nozzles; and
each of said plurality of modular nozzles comprising an angled adapter.

28. The system of claim 27 wherein at least one modular nozzle of said plurality of modular nozzles comprises a position sensor.

29. The system of claim 27 wherein at least one modular nozzle of said plurality of modular nozzles comprises a motorized adaptor.

30. The system of claim 27 further comprising an inter-collision separation device.

31. A method for ablating a heterogeneous material, the method comprising:
passing heterogeneous material into combined collision chamber comprising a plurality of modular nozzles, wherein each of the plurality of modular nozzles comprises an angled adapter.

32. The method of claim 31 wherein at least one modular nozzle of the plurality of modular nozzles comprises a position sensor.

33. The method of claim 31 wherein at least one modular nozzle of the plurality of modular nozzles comprises a motorized adaptor.

34. The method of claim 31 further comprising an inter-collision separation device.
